(19) United States
(12) Patent Application Publication
(10) Pub. No.: US 2010/0281766 A1
(43) Pub. Date: Nov. 11, 2010

(54) Dynamic Mixing of Fluids

(76) Inventor: David Livshits, San Francisco, CA (US)

Correspondence Address: VEDDER PRICE P.C., 222 N. LASALLE STREET, CHICAGO, IL, 60601, US

(21) Appl. No.: 12/529,625

(22) PCT Filed: Sep. 5, 2008
(86) PCT No.: PCT/US08/75374

§ 371 Date: Apr. 15, 2010

Related U.S. Application Data
(60) Provisional application No. 61/037,032, filed on Mar. 17, 2008.
(60) Provisional application No. 61/012,340, filed on Dec. 7, 2007.
(60) Provisional application No. 61/012,337, filed on Dec. 7, 2007.
(60) Provisional application No. 61/012,334, filed on Dec. 7, 2007.
(60) Provisional application No. 60/978,932, filed on Oct. 10, 2007.
(60) Provisional application No. 60/974,909, filed on Sep. 25, 2007.
(60) Provisional application No. 60/970,655, filed on Sep. 7, 2007.

(51) Int. Cl. F02M 29/06; C10L 1/12; C10L 1/16

(52) U.S. Cl. 44/458; 123/590

(57) ABSTRACT

Methods, systems, and devices for preparation and activation of liquids and gaseous fuels are disclosed. Method of vortex cooling of compressed gas stream and water removing from air are disclosed.

### CLAIMS OF PRIORITY

This application claims priority to the following U.S. provisional applications: U.S. Ser. No. 60/970,655, filed on Sep. 7, 2007, and entitled “Method and Device for Preparation and Activation of Fuel”; U.S. Ser. No. 60/974,909, filed on Sep. 25, 2007, and entitled “Method and Device for Preparation and Activation of Fuel”; U.S. Ser. No. 60/978,932, filed on Oct. 10, 2007, and entitled “Method and Device for Preparation and Activation of Fuel”; U.S. Ser. No. 61/012,334, filed on Dec. 7, 2007, and entitled “Method and Device for Preparation and Activation of Fuel”; U.S. Ser. No. 61/012,337, filed on Dec. 7, 2007, and entitled “Method and Device for Preparation and Activation of Fuel”; U.S. Ser. No. 61/012,340, filed on Dec. 7, 2007, and entitled “Fuel Preparation”; and U.S. Ser. No. 61/037,032, filed on Mar. 17, 2008, and entitled “Devices and Methods for Mixing Gaseous Components”. This application also claims priority to International Application No. PCT/US08/75374, filed Sep. 5, 2008, and entitled “Dynamic Mixing of Fluids”. All the preceding applications are incorporated by reference in their entirety.

### FIELD OF THE INVENTION

The invention relates to methods, devices and systems for dynamic mixing of fluids.

### BACKGROUND

Mixing components in a mix is well known. The basic criterion for defining efficiency of a mixing process has been those parameters that define the uniformity of a resultant mix. But the efficiency of a mixing process is defined not only by the resultant uniformity of the resultant mix, but can also include consideration of process parameters such as the energy expense, process development time, stability of the condition of the mix, kinetic energy of the mix, as well as other considerations.

In some technologies there is a desire to mix various components of different properties such as organic and/or inorganic liquids, liquids and gases, various gases with various properties, such as natural gas, hydrogen or other gases, and a gas oxidizer that is air or oxygen.

Some effective known methods of mixing use what is known as a dynamic effect for process intensification and influence on the components of a mix.

Examples include those that use eductors, atomizers, or venturi devices that are more effective than mechanical mixing devices, and generally put only one component into a dynamic condition.

In addition to the general mixing of gaseous and liquids components, the technical choices regarding the preparation and submission of gaseous fuel mixtures into combustion chambers of various devices are generally known.

Engines such as internal combustion engines burn fuel to power a device. In some cases, such engines exhibit less than one hundred percent efficiency in burning the fuel. The inefficiencies result in a portion of the fuel remaining non-combusted after a fuel cycle. The inefficiency of the engine can result in increased toxic emissions into the atmosphere and can require a larger amount of fuel to generate a selected level of energy. Various processes have been used to attempt to increase the efficiency of combustion chambers. In general, increasing the efficiency of the engine is desirable because the increase in efficiency can result in monetary savings due to decreased fuel consumption and can result in decreased emissions.

In these systems, various fuel gas mixes and fuel liquids and gaseous mixes, such as natural gas with air or oxygen or gasoline or diesel fuels with air and additional liquid components, are considered with the intent to increase the efficiency of the burning of gaseous fuel or liquid-gaseous fuel mixtures, for example, by increasing the submission of oxidizers into the zone of burning, modifying burner design, modifying cylinder or other engine component designs, improving heat exchanger surfaces and design, creating increased turbulence, developing vortex conditions in the system, using turbochargers to add combustion air under pressure, etc.

### SUMMARY

In one aspect, the invention relates to technologies of dynamic influence on various liquid and/or gaseous environments, their mixing, and intensification of their kinetic potential.

More particularly, the technologies can be extended to areas of mixing various liquids and/or gases, in various controllable proportions and combinations, with full and constant control of key parameters of the process, thereby defining the quality and parameters of a mix.

In some embodiments, the area of use can be characterized as any application that includes the results of dynamic mixing of fluids of various origins, organic and/or inorganic, having various physical and chemical properties, and degrees of activity. For example, the principles can apply to processes of mixing of liquids and liquids, liquids and gases, gases and aerosols, gases with gases, in various combinations and proportions.

Applications of these technical conditions can be employed in processes and devices for preparation of fuel mixes, for processes of technological mixing in all industries, and for a multitude of other non-industrial uses.

Embodiments concern technologies from which the properties of a mix and character of change of properties of components of a mix result from the control of dynamic parameters of the mixing process. As the result of the dynamic influences on the mix components, the level of kinetic potential of the mix components changes as does the level of kinetic potential of the resultant mix.

Embodiments therefore also concern the resultant changes that arise from the combination of effects from various kinds of dynamic influence on components of a mix during mixing.

In another aspect, the invention relates also to dynamic fuel preparation and activation technologies of fuel mixtures for internal combustion chambers.

In another aspect, the invention relates to the general area of the mixing of gases and/or liquids with gases, natural gas with oxidants; for example, embodiments relate to methods and devices for the preparation of gaseous mixtures and/or liquids mixtures, including gaseous fuel mixtures in a pipeline before their submission into a combustion chamber.

In another aspect, the invention relates to one or more of the following: devices and processes for dynamic mixing and activation with foam formation from a mixture including liquid and gas components; devices and methods for dynamic mixing and activation of fuel mixes including liquid and gas components; devices and methods for dynamic mixing and activation of fuel mixes including (e.g., consisting of) gas components; devices and methods for dynamic mixing and activation of multiple liquid components; devices and methods for dynamic mixing of gas components; and devices and methods for mixing and cooling of multiple gaseous components.

In some embodiments, a feature of component mixing, whether of liquids, gases, or combinations thereof, is the overlapping of positive effects from simultaneous Bernoulli Effect in liquid streams and the Bernoulli Effect in gas streams which are carried out in one device using the same energy sources and within the limits of the same constructive details. This feature decreases energy use, reduces the sizes of the devices, simplifies the design of devices, and increases operating performance and efficiency of the devices

The mix resulting from such devices is created by technological parameters, such as the pressure of the liquid and gas stream components. An estimation of the quality of the mixing process can be determined from measurement of the dielectric permeability of a foamed mix output from the device.

In certain embodiments, a feature of component mixing when applied to devices intended for consecutive cooling of a stream of compressed air and extraction of water is the overlapping of positive effects from adiabatic expansion (Joule-Thompson Effect) and from Ranque Effect phenomena. These overlapping effects do not demand additional energy sources and, using essentially the same quantity of energy as traditional methods, air temperatures can be lowered and productivity and efficiency of the device can be increased.

By overlapping the effects from several physical phenomena in devices described herein, new forms of mixes that may not be achievable using other methods may arise from liquid and gas components.

In devices employing these features, additional derivative principles may be applied, providing an additional gain in efficiency through their cumulative effects. For example, applying a principle of transformation of a hydraulic stream from a stream with a round system to a stream with a ring system, a principle of formation of consecutive volumetric zones of lowered pressure and input in these zones of various mix components under higher pressure, and/or a principle of embedding gas components into liquid components, can each improve the uniformity of a mix and its performance. For example, a device with a ring zone and combined effects applied can be 9.6 times more effective for increasing kinetic energy than some eductors having a cylindrical zone of formation with a flat ring zone, when both are used with identical operating parameters.

The devices and methods described herein can also include multiple stages of significant hydrodynamic and aerodynamic influence on a gaseous or liquid fuel stream flowing in the fuel pipeline.

The process for the activation of the fuel in the fuel pipeline of some existing systems can use minimal expense of energy to significantly improve the efficiency of the burning process in the combustion chamber, while at the same time lowering the volume of organic fuel used for a typical cycle of burning in the combustion chamber. The energy efficient processes for fuel activation can arise from using only: the existing fuel pump in the fuel system to input fuel components to the hydrodynamic portion of the fuel activation module; the output of an energy efficient compressor for input to the aerodynamic portion of the fuel activation module, powered from an existing take-off shaft on the device that uses the fuel; and the application of the Bernoulli Theorem to create low pressure zones for the creation of turbulence, fuel component mixing, and micro-bubble formation.

In other aspects, the invention features devices and methods for fuel activation (greater combustibility of a given volume of fuel) to increase fuel efficiency in internal combustion chambers, with the result being a corresponding reduction in the volume of fuel used to produce a specific energy level.

The process of fuel combustion in a combustion chamber can determine the efficiency of the device containing the combustion chamber, its environmental cleanliness, its thermodynamic parameters, and its mechanical characteristics. Therefore, having the correct fuel preparation has great value, particularly if preparation of the air/fuel mixture takes place prior to the process of burning in the combustion chamber, where there is more control over the variables that can produce the desired results. Thus an area of use is a system for the preparation and activation of fuel for combustion in combustion chambers.

In other aspects, the invention features an increase in the combustibility of the fuel, and, as a consequence, increases the energy of combustion from the same volume of fuel, which can thereby decrease the toxicity of the exhaust gases, and improve overall efficiency.

In other aspects, the invention features an increase in the amount of combustion air which can be added into the combustion chamber via the fuel line as air embedded in a mix of liquid fuel components prior to injection into the combustion chamber. The addition of air via a controlled pre-mix process in the fuel line prior to combustion has the same effect as a conventional turbocharger, but without moving mechanical components and with more precise timing of the detonation of the air/fuel mixture; the ability to regulate the air/fuel mixture and the injection speed of a pre-mixed fuel mixture with air into the combustion chamber permits efficiency improvements from the ability to time the injection of fuel droplets, which are no larger than 10 microns, into the combustion chamber at optimum points of piston position.

Additionally, this turbo-charger effect can be delivered to an existing combustion chamber without modifications to the engine, can lower the fuel temperature entering the combustion chamber from adiabatic effects, and can reduce emissions and vibrations due to the favorable characteristics of burning a highly uniform turbulent fuel mix with air.

In other aspects, in a diesel engine, if water is one fuel component added to fuel in a fuel activation device: the increased compressibility of the diesel fuel mix, by having air embedded into the fuel mix under pressure in the activation device, permits the diesel injector pump pressure to be decreased in size; water becomes an emulsion with the other fuel components in the fuel foam and the normal corrosive effect of water otherwise mechanically mixed in fuels at low fuel line pressures is reduced significantly; the addition of water into the combustion chamber also significantly reduces emissions and produces cooling effects which lower combustion temperatures.

Embodiments have broad application in internal combustion devices of all types, including those used, for example, in: commercial and industrial equipment of all types, fuel burning engines and generators, military equipment such as aircraft and naval turbines and engines, etc., regardless of the fuel being burned (gasoline, diesel, kerosene, jet fuel, propane, ethanol, combinations thereof, etc.)

In some aspects, a method of preparing a mixture of fuel and gas for use in a combustion device includes receiving from a fuel tank a first liquid component comprising a fuel and forming a first zone of increased turbulence and local low pressure by moving the first liquid component in an activation device.

The method can also include receiving a second liquid component into the first local zone of low pressure and mixing the first and second liquid components in vortices of the first local zone of low pressure to form a two component fuel mixture. The method can also include receiving pressurized gas and forming a second zone of local low pressure having a lower pressure than an incoming stream of the two component fuel mixture. The method can also include driving the two component fuel mixture into the second local zone of the low pressure to form a local pseudo-boiling condition in the combined fuel gas mixture, increasing the pressure in a stream of the fuel gas mixture to form a stream of micro-bubbles.

Embodiments can include one or more of the following:

The first liquid component can be an organic fuel. Receiving the second liquid component can include driving the second liquid component into the first zone of low pressure under a higher pressure than a pressure in the first local zone of low pressure.

The second liquid component can be water, another fuel, the same fuel, or other liquids. Forming the second zone of low pressure can include inputting the gas in a pipeline under pressure, opposite the direction of movement of the two-component liquid fuel gas mixture and transforming a direction of movement and form of the gas prior to entry of the gas into the second zone of low pressure. The stream of micro-bubbles can be a foamy and homogeneous stream. Formation of local zones of increased turbulence in the stream of at least one liquid component of the fuel mix can result from the hydrodynamic effect created by preferably using the physical principles of Bernoulli's Theorem. Formation of local zones of low pressure in the stream of at least one liquid component of the fuel mix can result from the hydrodynamic effect created by using the physical principles of Bernoulli's Theorem. Formation of local zones of low pressure in the stream of at least one gaseous component of the fuel gas mixture can result from the aerodynamic effect created by preferably using the physical principles of Bernoulli's Theorem m. Formation of local zones of the pseudo-boiling volumes in the stream of the fuel mix can result from the integrated hydrodynamic and aerodynamic effects created by preferably utilizing the physical principles of Bernoulli's Theorem. An organic component of the fuel mix can be used as a liquid working agent. The gaseous agent can be compressed air.

In some aspects, a method of preparation of a fuel gas mixture for submission into a combustion chamber can include receiving a first liquid component from a tank, the received first liquid component being under pressure. The method can also include generating a plurality of dispersed streams of the first liquid component to form a local zone of increased turbulence. The method can also include forming a first zone of local low pressure having a pressure that is less than a pressure of an incoming stream of the first liquid component. The method can also include forming a second zone of local low pressure. The method can also include inputting a pressurized gas into the second zone of local low pressure. The method can also include driving a turbulent fuel stream from the first zone of low pressure into the second local zone of the low pressure, to form a local pseudo-boiling condition in the fuel stream. The method can also include increasing a pressure in the fuel stream to change the fuel stream from a pseudo-boiling condition to a stream of micro-bubbles.

Embodiments can include one or more of the following:

The first liquid component can be an organic fuel. Forming the second zone of low pressure can include inputting the gas in a pipeline under pressure, opposite the direction of movement of the two-component liquid fuel gas mixture and transforming a direction of movement and form of the gas prior to entry of the gas into the second zone of low pressure. The stream of micro-bubbles can be a foamy and homogeneous stream.

In some aspects, a device for preparation of a fuel gas mixture for input into a combustion chamber can include a hydraulic system comprising a mechanical interface that produces hydrodynamic effects. The device can also include an aerodynamic system comprising a mechanical interface that produces aerodynamic effects connected to the mechanical interface that produces hydrodynamic effects. The device can also include a first pipeline for input of a liquid component to the hydraulic system.

The device can also include a second pipeline for input of a gaseous component from a compressor to the aerodynamic system. The device can also include a third pipeline for input of at least one fuel component. The device can also include a system for output of a fuel mix comprising the fuel component, the gaseous component, and the liquid component. The device can also include a first housing configured to house the hydraulic system. The device can also include a second housing configured to house the aerodynamic system, the first housing and second housing being configured to be located in a fuel line, wherein the hydraulic and aerodynamic systems of the device are located on cylindrical pins within the first housing and second housing to provide an integrated mechanical-hydrodynamic and mechanical-aerodynamic interface.

Embodiments can include one or more of the following:

The hydraulic system can include a plurality of channels disposed symmetrically about an axis of the fuel pipeline, the channels and having a decreasing cross-sectional area. The aerodynamic system further can include a plurality of channels disposed symmetrically about an axis of the fuel pipeline, the channels and having a decreasing cross-sectional area. The aerodynamic system further can include at least one channel having an input and an output directed in a direction of movement of a fuel mix to the combustion chamber. The device can also include conical reflectors.

The mechanical interface that produces the hydrodynamic effects and the mechanical interface that produces the aerodynamic effects can be connected by conical reflectors. These integrated hydrodynamic and aerodynamic interfaces can be connected by conical reflectors on the tops of conical surfaces. These integrated hydrodynamic and aerodynamic interfaces can each have reflectors with external and internal conical surfaces where the internal conical surface processes aerodynamic (gaseous) flows and the external conical surface processes hydrodynamic (liquid) flows.

In some aspects, a device for preparation of a fuel gas mixture for input into a combustion chamber can include an activation module disposed in a fuel pipeline, the activation module comprising a hydraulic system and an aerodynamic system connected to the hydraulic system. The device can also include at least one tank with one or more components of a fuel mix, the at least one tank being connected by a fuel pump and a pipeline to the hydraulic system of the activation module. The device can also include a compressor driven from a shaft of a device with the combustion chamber, an output of the compressor connected to the activation module. The device can also include at least one device for output of an activated fuel mix from the activation module to an atomizer for entry into the combustion chamber.

Embodiments can include one or more of the following:

The activation module can include a first housing structure, a second housing structure, and a component that unites the first and second housing structures and provides a site for connection to the fuel pipeline; the component first housing and second housing being configured to generate conditions for creating effects by applying the Bernoulli Theorem and generating two consecutive local zones of activation. The hydrodynamic system can include a conical fuel intake cavity in the shape of a truncated cone having a greater diameter at the input of fuel component and becoming smaller in the direction of movement of the fuel component and the aerodynamic system can include a conical gaseous intake cavity in the shape of a truncated cone having a greater diameter at the input of the of gaseous component and becoming smaller in the direction of movement of the gaseous component.

The device can also include a number of capillary openings disposed at the smaller diameter end of the truncated cone in the hydrodynamic system, the capillary openings having an axis parallel to an axis of the fuel pipeline and concentric to the circles of the truncated cone. The device can also include a number of capillary openings disposed at the smaller diameter end of the truncated cone in the aerodynamic system, the capillary openings having an axis parallel to an axis of the fuel pipeline and concentric to the circles of the truncated cone. Each of the hydrodynamic and aerodynamic working agent input structures of the fuel mix activation module can be in the form of truncated cones; in the hydrodynamic structure, flowing first from the smaller diameter and then to the larger diameter, and in the aerodynamic structure, flowing first from the larger diameter and then to the smaller diameter. Input of liquid and gaseous working agents in the activation module can be carried out from two sides of the module, and the input of the gaseous working agent can be carried out in a direction opposite to a direction of the fuel mix movement to the combustion chamber.

In some aspects, a fuel mix for use with an internal combustion chamber can include a plurality of multilevel fuel spheres in contact with each other, each multilevel fuel sphere having a core of compressed gas and a shell of turbulent organic fuel surrounding the core of compressed gas.

Embodiments can include one or more of the following:

The plurality of multilevel fuel spheres can include a plurality of pulsing multilevel fuel spheres.

In some aspects, a fuel mix for use in an internal combustion chamber can include a plurality of multilevel fuel spheres in contact with each other. Each multilevel fuel sphere can have a core of compressed gas and a shell surrounding the core of compressed gas. The shell can include a mixture of organic fuel components.

Embodiments can include one or more of the following:

The plurality of multilevel fuel spheres can include a plurality of pulsing multilevel fuel spheres. The mixture of organic fuel components can include a mixture of gasoline and ethanol.

In some aspects, a fuel mix, mainly for use in an internal combustion chamber, can include a plurality of multilevel fuel spheres in contact with each other.

Each multilevel fuel sphere can include a core of compressed gas and a shell surrounding the core of compressed gas, the shell comprising a mixture of organic and inorganic fuel components.

Embodiments can include one or more of the following:

The plurality of multilevel fuel spheres can include a plurality of pulsing multilevel fuel spheres. The mixture of organic fuel components can include a mixture of gasoline and water.

In some aspects, a device for preparation and activation of a fuel gas mixture for input into a combustion chamber can include a fuel mix activation module located in a fuel pipeline. The fuel mix activation module can include a hydraulic system and a functional aerodynamic system connected to the hydraulic system. The device can also include a tank configured to house components of a fuel mix, the tank being connected to the hydraulic system of the activation module by a fuel pump and a fuel pipeline. The device can also include a compressor driven by rotation of a take-off shaft from a device with the internal combustion chamber, the compressor being connected by a pipeline to the aerodynamic system of the activation module. The device can also include a device for outputting an activated fuel mix from the activation module to an atomizer for delivery of the activated fuel mix into a combustion chamber.

In some aspects, a method of preparation of a fuel gas mixture for input into a combustion chamber can include inputting a first liquid component of a fuel gas mixture comprising organic fuel under pressure from a tank with fuel in the fuel pipeline to an activation device. The method can also include forming a first local zone of increased turbulence and local low pressure in the activation device as the first liquid component flows in the fuel stream in the pipeline. The method can also include driving a second liquid component comprising water into the first local zone of low pressure under a higher pressure than the pressure in the first local zone of low pressure. The method can also include mixing the first and second liquid components by local hydrodynamic mixing in vortices of the activation device in combination with turbulent movement in the fuel pipeline to form a two-component liquid fuel gas mixture. The method can also include inputting in the pipeline under pressure and opposite the direction of movement of the stream of the two-component liquid fuel gas mixture a gaseous fuel component comprising compressed air to form a second zone of local low pressure that is at lower pressure than the incoming stream of the two component fuel mixture. The method can also include driving the two component fuel mixture into the second local zone of the low pressure to form a local pseudo-boiling condition in the mixture of the gaseous fuel component and two-component liquid fuel gas mixture. The method can also include increasing a local pressure in the fuel stream to form a foamy, homogeneous stream of micro-bubbles from the mixture of the gaseous fuel component and two-component liquid fuel gas mixture.

In some aspects, a method of preparation of a fuel gas mixture for input into a combustion chamber can include inputting a liquid component of a fuel gas mixture, into a fuel pipeline, under pressure, from a tank with the specified liquid component.

The method can also include transforming the specified liquid component into a number of dispersed micro-streams to form a local zone of increased turbulence and to form turbulent micro-streams of the liquid component.

The method can also include inputting a gaseous fuel component in the fuel pipeline under pressure and opposite the direction of movement of the turbulent micro-streams, to create a second zone of local low pressure having a lower pressure than the incoming fuel stream

of the gaseous fuel component comprising compressed air. The method can also include driving the turbulent micro-streams into the second local zone of low pressure to form a local pseudo-boiling condition in a fuel stream. The method can also include increasing a local pressure in the fuel stream to generate a foamy, homogeneous stream of micro-bubbles.

In some aspects, a device for preparation and activation of a fuel gas mixture for input into a combustion chamber can include a hydraulic system including a mechanical-hydrodynamic interface and a first housing that is coaxial with the mechanical-hydrodynamic interface. The device can also include an aerodynamic system including a mechanical-aerodynamic interface and a second housing that is coaxial with the mechanical-aerodynamic interface, the mechanical-aerodynamic interface and the mechanical-hydrodynamic interface being functionally connected. The device can also include a first system including a first pipeline configured to input of a liquid fuel component from a tank to the hydraulic system.

The device can also include a second system including a second pipeline configured to input a gaseous fuel component from a compressor to the aerodynamic system. The device can also include an input system configured to input the least one fuel component and an output system for output of the fuel mix, wherein the hydraulic and aerodynamic systems are disposed between the input system and output system, wherein the hydraulic system includes a first cylindrical pin within the first housing and the aerodynamic system includes a second cylindrical pin within the second housing which when pressed together with the first cylindrical pin provides an integrated mechanical-hydrodynamic and mechanical-aerodynamic interface.

In some aspects, a device can include a hydrodynamic system that includes an input to receive a fuel, a plurality of fuel channels configured to generate a turbulent stream of fuel, and an output configured to output the turbulent stream of fuel from the hydrodynamic system into a first zone of low pressure. The device can also include an aerodynamic system that includes a plurality of air channels configured to generate a stream of compressed air and an output configured to output stream of compressed air to a second low pressure zone connected to the first low pressure zone. The device can also include a channel between the first low pressure zone and the second low pressure zone configured to deliver the turbulent stream of fuel from the first low pressure zone to the second low pressure zone such that the turbulent stream of fuel is mixed with the stream of compressed air to form a plurality of micro-bubbles of fuel.

In some aspects, a device can include a first low pressure zone configured to receive a fuel and generate a turbulent stream of the fuel and a second low pressure zone configured to receive the turbulent stream of the fuel and a gaseous component and to generate a plurality of fuel spheres having a core of compressed gas and a shell of organic fuel surrounding the core of compressed gas.

In some aspects, a method includes receiving a fuel component, receiving a gaseous component, forming a plurality of fuel spheres having a core of compressed gas and a shell of organic fuel surrounding the core of compressed gas, and delivering the plurality of fuel spheres to a combustion chamber.

In some aspects, a device includes a first input configured to receive a fuel component and a second input configured to receive a gaseous component. The device also includes a hydrodynamic system and an aerodynamic system connected to the hydrodynamic system. The aerodynamic system and the hydrodynamic system can be configured to receive the fuel component and gaseous component and to form a plurality of fuel spheres having a core of compressed gas and a shell comprising organic fuel surrounding the core of compressed gas. The device can also include an output configured to deliver the plurality of fuel spheres to a combustion chamber.

Embodiments can include one or more of the following:

The shell can also include a second liquid. The shell can also include water. The shell can also include a second fuel component that is different from the fuel component.

In some aspects, a device includes a first input configured to receive a fuel component, a second input configured to receive a liquid, and a third input configured to receive a gaseous component. The device also includes a hydrodynamic system and an aerodynamic system connected to the hydrodynamic system. The aerodynamic system and the hydrodynamic system can be configured to receive the fuel component, liquid, and gaseous component and to form a plurality of fuel spheres having a core of compressed gas and a shell comprising the fuel component and the liquid surrounding the core of compressed gas. The device can also include an output configured to deliver the plurality of fuel spheres to a combustion chamber.

In some aspects, a device for preparation of a fuel gas mixture for input into a combustion chamber includes a hydraulic system that includes a hydraulic system housing and a mechanical-hydrodynamic interface disposed coaxially in the hydraulic system housing. The device also includes an aerodynamic system including an aerodynamic system housing and mechanical-aerodynamic interface disposed coaxially in the aerodynamic system housing, the mechanical-hydrodynamic being functionally connected to the mechanical-aerodynamic interface. The device also includes a pipeline configured to input a liquid component from a tank with the specified liquid fuel component to the hydraulic system. The device also includes a pipeline configured to input of a gaseous component from a compressor to the aerodynamic system. The device also includes a system configured to input of at least one fuel component. The device also includes a system configured to output of a fuel mix. The hydraulic and aerodynamic systems can be located on cylindrical pins within the hydraulic system housing and the aerodynamic system housing, and when pressed together, provide an integrated mechanical-hydrodynamic and mechanical-aerodynamic interface.

The device also includes a device configured to receive an output of an activated fuel mix from the hydraulic system and aerodynamic system and provide the activated fuel mix to a hydraulic switching center.

The device also includes a switching center connected with input channels of an atomizer having a nozzle tip configured to enter directly into the combustion chamber.

In some aspects, a device for preparation and activation of a fuel and gas mixture for input into a combustion chamber includes an activation module of the fuel mix disposed in a fuel pipeline. The activation module includes a hydraulic system and an aerodynamic system connected to the hydraulic system. The device also includes a tank configured to store components of a fuel and gas mixture, the tank being connected by a fuel pump and a pipeline to the hydraulic. The device also includes a compressor configured to be driven from a shaft of a device that includes the internal combustion chamber; the output of the compressor being connected to the activation module.

The device also includes a device configured to receive an activated fuel and gas mixture from the activation module and provide the activated fuel and gas mixture into an atomizer. The device also includes a device configured to receive the activated fuel and gas mixture from the activation module provide the activated fuel and gas mixture to a hydraulic switching center. The device also includes a switching center connected with input channels of a centrifugal vortex atomizer having nozzle tip configured to enter directly into the combustion chamber.

In some aspects, a method for preparing a fuel gas mixture for submission into a combustion chamber includes submitting a first liquid component of a fuel gas mixture from a fuel tank in a fuel pipeline. The first liquid component can be an organic fuel. The method also includes forming a first local zone of increased turbulence and local low pressure by the first liquid component moving in a fuel stream in the pipeline. The method also includes driving a second liquid component comprising water, into the first local zone of low pressure, the second liquid component being under a higher pressure than a pressure in the first local zone of low pressure. The method also includes hydro-dynamically mixing of the first and second liquid components in vortices, in combination with the subsequent developed turbulent movement in the fuel pipeline to generate a two-component liquid fuel gas mixture.

The method also includes inputting a gaseous fuel component comprising compressed air in the pipeline under pressure and opposite the direction of movement of the stream of the two-component liquid fuel gas mixture. The method also includes transforming the direction of movement and form of the gaseous fuel component to form a second zone of local low pressure having a lower pressure than the incoming stream of the two component fuel mixture. The method also includes driving the two component fuel mixture into the second local zone of the low pressure, to combine the gaseous fuel component and the two-component liquid fuel gas mixture to generate a fuel gas mixture and form a local pseudo-boiling condition in the fuel gas mixture. The method also includes increasing a local pressure in the fuel stream of the fuel gas mixture to change the fuel stream from a pseudo-boiling condition to a stream of micro-bubbles.

The method also includes distributing the stream of micro-bubbles between the input channels of an atomizer nozzle, the atomizer nozzle including tips configured to enter into the combustion chamber, and including conical output for the foamed micro-bubble fuel stream to be proportional and shaped to the selected level of fuel mix dispersion.

In some embodiments, the stream of micro-bubbles can be a foamy and homogenous stream of micro-bubbles.

In some aspects, a method for preparing a fuel and gas mixture for submission into a combustion chamber includes submitting a first liquid component of a fuel gas mixture from a fuel tank in a fuel pipeline to form a stream of the first liquid component, the first liquid component comprising organic fuel. The method also includes transforming the stream of the first liquid component, into a plurality of dispersed micro-streams and forming a local zone of increased turbulence. The method also includes generating in the local zone of increased turbulence a turbulent stream of the first liquid component. The method also includes inputting a gaseous fuel component comprising compressed air under pressure and opposite the direction of movement of the turbulent stream of the first liquid component. The method also includes transforming a direction of movement and form of the gaseous fuel component to generate a second zone of local low pressure that is at lower pressure than the turbulent stream of the first liquid component.

The method also includes driving the turbulent stream of the first liquid component into the second local zone of the low pressure to form a local pseudo-boiling condition in the turbulent stream of the first liquid component. The method also includes increasing a local pressure in the fuel stream of the fuel gas mixture to change the fuel stream from a pseudo-boiling condition to a stream of micro-bubbles. The method also includes distributing the stream of micro-bubbles between input channels of an atomizer nozzle having one or more tips configured to enter into the combustion chamber and having conical output chambers for the foamed micro-bubble fuel stream to be proportional and shaped to the selected level of fuel mix dispersion.

In some aspects, a multi-stage activation method for preparing a fuel and gas mixture for input into a combustion chamber includes inputting a liquid component of a fuel gas mixture from a tank with the specified liquid component into a fuel pipeline under pressure, to form a stream of the liquid component.

The method also includes transforming the stream of the liquid component into a number of dispersed micro-streams. The method also includes forming a local zone of increased turbulence. The method also includes inputting a gaseous fuel component comprising compressed air under pressure and opposite the direction of movement of the turbulent stream of the first liquid component.

The method also includes transforming a direction of movement and form of the gaseous fuel component to generate a second zone of local low pressure that is at lower pressure than the turbulent stream of the first liquid component.

The method also includes driving the turbulent stream of the first liquid component into the second local zone of the low pressure to form a local pseudo-boiling condition in the turbulent stream of the first liquid component. The method also includes increasing a local pressure in the fuel stream of the fuel gas mixture to change the fuel stream from a pseudo-boiling condition to a stream of micro-bubbles. The method also includes distributing the stream of micro-bubbles between input channels of an atomizer nozzle having one or more tips configured to enter into the combustion chamber and having conical output chambers for the foamed micro-bubble fuel stream to be proportional and shaped to the selected level of fuel mix dispersion.

In some aspects, a device for preparation and activation of a fuel gas mixture for input into a combustion chamber includes a hydraulic system including a hydraulic system housing and a mechanical-hydrodynamic interface disposed coaxially in the hydraulic system housing.

The device also includes an aerodynamic system including an aerodynamic system housing and mechanical-aerodynamic interface disposed coaxially in the aerodynamic system housing. The device also includes a pipeline configured to input a liquid component from a tank with the specified liquid fuel component to the hydraulic system. The device also includes a pipeline configured to input a gaseous component from a compressor to the aerodynamic system. The device also includes a system configured to input at least one fuel component. The device also includes a system configured to output a fuel mix, where the hydraulic and aerodynamic systems are located on cylindrical pins within the hydraulic system housing and the aerodynamic system housing, and when pressed together, provide an integrated mechanical-hydrodynamic and mechanical-aerodynamic interface. The device also includes a system configured to distribute the fuel mix stream from an n tipped atomizer having conical output with the larger diameter of the cone facing the combustion chamber.

In some aspects, a device for preparation and activation of a fuel gas mixture for input into a combustion chamber includes a fuel mix activation module disposed in a fuel pipeline. The activation module includes a hydraulic system and a functional aerodynamic system connected to the hydraulic system. The device also includes at least one tank configured to store components of a fuel mix, the tank being connected to the hydraulic system of the activation module by a fuel pump and a fuel pipeline. The device also includes a compressor driven by rotation of a take-off shaft from a device with an internal combustion chamber, the compressor being connected by a pipeline to the aerodynamic system of the activation module. The device also includes a device configured to receive an output of activated fuel mix from the activation module and input the activated fuel mix into an atomizer entered directly into the chamber of combustion. The device also includes a system configured to distribute the activated fuel mix from a nozzle of the atomizer, the nozzle having a conical output with the larger diameter of the cone facing the combustion chamber.

In some aspects, a method of preparation of a fuel gas mixture for input into a combustion chamber that includes multiple stages of activation. The method can include inputting a first liquid component of a fuel gas mixture, mainly organic fuel, under pressure, from a tank with fuel in the fuel pipeline.

The method can also include forming a first local zone of increased turbulence and local low pressure by the first liquid component moving in a fuel stream in the pipeline. The method can also include driving a second liquid component comprising water, into the first local zone of low pressure, the second liquid component being under a higher pressure than a pressure in the first local zone of low pressure. The method can also include hydro-dynamically mixing the first and second liquid components in vortices, in combination with the subsequent developed turbulent movement in the fuel pipeline to generate a two-component liquid fuel gas mixture. The method can also include inputting a gaseous fuel component comprising compressed air in the pipeline under pressure and opposite the direction of movement of the stream of the two-component liquid fuel gas mixture. The method can also include transforming the direction of movement and form of the gaseous fuel component to form a second zone of local low pressure having a lower pressure than the incoming stream of the two component fuel mixture. The method can also include driving the two component fuel mixture into the second local zone of the low pressure, to combine the gaseous fuel component and the two-component liquid fuel gas mixture to generate a fuel gas mixture and form a local pseudo-boiling condition in the fuel gas mixture. The method can also include increasing a local pressure in the fuel stream of the fuel gas mixture to change the fuel stream from a pseudo-boiling condition to a stream of micro-bubbles. The method can also include distributing the stream of micro-bubbles between input channels of a centrifugal vortex atomizer nozzle, the vortex atomizer nozzle having tips entering into the combustion chamber and having conical output chambers for the foamed micro-bubble fuel stream to be proportional and shaped to the selected level of fuel mix dispersion.

In some aspects, an internal combustion engine can include a system configured to input components of a fuel mix, prepare the fuel mix, perform hydrodynamic activation of the fuel mix, and perform aerodynamic activation of the fuel mix. The system can be configured to distribute, inject and ignite the fuel mix. The engine can also include a set of cylinders and pistons. The engine can also include a system configured to transform piston motion into rotary movement. The engine can also include a system configured to cool and reduce the level of aerodynamic noise of exhaust output gases. The engine can also include a system configured to at least partially neutralize toxic components of exhaust gases. The engine can also include an electronic control system configured to perform adjustments.

In some aspects, an internal combustion engine can include a system configured to input components of a fuel mix, prepare the fuel mix, perform hydrodynamic activation of the fuel mix, and perform aerodynamic activation of the fuel mix. The engine can also include a system configured to distribute, inject and ignite the fuel mix. The engine can also include a set of cylinders and pistons. The engine can also include a dual-rotary system having no dead points or crankshaft, the dual-rotary system being configured to transform the movement of pistons in cylinders into rotary movement of an output shaft. The engine can also include a system configured to cool and reduce the level of aerodynamic noise of exhaust output gases. The engine can also include a system configured to at least partially neutralize toxic components of exhaust gases. The engine can also include an electronic control system configured to perform adjustments.

In some aspects, a method includes generating a multi-level fuel sphere that includes a core of compressed gas and a liquid shell surrounding the core of compressed gas. The shell includes a fuel for combustion in a combustion chamber. The method also includes maintaining the multi-level fuel sphere at a pressure in a fuel line such that the multi-level fuel sphere does not burst. The method also includes causing the multi-level fuel sphere to burst in the combustion chamber, the combustion chamber having a pressure that is lower than a pressure of the fuel line.

Embodiments can include one or more of the following:

Causing the multi-level fuel sphere to burst in the combustion chamber can include causing the multi-level fuel sphere to burst by submitting the multi-level fuel sphere to the combustion chamber. Generating a multi-level fuel sphere can include selecting a volume of gas, selecting a pressure of the gas, and selecting a volume of fuel to mix with the gas. The method can also include monitoring a characteristic of combustion of the fuel in the combustion chamber and adjusting at least one of the volumes of the gas, pressure of the gas, and volume of fuel used to generate the multi-level fuel sphere. The pressure of the fuel line can be greater than 50 PSI and the pressure of the combustion chamber can be less than 25 PSI. The pressure of the fuel line can be greater than 70 PSI and the pressure of the combustion chamber can be less than 10 PSI.

In some aspects, a multi-level fuel sphere for use with an internal combustion chamber can include a core of compressed gas and a liquid shell surrounding the core of compressed gas, the shell comprising a fuel for combustion in the combustion chamber, wherein a thickness and pressure of the core of compressed gas and a thickness of the liquid shell are selected such that the fuel sphere bursts at a pressure of the combustion chamber.

Embodiments can include one or more of the following:

The fuel sphere can be configured such that it does not burst at a pressure of a fuel line connected to the combustion chamber. The pressure of the fuel line can be greater than 50 PSI and the pressure of the combustion chamber can be less than 25 PSI. The pressure of the fuel line can be greater than 70 PSI and the pressure of the combustion chamber can be less than 10 PSI. A ratio of a radius of the core of compressed gas to a thickness of the shell surrounding the core of compressed gas can be between about 0.8 and about 2.5. The shell can be formed of turbulent organic fuel. The shell can be formed of a mixture of organic fuel components. The mixture of organic fuel components can include a mixture of gasoline and ethanol. The shell can be formed of a mixture of organic and inorganic fuel components. The mixture of organic and inorganic fuel components can include a mixture of gasoline and water.

In some aspects, the fuel bubble bursts due to a pressure differential between a fuel line and a combustion chamber. Depending on the pressure it bursts into fuel particles, air particles, and fuel with air embedded in the fuel particles.

The mixture formed upon bursting of the fuel bubble provides an advantage of being turbulent and mixes in the combustion chamber to be highly uniform for promoting greater burning efficiency.

The mixture can be delivered as a stream of foam from the fuel line or the co-located activation device resident into the cylinder block. An atomizer or some other device can be used for injection of the mixture into the combustion chamber. In some aspects, the device can be located near the combustion chamber and controlled by the engine management system to allow for fast response times upon changes to the mixture.

Embodiments feature methods and devices for vortex mixing of at least two different gaseous components for any gaseous mix application, including with the mixing of gaseous fuel components like natural gas, hydrogen, and/or gaseous oxidants such as oxygen or air, in a pipeline, in proportions which correspond to a gaseous fuel mix desired for a particular combustion environment, including the proportion used to create an explosive mixture (“a rattling mix”).

In some embodiments, the relative density of the first gaseous component is less than the relative density of the second gaseous component and, as the first gaseous component stream moves through the pipeline, tangential streams of the second gaseous component, at a higher pressure and by means of a system of the tangential channels located around the pipeline in which the first gaseous component moves, creates a vortex stream which envelops the stream of the first gaseous component and increases the level of the turbulence of the mixture.

Whereas the process of mixing is conducted in a closed volume, the relative weight or volumetric proportions of the first gaseous component and second gaseous component may be completely controlled.

Such control can be effected by altering the pressures, flow rate, and speed of each gaseous component which instantly changes the proportions of mixing between the gaseous components, thereby providing full control over the mixing process.

The specified method of mixing during movement of the gaseous components in the pipeline also increases the volumetric uniformity of the gas mixture and simultaneously increases the speed of mixing, due to the effect of the vortex channel and the low and high pressure mixing as the Bernoulli Effect occurs, allowing a lower power demand for mixing, and an increase in the efficiency of mixing.

Such characteristics enable application of the methods and the devices intended for its realization to be used as a mixing devices for any gaseous mixture application, including medical applications and microelectronics production, as well as gaseous fuel preparation for burning in combustion chambers such as in all types of industrial equipment such as engines, boilers, furnaces, power generation equipment, among others, and for agricultural and other process applications.

For specific gaseous fuel mix requirements, a proportion slightly less than the critical amount which would otherwise lead to explosion of the rattling mix may also be maintained. This controlled mixing in such a manner and proportion permits a safe environment in which the fuel mix enters the combustion chamber with thermal energy characteristics almost identical to a rattling mix.

The specific situation of a volume of a gaseous fuel mix in proportions used to create a rattling mix is known to have the same thermal performance as the thermal energy (in combustion burning) of an equivalent volume of a 100% gaseous fuel component with no oxidant mixed in. The described embodiments thereby provide significant improvement in the thermal performance realized by burning a specific volume of a near rattling mix of gaseous fuel and an oxidant in a combustion chamber, by reduction of the gaseous fuel component. A controlled “near-rattling” mix is developed to prevent the creation of an explosive mixture.

At other proportions of gaseous fuel components and oxidants other than a rattling mix, thermal performance during combustion is also enhanced, due to the lowering of requirements for combustion air compared to other technologies.

As thermal performance improves, and less oxidant is used for achieving a specific level of thermal performance for a specific combustion environment, the volume and a level of toxic exhaust gas emissions are reduced.

The described methods and devices have additional desirable effects for subsequent burning of the resultant gaseous mixture in the combustion chamber such as: the cooling effect on the gaseous mix as the stream of the second gaseous component exits its channels and expands as it enters into the stream of the first gaseous component; the increase of the level of turbulence in the concentric gaseous mixture streams moving in the pipeline; and the creation of an axial force vector in the pipeline of the gaseous mix, moving in the direction of the combustion chamber.

Description of a Process of Vortex Mixing of a Gaseous Fuel Component With a Compressed Gaseous Oxidant in a Device With at Least One Vortex Generator

1. Sequence of Stages of Vortex Mixing:

1.1. Input of the stream of a gaseous fuel component into the pipeline of the device at usual operating pressures.

1.2. The stream of the gaseous fuel component is directed in the axial channel of the device.

1.3. Consecutive interaction of the stream of a gaseous fuel component, within the limits of the specified channel, with the compressed gaseous oxidant streams tangential to the channel's cylindrical surface.

1.4. In the same pipeline, the operation of a minimum of one vortex generator forms hollow vortex cylindrical spirals of compressed oxidant moving in the direction towards the combustion chamber, concentric to the gaseous fuel component, forming a linear axial force which has a vector towards the combustion chamber. The force is approximately 10 grams per one square millimeter of each system of the vortex cylinder, when the gaseous oxidant pressure is at least 1 atmosphere greater than the pressure of the gaseous fuel component. Due to pressure effects, the output gaseous mix from a vortex generator has an average temperature 3-5 degrees Celsius less than the gas stream on entry into the pipeline of the vortex generator. Such a cycle of vortex processing consistently repeats when multiple vortex generators are coupled together. Each subsequent vortex generator in the sequence, among other effects, further lowers the temperature, increases turbulence, and increases the linear axial force vector. Throughout the mixing process, the ratio of gaseous oxidant to the gaseous fuel component is completely supervised and controlled to form a non-explosive gaseous fuel mix with the desired characteristics, including a mix near that of an explosive mix.

1.5. The linear axial force, whose vector is in the direction of the combustion chamber, prevents the opportunity for a spontaneous return of the fuel mix going in reverse to enter the fuel mix pipeline, which could possibly otherwise cause an unexpected explosion.

1.6. As the relative density of the gaseous oxidant is greater than that of the gaseous fuel component, the compressed gaseous oxidant vortex cylinder formed around the gaseous fuel component stream maintains the dynamical stream of the gaseous fuel component in the center of the integrated vortex stream of the fuel mix. This mixing action causes a more complete hashing of the various gas mix components and creates a mutual diffusion of the gases. Therefore, upon input of the vortex fuel mix into the combustion chamber for burning, when using the device, less outside combustion air is required, there is a reduction in the volume of exhaust gases generated, there is a decrease in the temperature of the fuel mix, the burner flame has reduced pulsations, there is a more uniform and higher speed of burning, and there is a decrease in the concentration toxic elements in the exhaust gases (NOx, Cox, etc.). When the gaseous fuel mixture is near an explosive mix, the burning characteristics of the fuel mix itself further increases thermal performance.

1.7. A comparatively highly turbulent, thoroughly mixed stream of a gaseous fuel component and gaseous oxidant component also increases the level of the intensity of oxidation reactions when this fuel mix is burned in the combustion chamber; increased oxidation reactions result, and thereby reduce the concentration of oxides of carbon in the exhaust gases.

Features of the devices, systems and methods described herein, whether for dynamic mixing and activation of several fluid components, mixing, cooling and extraction of water from several gas components, or for cooling a stream of compressed air and extracting potable water from it, include the positive kinetic energy effects gained by overlapping several widely known physical principles in one device with no moving parts and internal geometries within to further enhance these effects. The benefits include the formation of liquid, gaseous, or combination streams with higher kinetic energy at lower energy inputs to achieve a desired result, in smaller devices with more simplified designs and lower operating costs.

In addition, the ability to overlap various effects from the several physical phenomena and further enhance them with internal energy enhancing geometries, permits the development of new mixes of various liquid and/or gas components which may otherwise not be achievable with less intensive mixing and activating methods.

The overall improvement in kinetic energy production may be in excess of 5× what is otherwise available from other devices inputting the same energy.

The benefits of these new mixes and the methods to produce them also promote more efficient fuel burning, better control over combustion processes, and new and improved approaches to efficient system design in many applications.

A. Examples of Basic Principles That are Applied Include:

1. For dynamic mixing and activation of several liquid components, gas components, or liquids and gases:

Simultaneous action and mutual influence of the Bernoulli Effect in a stream of a liquid and The Bernoulli Effect in a stream of a gas (Control of this process by only control of the liquid and gas pressures)

2. For dynamic mixing, cooling and extraction of water from several gas components and for cooling a stream of compressed air and extracting potable water from it:

Continuous overlapping of the cooling effect from adiabatic expansion (Joule-Thompson phenomena) and of Ranque Effect phenomena

B. In Addition To The Underlying Basic Principles, Examples of Other Geometric Designs Within The Devices Further Strengthen The Cumulative Effects That Arise From Application Of The Technologies:

Transformation of a hydraulic stream from a stream with a round cross-section to a stream with a ring cross-section, creating turbulence and enabling greater penetration of gas components into the overall liquid volume;

Formation of consecutive volumetric zones of lowered pressure and the input of the various components of mixes at higher pressures into these zones causing intensive mixing; and

Formation of hydraulic and pneumatic passageways that accelerate fuel components as well as to create vortices and turbulence.

### BRIEF DESCRIPTION OF THE DRAWINGS

FIG. 1 is a cross-section of a fuel activation device.

FIG. 1A is a diagram of cross sections of hydrodynamic and aerodynamic system of the fuel activation device.

FIG. 1B is a cross section of a universal version of a fuel activation device.

FIG. 1C is a model of a universal version of a fuel activation device.

FIG. 2A is a diagram of dynamic flow of a fuel activation device.

FIG. 2B is a diagram of dynamic flow of a universal version of a fuel activation device.

FIG. 3A is a diagram of a structure of a fuel activation device.

FIG. 3B is a diagram of a structure of a universal version of a fuel activation device.

FIG. 4 is a diagram of a dynamic flow in a fuel activation device.

FIG. 5 is a block diagram of a system that includes a fuel activation device that activates one liquid and one gaseous components of fuel mix.

FIG. 6 is a block diagram of a system that includes a fuel activation device that activates more than one liquid components of a fuel mix.

FIG. 7 is a diagram of a fuel activation device that is assembled directly on an engine.

FIG. 8 is a diagram of a flow of air and liquid in a fuel activation device that is assembled directly on an engine; FIG. 8B shows the relationship between different dimensions of a fuel activation device; and FIGS. 8C and 8D show a fuel activation device located in a hermetically sealed system between two portions of a fuel pipeline.

FIGS. 9A, 9B, and 9C are diagrams of a reflector design versions of the fuel activation device.

FIG. 10 is a cross section of a cylinder of an engine.

FIG. 11A is a cross section of a fuel activation device with an atomizer on an output of a device.

FIG. 11B is a cross section of a universal design version of a fuel activation device that can be connected to an atomizer.

FIG. 12A is a diagram of air and liquid fuel flow in a fuel activation device that is connected to an atomizer.

FIG. 12B is a general diagram of a universal fuel activation device.

FIG. 13 is a block diagram of a system with two in sequence connected fuel activation devices.

FIG. 14 is a block diagram of a system of sequentially connected fuel activation devices, at least one of them used more than one liquid fuel component.

FIGS. 15A-15D are diagrams of fuel.

FIG. 16 is cross section of hydrodynamic and aerodynamic housings of a fuel activation device.

FIG. 17 is the block diagram showing use of a fuel activation device in an internal combustion engine.

FIGS. 18, 19, 20, 21, 22, and 23 are the proportional and dimensional parameters of systems of fuel activation devices.

FIGS. 24-29 shows geometrical relationships and design features of the housing of the hydraulic system.

FIGS. 30A and 30B are diagrams of a device for aerodynamic activation of natural gas, mixing it with compressed air and cooling of the gaseous mix in time of the mixing.

FIGS. 31-32 are diagrams of a version of a device for aerodynamic activation of natural gas and air mix.

FIGS. 33-34 show the cross section of a device for activation of natural gas with air mix with use of vortex generators.

FIGS. 35A-35B shows a model and a cross section of a vortex generator.

FIGS. 36A-36B shows a cross section of a vortex of water producing and cooling device and a model of a vortex generator.

FIGS. 37A-37B shows a cross section of a vortex of water from an exhaust gas producing and exhaust gas cooling device and vortex generator model.

FIG. 38 shows a double vortex generator model.

### DESCRIPTION OF EMBODIMENTS

Devices and methods described herein may be applied when fuel has multiple components, for example, two dissimilar components such as gasoline and water; or two homogeneous components, such as gasoline and ethanol; or at least three diverse components, such as gasoline, ethanol and water. The devices and methods can be applied, in situations where the fuel has only one component, for example only gasoline or only diesel fuel.

In some embodiments, of the devices and methods include processing of the fuel mixture while the fuel is moving in the fuel pipeline, while employing consecutive basic principles of hydrodynamics and aerodynamics to activate the fuel;

For all applications, the device includes a fuel pump and a fuel line, a hydro-mechanical and hydro-dynamic component to create turbulence, connected structurally and functionally with an aerodynamic fuel foam making activator which itself is connected to a compressor powered from a power take-off shaft connected to the fuel using device The fuel mix thereby processed is output from the fuel line to be input into the combustion chamber for subsequent combustion. In some embodiments, compressed air can be provided from an air conditioner or other compressor in a device.

The devices and methods can also provide, with equal efficiency, the hydrodynamic mixing of organic and inorganic fuel components with the subsequent homogeneous aerodynamic saturation by oxygen, with full or partial foaming, or the making of a turbulent, homogeneous stream of fuel, also with subsequent homogeneous aerodynamic saturation by oxygen. Regardless of the fuel mixture variations described, the physical-chemical properties of the fuel so processed are maintained until combustion.

In some embodiments, a method of preparing a fuel gas mixture for subsequent submission into the combustion chamber includes:

Fuel from a tank with the first liquid component, mainly organic fuel, is input into the fuel pipeline under pressure;

The specified first liquid component is dispersed into the fuel stream moving in the fuel pipeline, and forms a local zone of increased turbulence and low pressure;

A second liquid component, mainly in the form of the water, is driven into the first local low pressure zone under a pressure which exceeds the pressure in the first local low pressure zone;

The two specified liquid components are hydro-dynamically mixed with vortices, in combination with the turbulent movement which is developed in the fuel pipeline; and

A gaseous component, mainly in the form of compressed air, is driven into the pipeline under pressure, opposite the direction of movement of the stream of the two component fuel mixture described above, forming a second zone of local low pressure, with a pressure lower than the pressure of the two-component fuel mixture stream prior to its interaction with the gaseous component.

A local pseudo-boiling condition is formed in the fuel mixture in the second zone of low pressure, as the fuel mixture moves in the direction of the combustion chamber.

The gradual increase in local pressure in the fuel stream changes the fuel stream from a fuel mixture in a pseudo-boiling condition into a homogeneous fuel mixture stream of micro-bubbles.

In some embodiments, a method of preparing a fuel gas mixture for input into the combustion chamber includes:

From a fuel tank, the specified liquid fuel component is submitted under pressure into the fuel pipeline;

The stream of the specified liquid component moving in the pipeline is transformed into a number of micro-streams and is dispersed into the fuel stream moving in the fuel pipeline, and forms a first local zone of increased turbulence and low pressure;

A gaseous fuel component, mainly in the form of compressed air, is driven into the pipeline under pressure, opposite the direction of movement of local zone of micro-streams described above, forming a second zone of local low pressure, with pressure lower than the pressure in the stream before the specified zone;

A local pseudo-boiling condition forms in the second zone of low pressure, as the fuel moves in the direction of the combustion chamber; and

The gradual increase in local pressure in the stream changes the mix from a pseudo-boiling condition into a homogeneous fuel stream of micro-bubbles.

A device for preparing a fuel gas mixture for subsequent burning in a combustion chamber can include:

Integrated mechanical interfaces that are functionally connected, one system that produces hydrodynamic effects and the other interface that produces aerodynamic effects.

At least one system including a fuel tank and a pipeline for input of the specified fuel component to the hydraulic system of the specified device;

At least one system including a pipeline for submission of a gaseous fuel component from the compressor to the aerodynamic system of the specified device; and

At least one system for input of at least one fuel component and one system for output of the fuel mix from the specified device, and between these two systems, built into the fuel line, are the hydraulic and aerodynamic systems of the specified device. The hydraulic and aerodynamic systems of the device are in separate housings that are coaxial, are located on cylindrical pins within each system housing, and together, provide an integrated hydrodynamic and aerodynamic component.

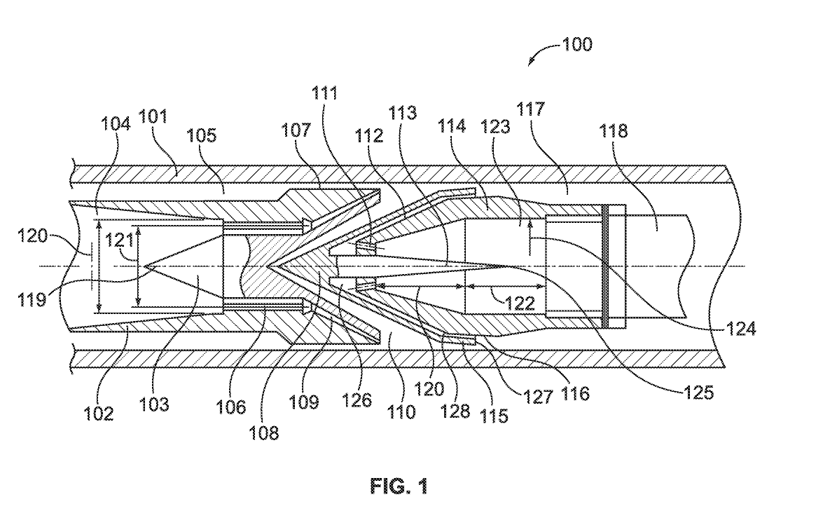

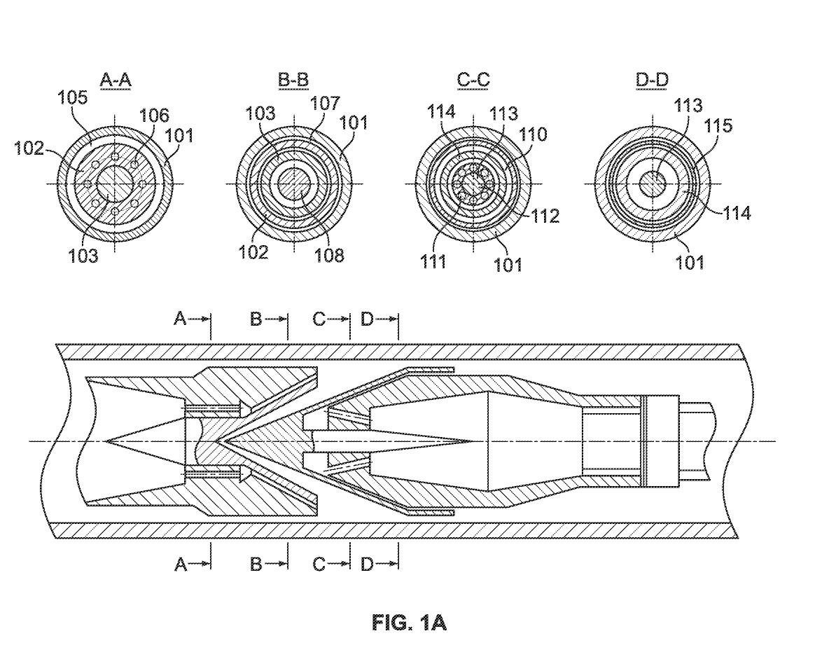

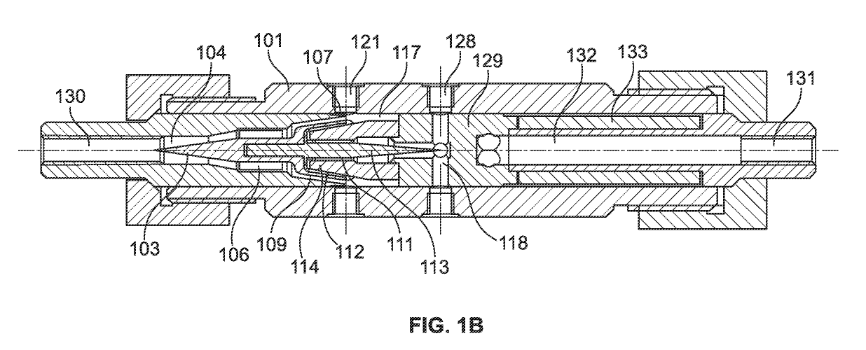

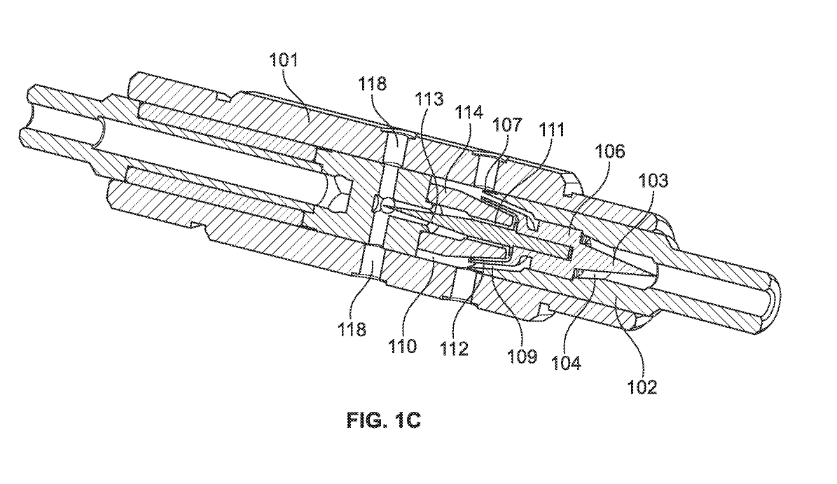

FIG. 1 shows a cross-section of a device for step activation of organic fuel, wherein the first step organic fuel mixes with water, and wherein the second step compressed air is input under pressure into the mix of organic fuel with water, in conditions resulting from the application of Bernoulli's Theorem, resulting in a condition of pseudo boiling, then moving as a flow of a foam of micro-bubbles into the combustion chamber.

FIGS. 1, 1A, 1B, and 1C include the following features:

Position 101, —a fuel pipeline;

Position 102, —a housing of the hydrodynamic component, which creates turbulence and activates the fuel mix stream;

Position 103, —a cone for transformation of the fuel stream from cylindrical to conical flow;

Position 104, —a cavity in which the fuel is transformed;

Position 105, —a ring cavity in which water moves;

Position 106, —a channels distributed in regular intervals on a circle, each channel has a length at least 10 times greater than its diameter;

Position 107, —a channel ring between the internal diameter of the pipeline and the housing 102;

Position 108, —a conical reflector;

Position 109, —a conical capillary ring channel in which the speed of the stream increases and simultaneously increases the turbulence of the stream;

Position 110, —a zone of local lowered pressure in which there is a hydrodynamic mixing of the liquid components of the fuel mix;

Position 111, —openings that divide the stream of the compressed gas into uniform capillary micro-streams;

Position 112, —a conical channel ring in which the stream of the compressed gas changes direction of movement and, owing to the high speed of movement, forms a local zone of low pressure;

Position 113, —a conical needle that begins the process of transforming the form of the compressed gas stream;

Position 114, —a housing of the aerodynamic device, and the aerodynamic system of the transformation of the compressed gas stream of the system;

Position 115, —a stabilizer of the conical reflector supporting the high speed of movement of gas;

Position 116, —a ring shaped area of the device in which the steady pseudo-boiling volume of a fuel mix is formed;

Position 117, —a ring shaped area and a continuation of area 116, in which the pseudo-boiling volume passes as a foam of micro-bubbles;

Position 118, —a pipeline for input of the compressed gas;

Position 119 (FIG. 1B), a collector for activated fuel mix;

Position 120, a compressed air input;

Position 121, an additional fuel component input;

Position 122, a collection pipe for outlet of the activated fuel mix;

Position 123, a bushing that can be changed for an electromagnet accelerator or for a heating device;

Position 124, an output connector; and

Position 125, an input connector.

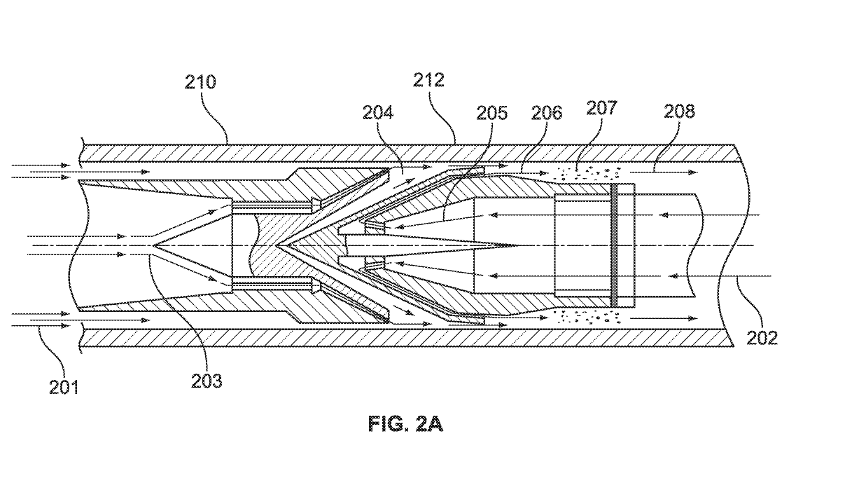

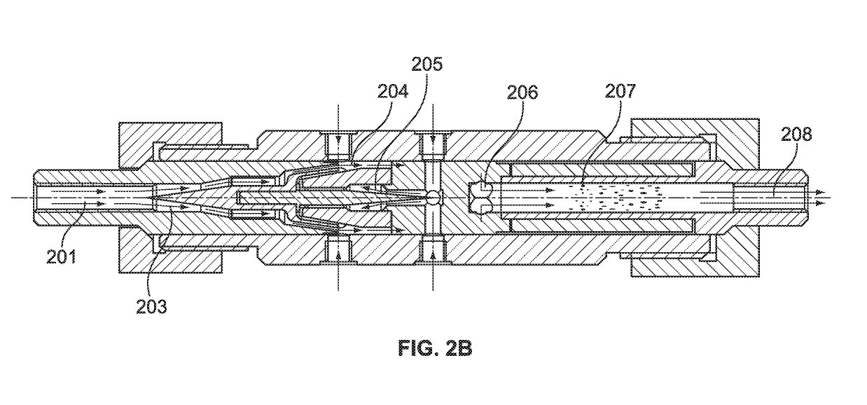

In FIG. 2A, the cross section of the device for step activation of a fuel mix in which the flow of the input of initial components and the output of the activated fuel mix are schematically shown. In FIG. 2B the cross section of a universal fuel activation device is shown. FIGS. 2A and 2B include the following features:

Position 201, —an input channel of an inorganic fuel component;

Position 202, —an input channel of the compressed gas;

Position 203, —an input channel of an organic fuel component;

Position 204, —a ring zone in the pipeline in which an inorganic fuel component mixes with a flowing organic fuel component that is at low pressure, simultaneously creating a pseudo-boiling volume in this zone;

Position 205, —a distribution zone of a compressed air stream, which is accelerated as it flows to the exit openings;

Position 206, —a ring zone in which a second local area of low pressure is formed and the pseudo-boiling volume is formed;

Position 207, —a ring area in which the micro-bubbled volume is formed; and

Position 208, —a ring area in which the foamy volume of micro-bubbles is formed.

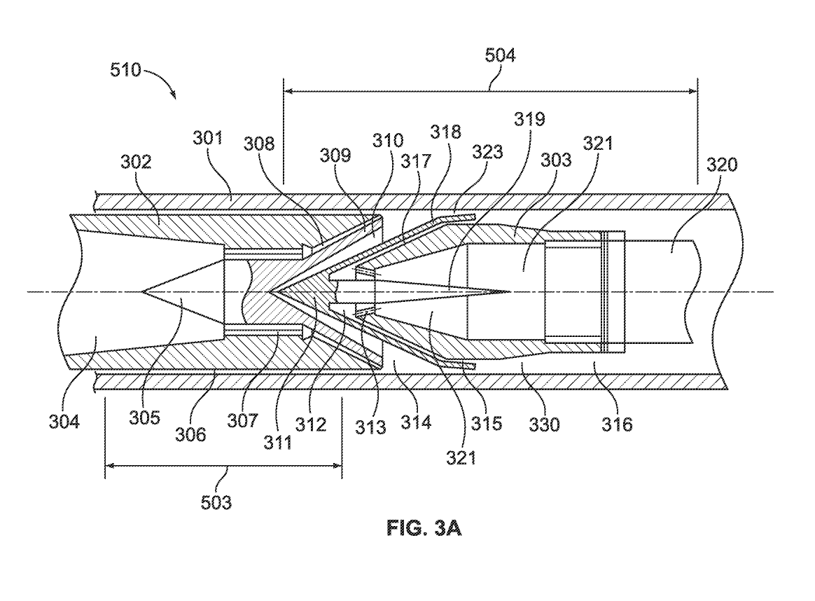

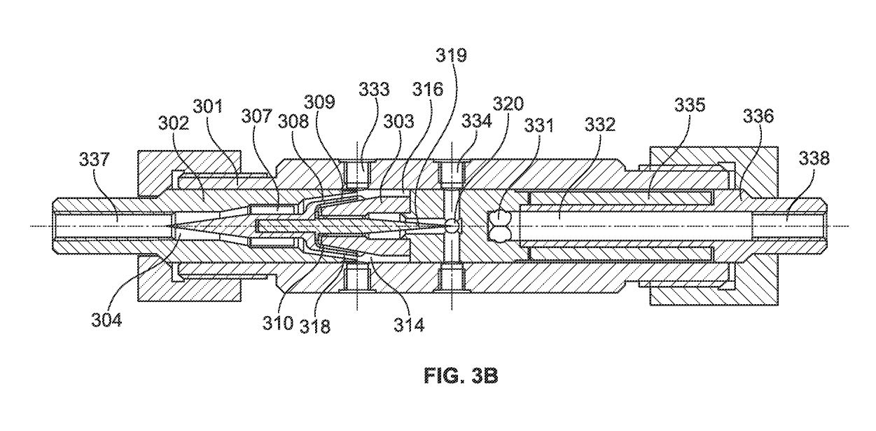

In FIG. 3A, a cross section of the device for step activation of the fuel mix is shown, consisting only of an organic component and compressed air. In FIG. 3B, a cross section of the universal fuel activation device is shown. FIGS. 3A and 3B include the following features:

Position 301, —a fuel pipeline;

Position 302, —a housing of the system for creating local turbulence in the fuel mix;

Position 303, —a housing of the system for the local aerodynamic intensification of the process of formation of the pseudo-boiling volume in the fuel stream;

Position 304, —a cone-shaped cavity in which the cross-section system gradually decreases, and, the speed of movement of a liquid flowing in it gradually increases;

Position 305, —a cone for transformation of the fuel stream from cylindrical to conical flow;

Position 306, —a gap between the housing 302 and the pipeline 301, —generally, the housing is lightly pressed into the pipeline;

Position 307, —capillary openings distributed in at regular intervals on the bottom of conical cavity 304, each opening has a length at least 10 times greater than its diameter;

Position 308, —a capillary cone-shaped channel for the output of opening 307;

Position 309, —a conical bell surrounding a reflector;

Position 310, —a conical channel ring between the hydrodynamic and aerodynamic systems of the device for activation of the fuel mix;

Position 311, —a conical reflector of aerodynamic system;

Position 312, —a local ring zone in which the stream of the compressed gas turns 180 degrees;

Position 313, —regular interval openings in housing 303, distributed on the end face, in which compressed air is dispersed and starts to create local low pressure;

Position 314, —a local, low pressure ring zone in which high-speed streams of compressed air are driven into the turbulent micro-streams of fuel at Position 315, a ring channel in which the maximal flow speed of compressed air is created;

Position 316, —a local ring zone in which a foamy volume of micro-bubbles is formed;

Position 317, —a cone-shaped channel in which there is dispersal of compressed air;

Position 318, —a conical system of the aerodynamic reflector;

Position 319, —a conical needle of the aerodynamic reflector; and

Position 320, —a pipeline for input of compressed air.

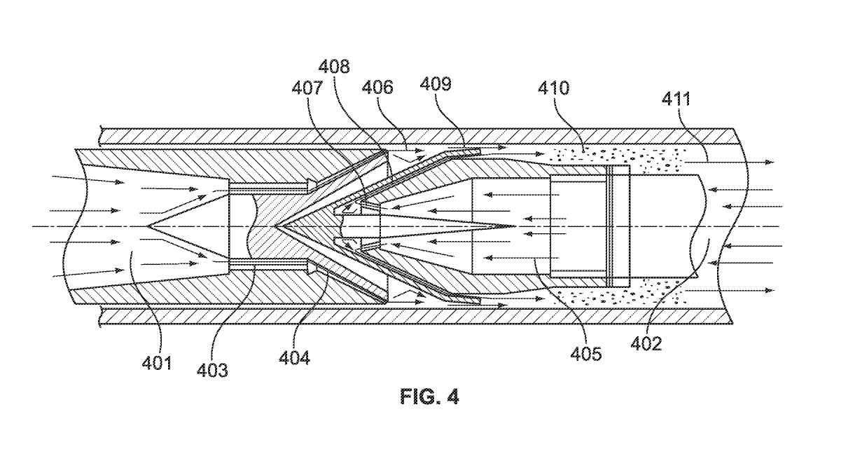

In FIG. 4, a diagram of the flow of the liquid and gas in the device for stepwise activation of the fuel mix, consisting only from an organic component and compressed air, is shown. FIG. 4 includes the following features:

Position 401, —an incoming fuel stream is distributed to the openings located at regular intervals;

Position 402, —a stream of compressed air is input in a direction opposite to the direction of the fuel flow;

Position 403, —micro-streams of fuel move through capillary openings;

Position 404, —dispersal of the fuel that has left the capillary openings;

Position 405, —a cavity in which compressed air is distributed to openings located at regular intervals;

Position 406, —a ring cavity from which a turbulent stream of fuel exits, flowing at high speed and under pressure;

Position 407, —a 180 degree turn of the stream of compressed air;

Position 408, —dispersal of the stream of the compressed gas and formation of a local low pressure zone;

Position 409, —driving of a stream under high pressure into the zone of low pressure, beginning of formation of a pseudo-boiling stream;

Position 410, —a local area in which the pseudo-boiling zone is formed, which gradually becomes a volume of micro-bubbles;

Position 411, —a foamy stream of micro-bubbles of the fuel gas mixture.

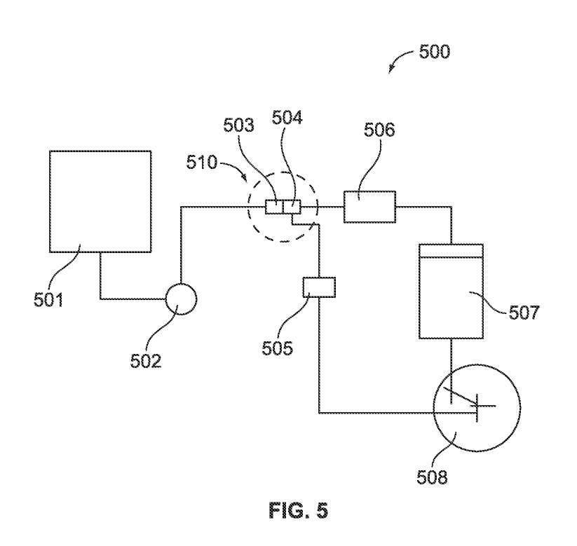

In FIG. 5, a diagram of a consecutive preparation process of the fuel gas mixture for burning in a combustion chamber is shown. FIG. 5 includes the following features:

Position 501, —a tank with fuel;

Position 502, —a fuel pump;

Position 503, —a hydrodynamic system of the device for activation of the fuel mix

Position 504, —an aerodynamic system of the device for activation of the fuel mix;

Position 505, —a compressor;

Position 506, —an atomizer;

Position 507, —a cylinder of the combustion chamber; and

Position 508, —a crank mechanism of an internal combustion chamber.

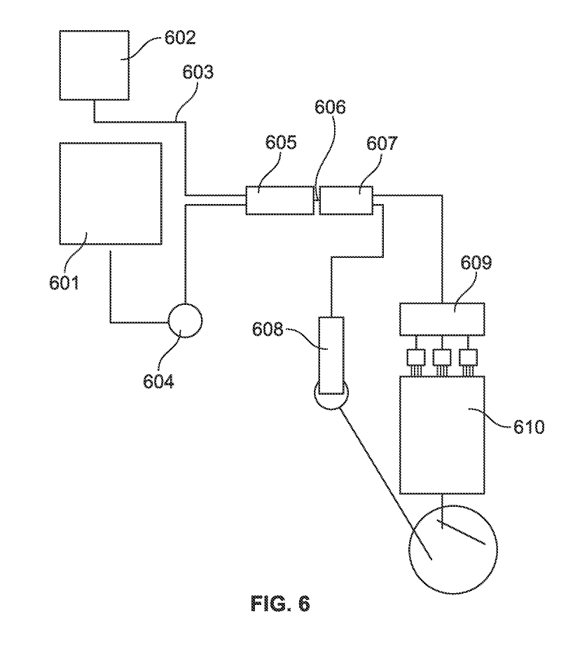

In FIG. 6, a diagram of a consecutive preparation and activation process of a multi-component fuel gas mixture for burning in a combustion chamber is presented. FIG. 6 includes the following features:

Position 601, —a tank with an organic fuel;

Position 602, —a tank with an inorganic mix;

Position 603, —a pipe for input of the inorganic fuel component to the device for hydrodynamic mixing;

Position 604, —a fuel pump;

Position 605, —a device for hydrodynamic mixing of the organic and inorganic fuel components;

Position 606, —mechanical-hydrodynamic and mechanical-aerodynamic components functionally connected into one closed system, which is the device providing the hydrodynamic and aerodynamic effects on the fuel mix;

Position 607, —a device for producing complex aerodynamic effects on the fuel mix, including mixing of fuel components and transformation of the form and a physical condition of the received mix;

Position 608—a compressor with a drive of rotation from a shaft of the device with an internal combustion chamber;

Position 609, —a system of fuel atomizers; and

Position 610, —a cylinder within an internal combustion chamber.

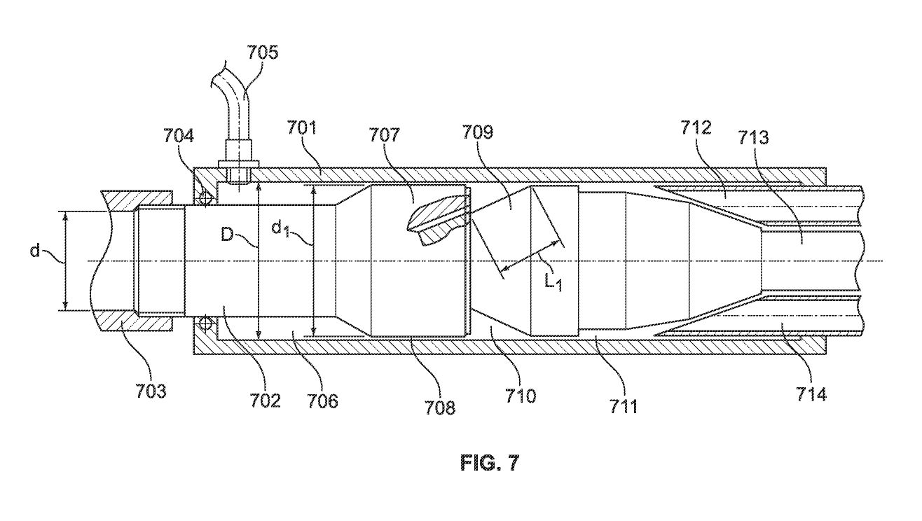

In FIG. 7, an axial system of an activation module is shown along with a study of the system for input of the liquid fuel components of the fuel mix and the system for output of the prepared and activated fuel mix. FIG. 7 includes the following features:

Position 701, —a cross section of a fuel pipeline in which the activation module is built in;

Position 702, —a hydrodynamic system of the device;

Position 703, —a fuel pipeline, for input from the organic fuel tank;

Position 704, —a hydraulic “O” ring.

Position 705, —a pipeline for input of the inorganic fuel component, for example, water;

Position 706, —a cavity in which the inorganic fuel component is accumulated before being driven into a zone for mixing with the turbulent organic fuel component;

Position 707, —a housing of the device that produces hydrodynamic effects; the ring capillary channel for hydrodynamic effects is formed by the area between the inside diameter of housing 701 and the outside diameter of housing 707;

Position 708, —a ring capillary channel;

Position 709, —a conical reflector of the device that produces aerodynamic effects;

Position 710, —a local ring zone in which the liquid components of the fuel are hydro-dynamically mixed and made turbulent;

Position 711, —a ring zone in which the first phase of pseudo boiling is formed in the liquid-gas fuel mix;

Position 712, —channels for output of the activated fuel mix from cross section 701 are located at regular intervals around the pipeline for input of compressed air;

Position 713, —a pipeline for input of compressed air from the compressor; and

Position 714, —similar to position 712.

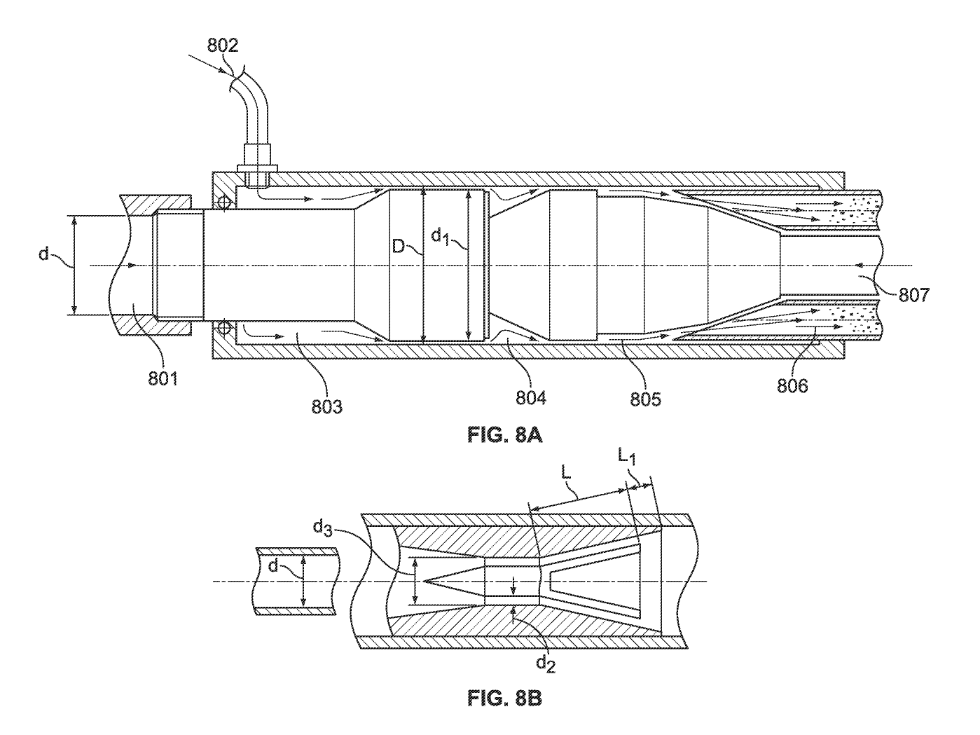

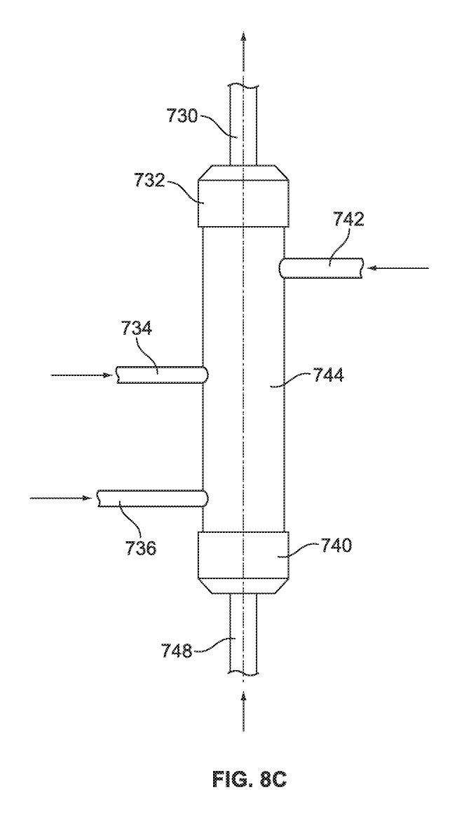

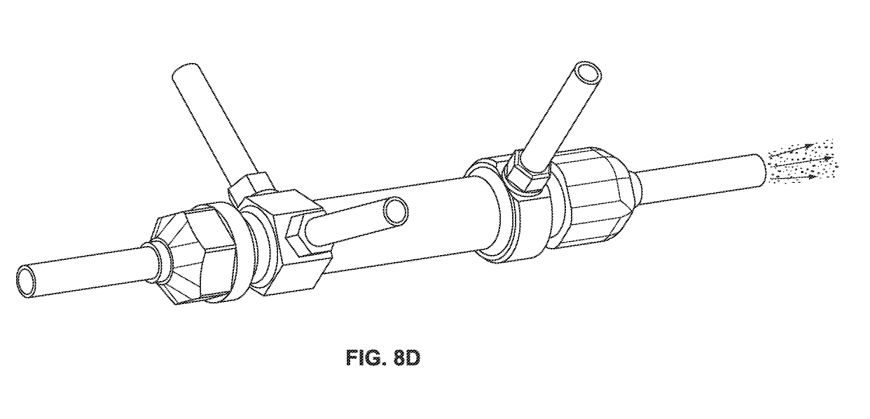

In FIG. 8, the schematic is shown for the flow of the fuel mix components in the device for preparation of the fuel gas mixture. FIG. 8A includes the following features:

Position 801, —an input of a liquid component of a fuel mix that has an organic origin, for example gasoline; the input is carried out under the pressure created by a fuel pump;

Position 802, —an input of a liquid component of a fuel mix that has an inorganic origin, for example water; the input is carried out under influence of forces of gravitation, without added pressure;

Position 803, —a cavity in which the inorganic fuel component is concentrated;

Position 804, —a cavity in which the mixing of organic and inorganic fuel components occurs, in the following sequence: the organic fuel component is dispersed, made turbulent, and creates a local zone of low pressure, coaxial and symmetric to the cavity 803; then in a zone of low pressure on capillary ring channels, also symmetrical and coaxial to the cavity 803, the inorganic fuel component, due to the geometry and the form of connection of all the specified cavities, is distributed to and mixed at regular intervals with the turbulent volume of the organic fuel component; therefore, the resulting mix maintains a level of turbulence and a level of pressure in 804; Position 805, —a ring cavity, symmetrical and coaxial to all to the previous cavities, in which compressed air creates a zone of local low pressure; as the previous hydrodynamic cavity has a pressure higher than that of the aerodynamic zone of low pressure, the fuel in this cavity 805 mixes with vortices with high speed in a mode of pseudo-boiling, in which the structure of the formed stream of fuel mix has the structure of a moving foam of micro-bubbles; and

Position 806, —an output of the fuel mix in symmetrical cavities located on a circle, coaxial to all previous cavities.

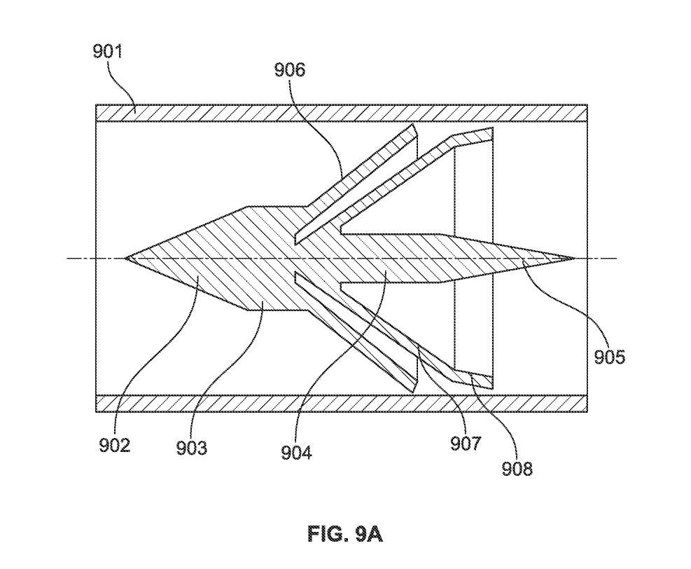

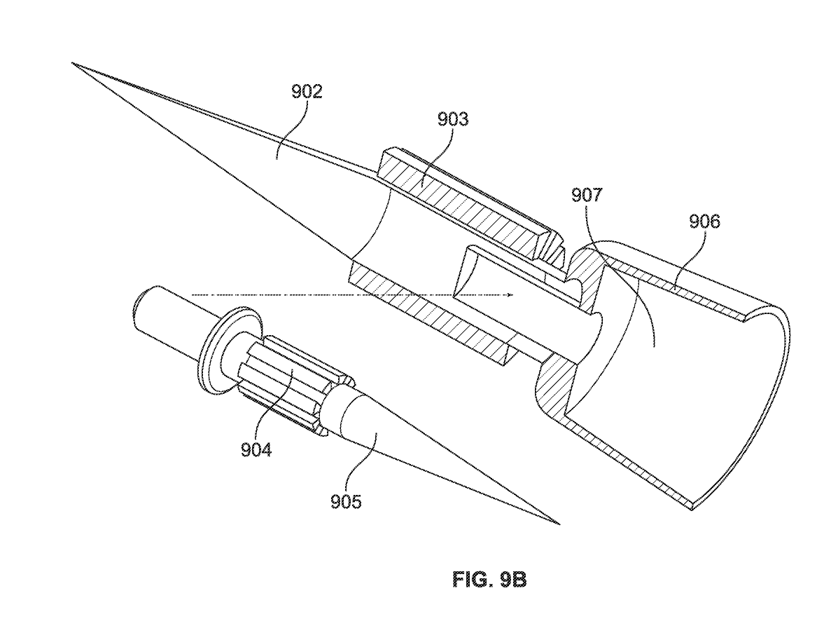

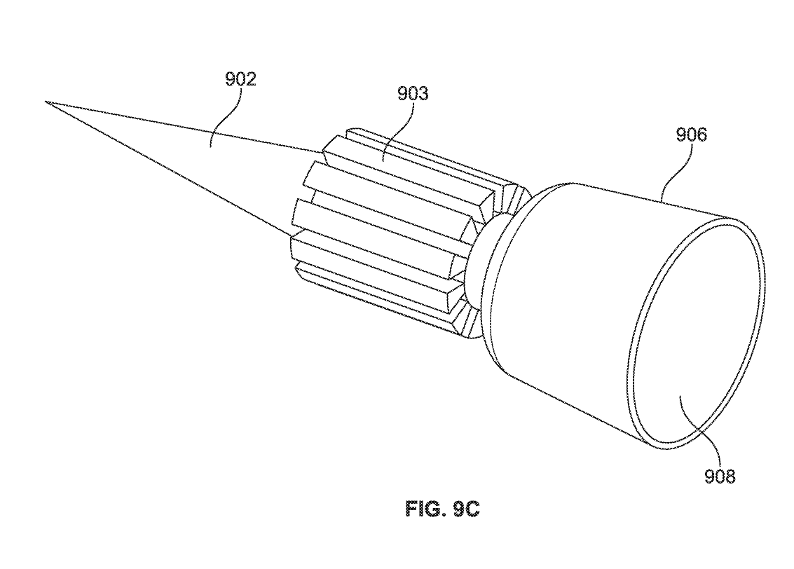

In FIG. 9A the interface between two cone-shaped reflectors of the device for preparation of a fuel mix is shown; In FIGS. 9B and 9C, models of the interface of universal fuel activation device are shown. FIGS. 9A, 9B, and 9C include the following features:

Position 901, —a fuel pipeline;

Position 902, —a conical axial pin of the hydraulic system of the interface;

Position 903, —a cylindrical axial pin, on which is the housing of the hydrodynamic system;

Position 904, —a cylindrical axial pin, on which is the housing of the aerodynamic system;

Position 905, —a conical axial pin of an aerodynamic system of the interface;

Position 906, —a cone-shaped reflector of the hydraulic system of the interface;

Position 907, —a combined cone-shaped reflector of a aerodynamic system of the interface; and

Position 908, —a bell of reflector 907.

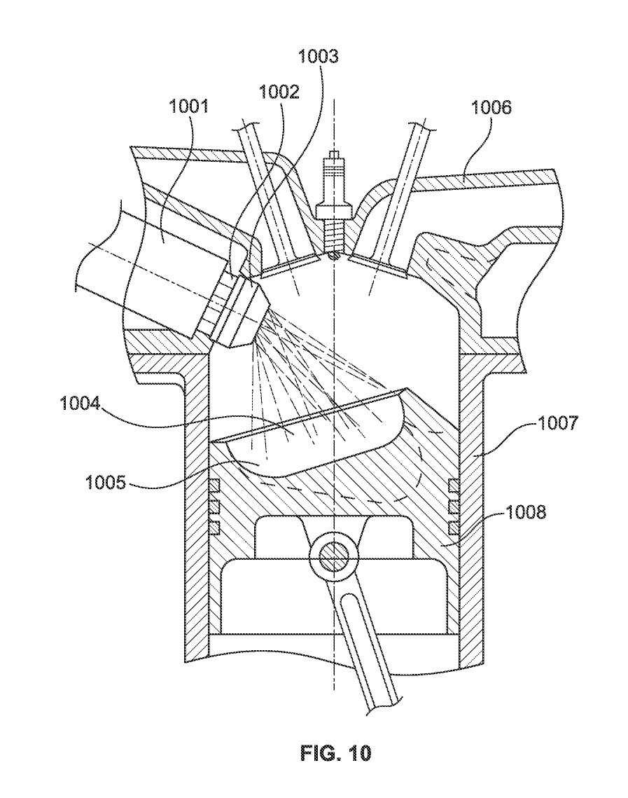

In FIG. 10 a cross section of a head of a cylinder of an internal combustion chamber is shown in which an activation module is placed directly into the combustion chamber and the activated fuel mix is injected into the combustion chamber. FIG. 10 includes the following features:

Position 1001, a device for preparation of the fuel mix;

Position 1002, —channels for the output of the activated fuel mix from the activation module to, for example, atomizers;

Position 1003, —an atomizer;

Position 1006, —a housing of the cylinder head;

Position 1007, —a housing of the cylinder block in an internal combustion chamber; and

Position 1008, —a piston.

In FIG. 11A, an axial cross section of a device for preparation and activation of a fuel mix consisting only of two components, one liquid and one gaseous, where the specified device may enter directly into the combustion chamber is shown. In FIG. 11B an axial cross section of the universal device for fuels activation is shown. FIGS. 11A and 11B include the following features:

Position 1101, —an external cylindrical housing of the device;

Position 1102, —a shaft of the housing of the hydraulic system of the device;

Position 1103, —a cylindrical pin of an integrated interface connecting an hydrodynamic and the aerodynamic systems of the device intended for use as the hydraulic system of the device;

Position 1104, —a conical axial pin of the hydraulic system of the interface;

Position 1105, —a conical axial pin of the aerodynamic system of the interface;

Position 1106, —a housing of the aerodynamic system of the device;

Position 1107, —regularly located openings in a forward end face of the housing 1106;

Position 1108, —an internal cavity of the housing 1106;

Position 1109, —spiral capillary channels distributed at regular intervals on the diameter of two conical reflectors incorporated into the design of the interface;

Position 1110, —an internal conical surface of the reflector of the integrated interface, which is located in the aerodynamic system flow of the device;

Position 1111, —an external conical surface of the reflector of the integrated interface which is located in the hydraulic flow of the device; system

Position 1112, —channels distributed at regular intervals for dispersal of the liquid organic fuel component, whose center is located on a circle, coaxial to all pins of the interface;

Position 1113, —a hydraulic “O” ring

Position 1114, —an internal conical surface of the housing of the hydraulic system of the device;

Position 1115, —channels for output of the fuel mix in, for example, an atomizer;

Position 1116, —a pipeline for supply of compressed air;

Position 1117, —an atomizer; and

Position 1118, —the fuel pipeline.

In FIG. 12A, a schematic is shown for the input, output, and movement of fuel mix components in a device for preparation and activation of a fuel gas mixture. In FIG. 12B the universal version of same device is shown. FIGS. 12A and 12B include the following features

Position 1201, —an input of a stream of an organic fuel component and transformation of this form in a conical chamber;

Position 1202, —a zone for dispersal of the stream of the organic fuel component and an increase of its turbulence;

Position 1203, —a zone for dispersal of a stream of compressed air, after changing the direction of its movement;

Position 1204, —due to low pressure, the zone in which the turbulent stream of the organic liquid component of the fuel is mixed with compressed air forms a pseudo-boiling volume which flows to an atomizer, for example, in a foamy stream of micro-bubbles;

Position 1207, —an output of the foamy stream of micro-bubbles through channels of output in, for example, an atomizer; and

Position 1208, —an integrated atomizer.

For all embodiments of the described device for preparation and activation of a fuel gas mixture, the process of preparation and activation includes the same technological transitions. Without taking into account the amount of the liquid components, the process flow has the following characteristics:

The liquid fuel component from a tank 501 in FIG. 5 moves by means of the fuel pump 502 into the hydraulic system 503 of the device for preparation, transformations and activation of the fuel mix. In this device, the liquid fuel component from the fuel pipeline 101 in FIG. 1 enters into a conical cavity 104, and gradually, as the liquid moves in a conical area of changing cross section, and as the stream of a liquid is at the same pressure, the speed of movement of a liquid increases, reaching its maximum speed before entering into the capillary openings 106 in housing 102.

As the total cross sectional area of all the openings is less than the area of the housing cavity that contains the base of the cone, the liquid is therefore dispersed even more in these openings which increases the Reynolds's number of the stream and considerably increases the turbulence level. Thus, as the fuel exits from the hydraulic system of the device, the fuel mix has a high speed of flow, a high level of turbulence, and as determined by the geometry of the hydraulic reflector 309 in FIG. 3, vortices in the streams.

Simultaneously with this process, in the aerodynamic system of the device, there is the input and transformation of a stream of the compressed air received from the compressor 505 in FIG. 5 which is connected to the rotation of a shaft of the device with the internal combustion chamber 508. Compressed air inside of housing 114 in FIG. 1 is gradually compressed and enters into capillary openings of 111, in which it is dispersed and exits in parallel with the conical surfaces of reflector 115, changes direction 180 degrees, and exits from the conical cavity of the reflector, thereby creating a low pressure zone in which the high speed the liquid fuel stream mixes. Thus, where the two streams meet, a pseudo-boiling volume is created in which a process of simulated boiling occurs, formed by explosions of large bubbles of air. As this stream is accelerated, smaller and smaller air bubbles are formed. This entire process happens as the fuel mix stream flows, for example, to atomizer 1117 in FIG. 11, or any other fuel input device that injects a fuel mix into the combustion chamber.

As described above, systems and methods can be used to form a shell of turbulent organic fuel surrounding a core of compressed gas. In some embodiments, the compressed gas can be air. In some additional embodiments, the compressed gas can be a gas other than air, for example, hydrogen.

In some embodiments, hydrogen under pressure can be used for combustion in the combustion chamber of an aircraft turbine or ramjet. Use of hydrogen can provide various advantages. For example, high density hydrogen slush can be used to cool wings of an aircraft and then brought up to temperature to combust, most likely as a gas. In some embodiments, hydrogen can be used as a liquid, which can be foamed. Either air or gaseous hydrogen can be injected in the aerodynamic system into a hydrogen liquid to form the micro-bubbles. As such, a hydrogen bubble coated with hydrogen liquid can be formed.

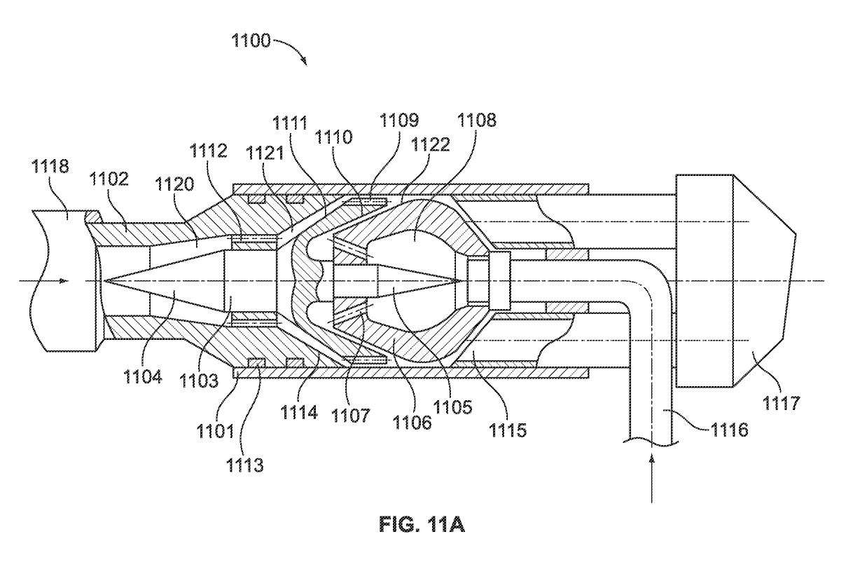

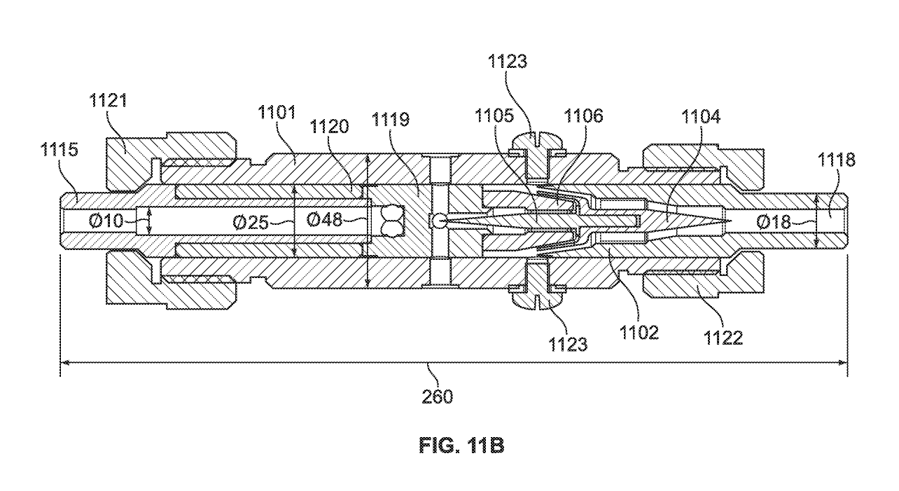

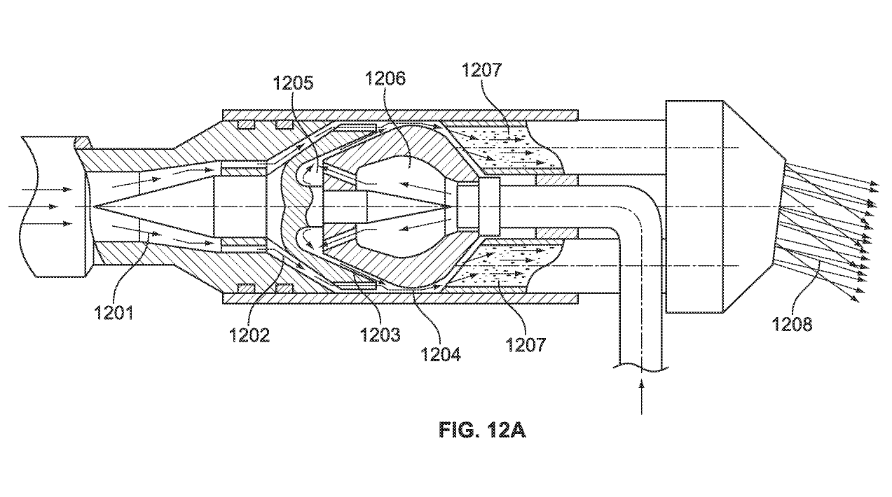

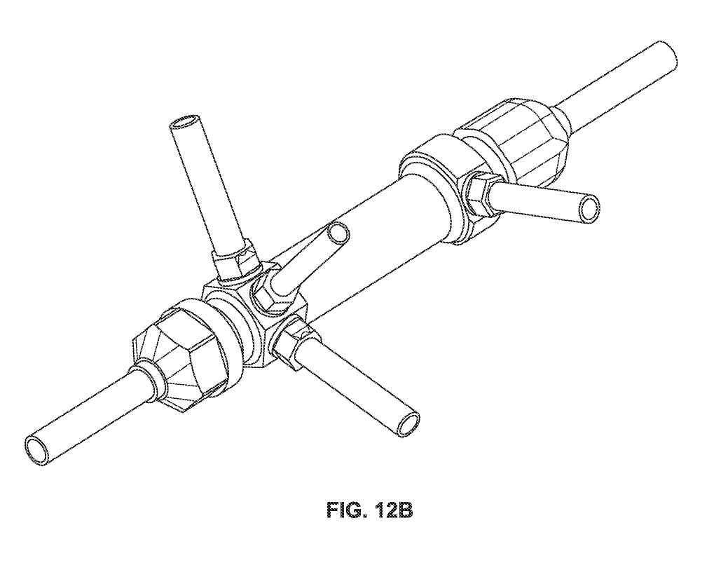

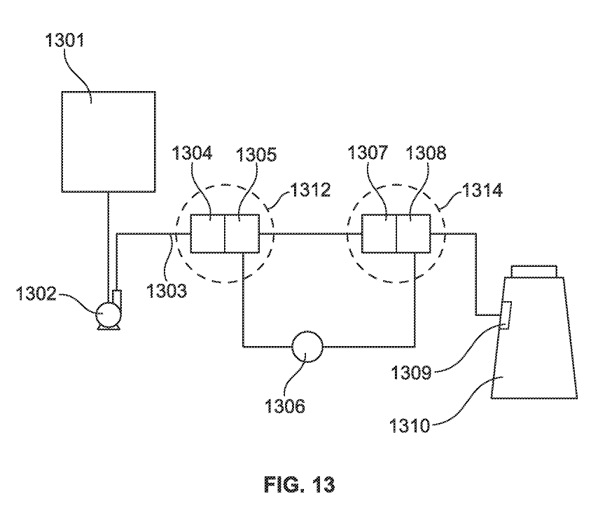

In FIG. 13, a block diagram of a step-wise process for consecutive activation of a fuel mix is shown. In this example, the fuel mix consists of only an organic liquid fuel. The fuel mix is input into the combustion chamber as a homogeneous, highly efficient high-calorie fuel.

During the flow of the fuel mix from the fuel tank to the combustion chamber, the process of activation occurs in a set of consecutive steps. In FIG. 13, this process is diagrammed, showing two distinct stages of the activation. The first stage of activation is after the output of the liquid fuel component from the fuel tank in the fuel pipeline, and the second stage of activation is before input (or injection) of the fuel mix into the chamber of combustion.

FIG. 13 includes the following features:

Position 1301—a fuel tank;

Position 1302, —a fuel pump;

Position 1303, —a site of a fuel pipeline before the first stage of activation;

Position 1304, —the hydrodynamic system of the first activation module;

Position 1305, —the aerodynamic system of the first activation module, connected to a compressor or other source of a compressed gas agent;

Position 1306, —a source of the compressed gas agent, for example, a compressor;

Position 1307, —the hydrodynamic system of the second activation module, connected to the output from the aerodynamic system 1305 of the first activation module, and located before the fuel is injected into the combustion chamber;

Position 1308, —the aerodynamic system of the device of the second activation module, connected with a source of the compressed gas 1306, and having an output connected to the input to the combustion chamber;

Position 1309, —an input into the combustion chamber, for example in the form of an atomizer; and

Position 1310, —a combustion chamber.

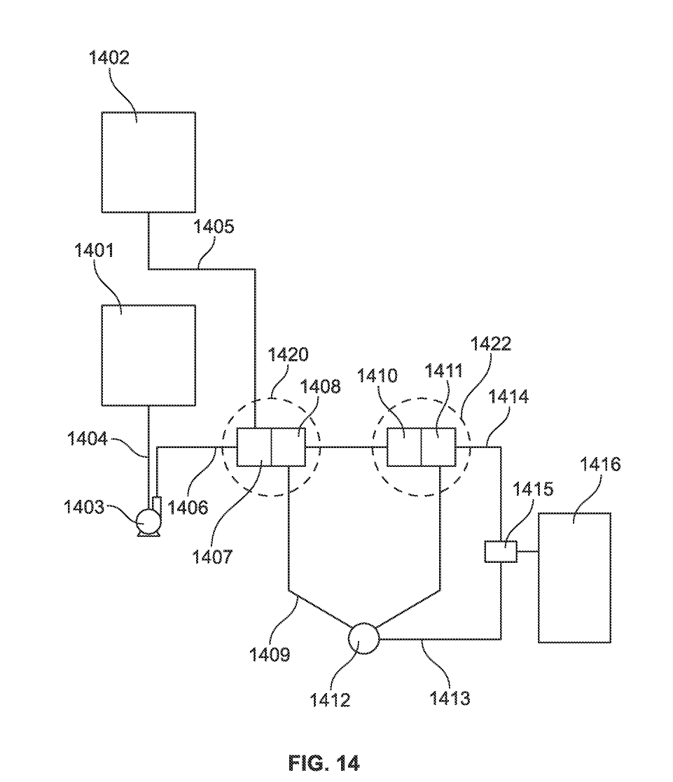

In FIG. 14, a block diagram of the step-wise process for consecutive activation of a multi-component fuel mix, with diverse liquid components, is shown. In this example, the fuel mix includes at least two liquid fuel components, one of which can be inorganic. The activated fuel mix enters the combustion chamber as a homogeneous fuel, thereby providing a highly efficient process of combustion. FIG. 14 includes the following features:

Position 1401, —a fuel tank for an organic component of the fuel mix;

Position 1402, —a fuel tank for an inorganic component of the fuel mix;

Position 1403, —a fuel pump;

Position 1404, —a pipeline connecting the fuel tank 1401 with fuel pump 1403;

Position 1405, —a pipeline connecting the fuel tank 1402 with the hydrodynamic system of the first fuel activation module;

Position 1406, —a pipeline connecting the fuel pump with the hydrodynamic system of the first fuel activation module;

Position 1407, —the hydrodynamic system of the first fuel activation module;

Position 1408, —the aerodynamic system of the first fuel activation module, connected with a source of the compressed gas; this module is then connected to the second activation module;

Position 1409, —a pipeline connecting the aerodynamic system of the activation module 1408 with a source of compressed gas;

Position 1410, —the hydrodynamic system of the device the second activation module;

Position 1411, —the aerodynamic system of the second activation module;

Position 1412, —a source of the compressed gaseous working agent, for example, a compressor;

Position 1413, —a pipeline connecting the compressor with the input device to the combustion chamber, for example, an atomizer;

Position 1414, —a pipeline connecting the output of the second activation module to the combustion chamber, for example, an atomizer;

Position 1415, —a device for input of the fuel mix to the combustion chamber; and

Position 1416, —a combustion chamber.

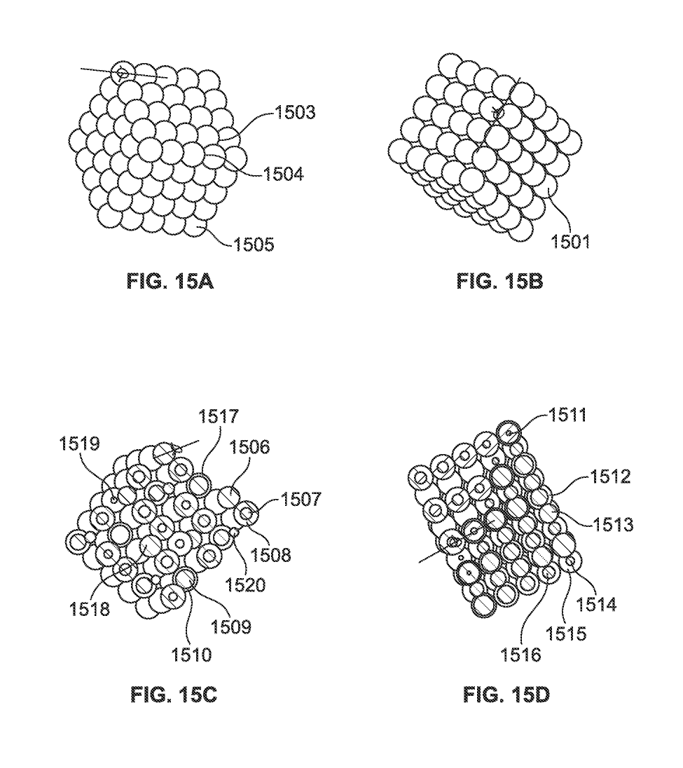

In FIG. 15, the volumetric structure of the fuel mix after activation is shown. FIG. 15A shows the volumetric structure after the first stage of activation, when the volume made of foam bubbles have not started to be transformed in space of the fuel pipeline and are as though pressed to each other.

FIG. 15B shows the volumetric structure during the moment when the bubbles have started to be transformed in the fuel mix, separating from each other.

FIGS. 15C and 15D show the internal processes in the activated volume of a fuel mix as it moves in the fuel pipeline. When injected into the combustion chamber during one running cycle, the kinetic parameters of the activated volume of the fuel mix, in combination with the large active surface area of an activated unit dose of fuel, makes the burning process highly efficient.

FIGS. 15A-15D include the following features:

Position 1501, —a fuel composite sphere in a mode of transformation during movement from the first activation module to the second activation module;

Position 1502, —the form of contact between composite fuel spheres during transformation;

Position 1503, —the form of contact between fuel spheres in their homogeneous mode after the second activation module step;

Position 1504, —the form of contact between fuel spheres in their homogeneous mode after the second activation module step;

Position 1505, —composite fuel spheres in their homogeneous mode after the second activation module step;

Position 1506, —one variant of the fuel sphere, without a kernel of compressed gas, in a mode of transformation after the first activation module step;

Position 1507, —one variant of the fuel sphere with a kernel of compressed gas;

Position 1508, —a coating on the fuel spheres made from a combustible composite, for example gasoline or a mix from gasoline and water;

Position 1509, —one variant of fuel spheres with the maximum diameter of a kernel from the compressed gas and the minimum thickness of a coating from a combustible composite;

Position 1510, —a coating of the fuel sphere with the minimum thickness;

Position 1511, —a kernel of the fuel sphere with the minimum diameter;

Position 1512, —a coating on a fuel sphere with insufficient thickness which cannot provide stability due to forces from superficial tension;

Position 1513, —a kernel of fuel sphere, practically without a coating;

Position 1514, —a kernel of fuel sphere with optimum size;

Position 1515, —a coating on a fuel sphere of the optimum size at which diameter of a kernel is equal to thickness of the coating; and

Position 1516, —a fuel sphere with transitive sizes at which thickness of the coating is equal to the radius of a kernel.

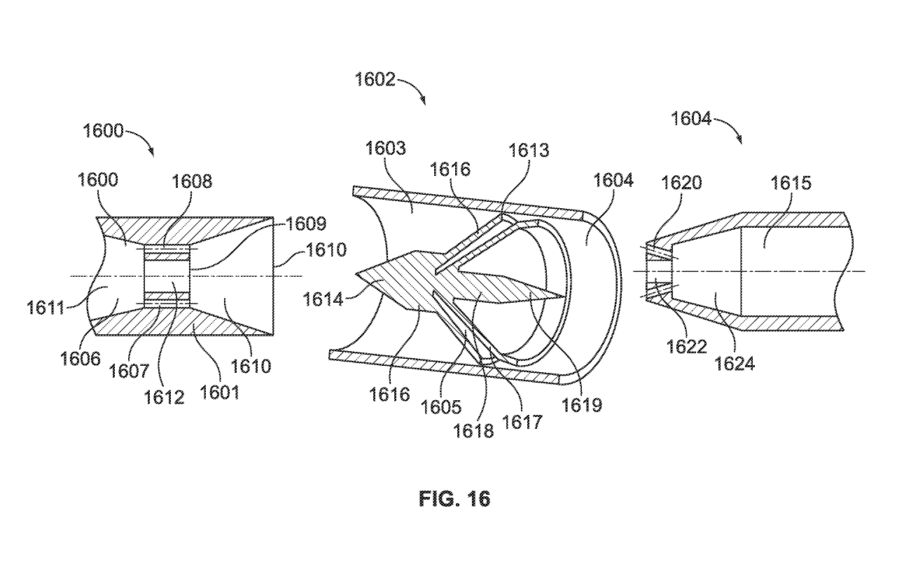

FIG. 16 shows the structures of the hydrodynamic and aerodynamic housings, pressed together components of the fuel mix activation module, and separated to reveal their individual details. FIG. 16 includes the following features:

Position 1601, —a hydrodynamic housing;

Position 1602, —an aerodynamic housing;

Position 1603, —a central orientation hole;

Position 1604, —a central orientation hole;

Position 1605, —inside a conical chamber;

Position 1606, —inside a conical chamber;

Position 1607, —micro-holes;

Position 1608, —micro-holes;

Position 1609, —a small diameter;

Position 1610, —a large diameter; Position 1611, —a fuel pipe;

Position 1612, —a small diameter;

Position 1613, —a large diameter;

Position 1614, —a liquid working agent input; and

Position 1615, —a gaseous working agent input;

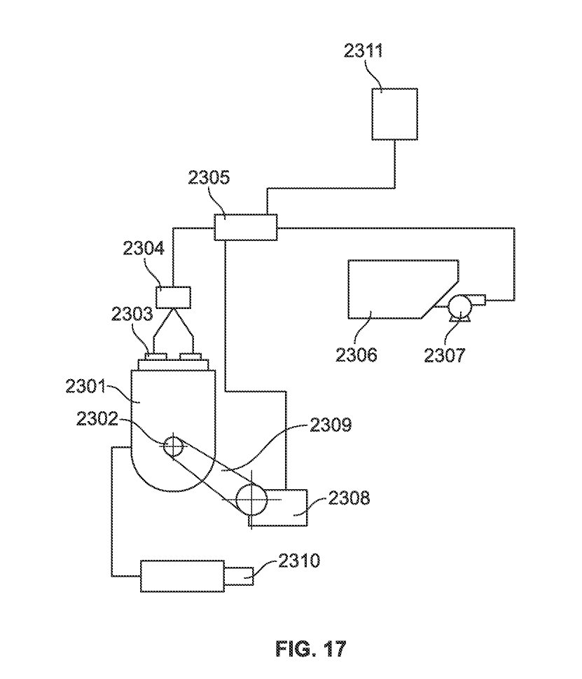

In FIG. 17, a schematic of an internal combustion engine block is shown.

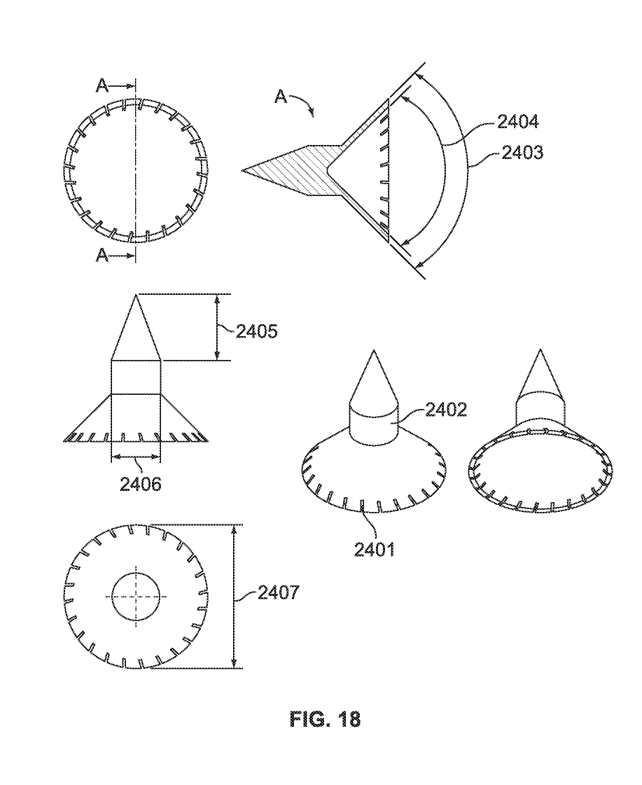

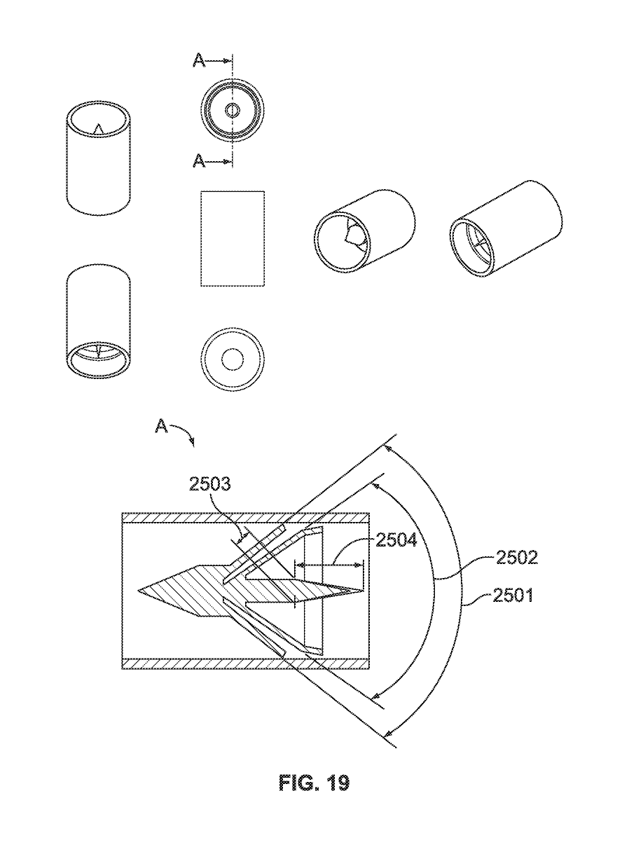

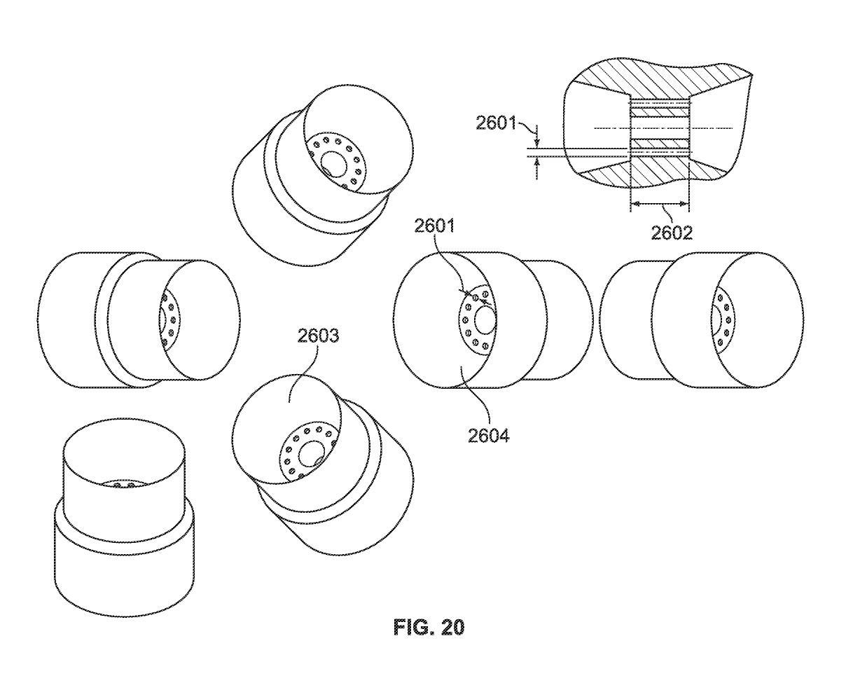

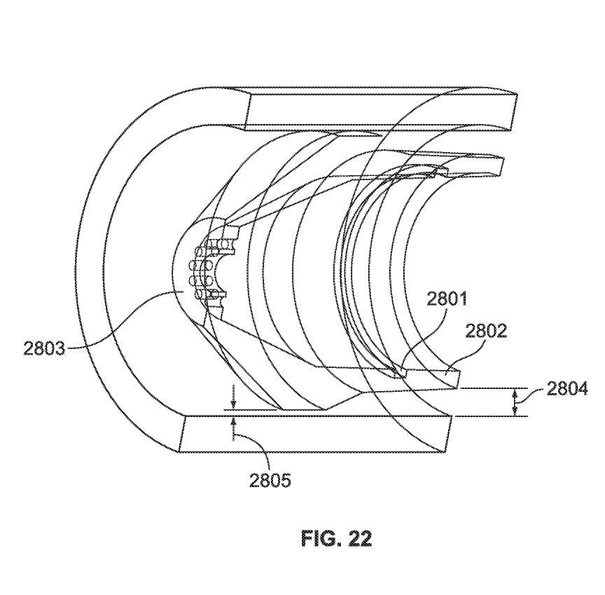

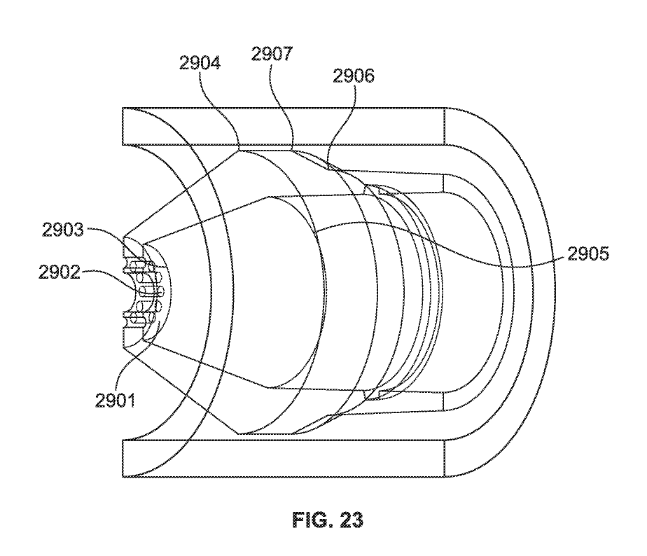

In FIGS. 18-23, geometrical relationships and design features of the housing of the hydraulic system are shown. In FIG. 20 the housing 2603 of the hydraulic system are shown and the geometrical relationships of the diameters of holes 2601 and the length 2602 of the same holes are shown; also, FIG. 18 shows the geometrical relationships of reflectors 2402 and parameters 2401, 2403, 2404,2405,2406, and 2407; FIG. 19 shows parameters 2501,2502,2503,2504;

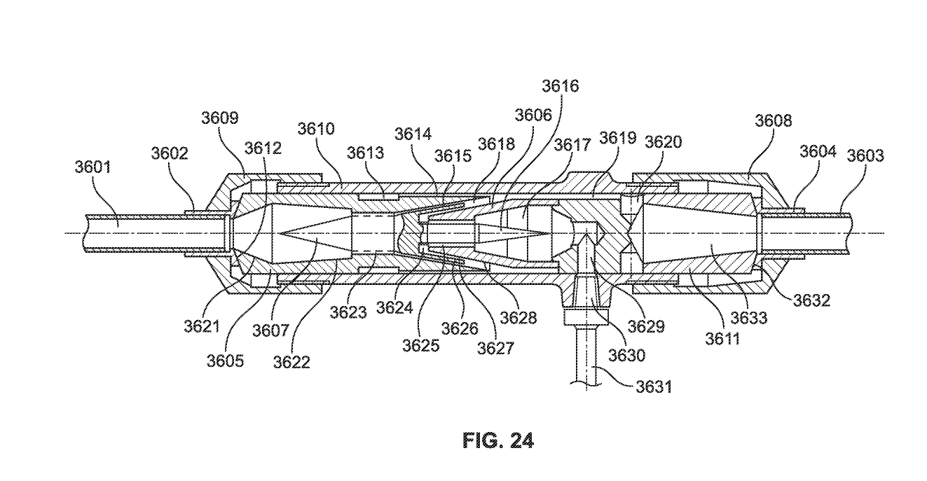

In FIGS. 24, 25, 26, 27, 28, and 29, various design versions of fuel activation device are shown.

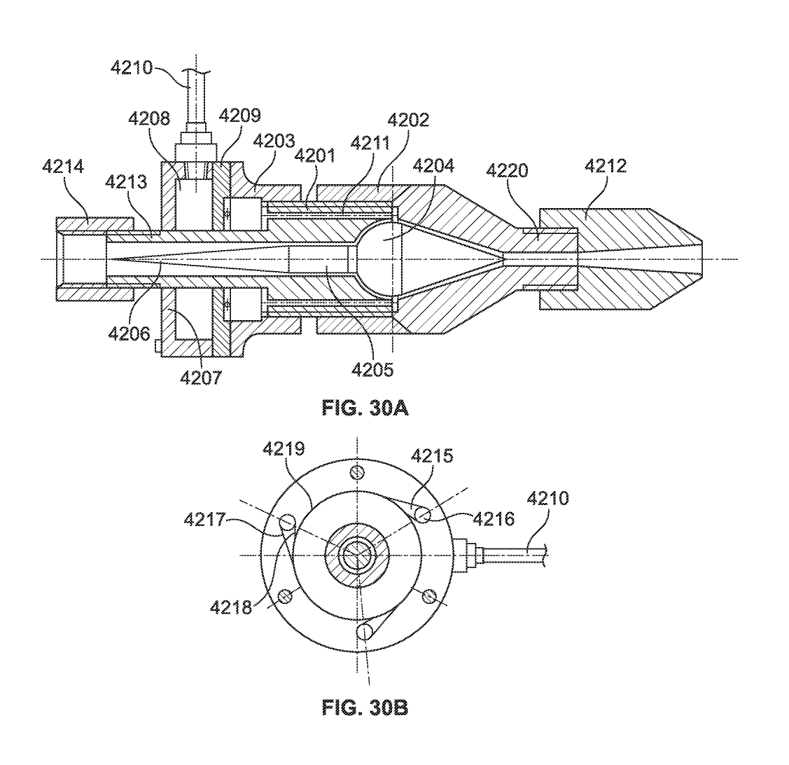

In FIGS. 30A and 30B, a gaseous component and air mixing device with an input vortex generator is shown.

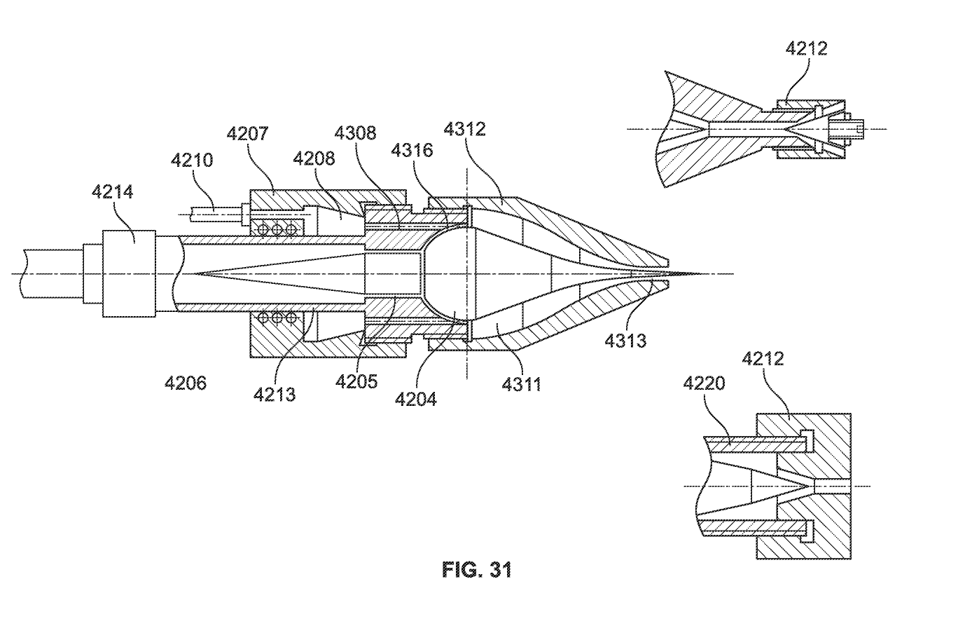

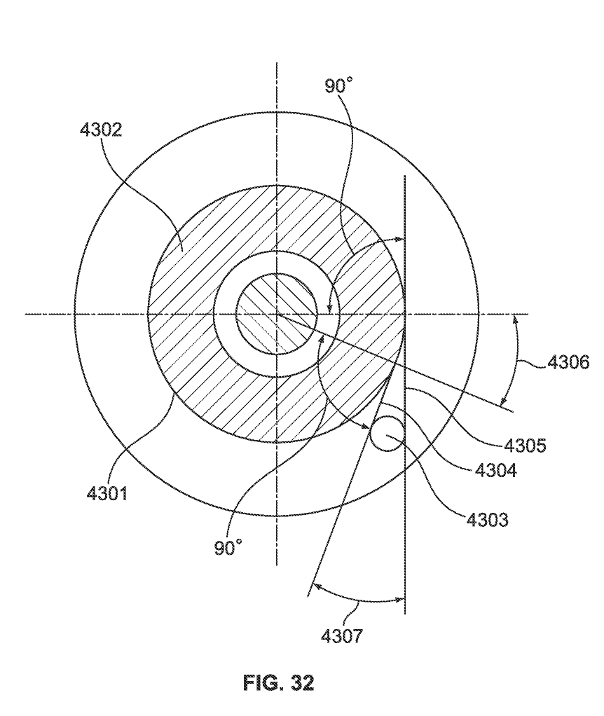

In FIGS. 31 and 32, a device and its components for aerodynamic activation of a gaseous component by mixing the gas with compressed air and cooling the gaseous mix during the mixing process is shown

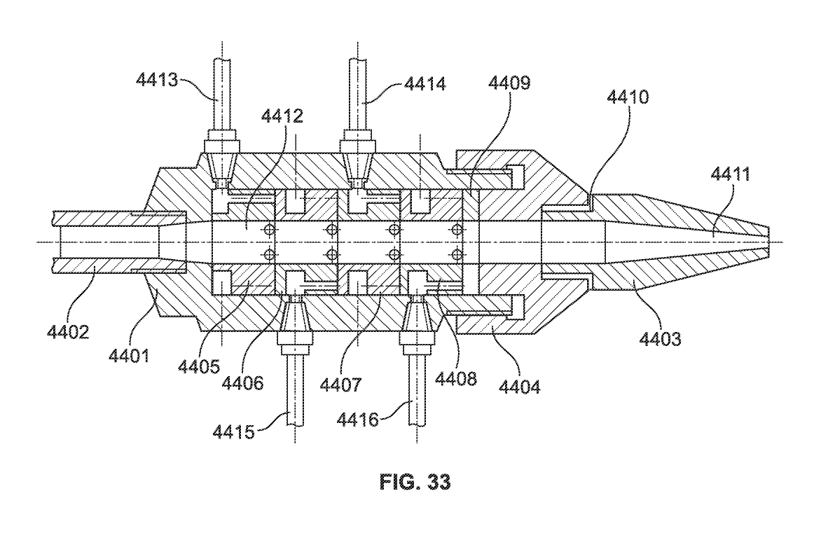

In FIGS. 33, 34, 35, the device for mixing and cooling a gaseous component with air—shown

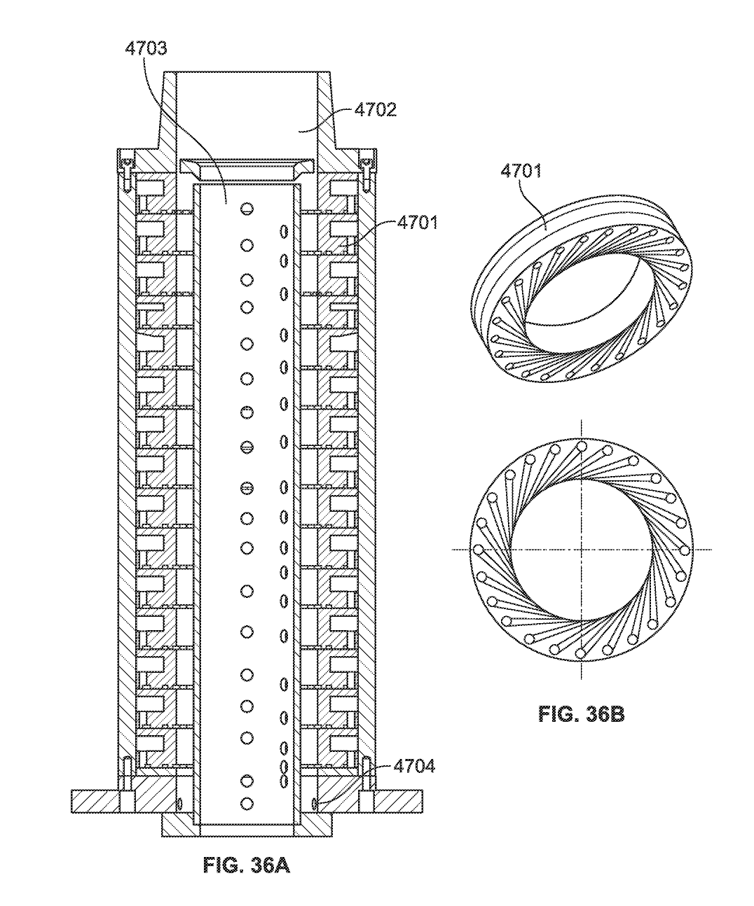

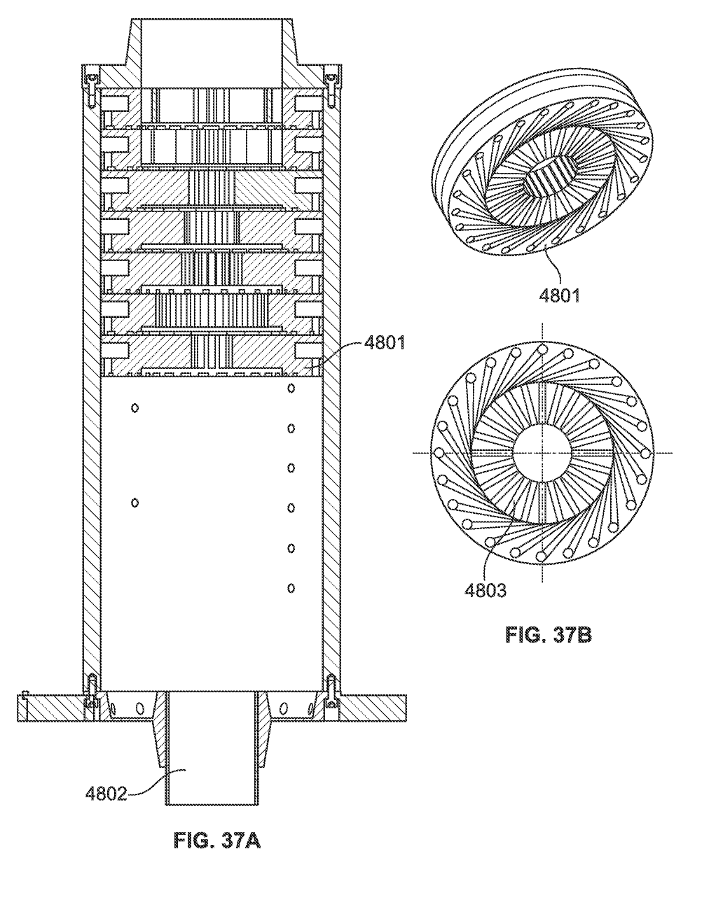

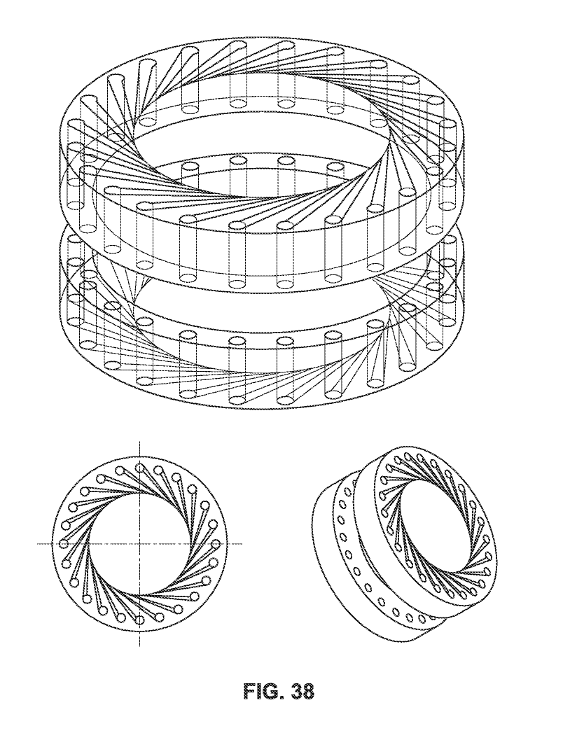

In FIGS. 36A, 36B, 37A, 37B and 38, water producing and cooling devices using vortex generator models are shown.

Fuel Activation Device for Generating a Fuel Mix That Includes Two Liquid Components:

Referring to FIGS. 1, 1A, 1B and 1C, FIG. 1 shows a cross-sectional view of an exemplary fuel activation device 100 and FIG. 2A shows the flow of liquids and air within the fuel activation device 100 of FIG. 1 to generate a foamed fuel. The fuel activation device 100 is located in a fuel pipeline 101 and includes a hydrodynamic portion 210 and an aerodynamic portion 212 (FIG. 2A). The hydrodynamic portion 210 and aerodynamic portion 212 overlap in an interface region. The hydrodynamic portion 210 mixes two (or more) liquids and generates turbulence in the liquids and the aerodynamic portion 212 mixes the turbulent liquid with compressed gas to form micro-bubbles 207.

As described in more detail herein, during use, fuel and another liquid (e.g., water, the same fuel, or a different fuel) are input into the hydrodynamic portion 210 of the fuel activation device 100 (as indicated by arrows 203 and 201). The fuel and other liquid are mixed in a zone of low pressure 110 using the hydrodynamic effect of the Bernoulli Theorem. After mixing the fuel with the other liquid, the fuel mix passes in a turbulent condition to the aerodynamic portion 212 of the fuel activation device 100. In the aerodynamic portion 212, a gas such as compressed air is provided to the aerodynamic portion 212 of the fuel activation device 100 (as indicated by arrow 205) and is mixed with the fuel mixture in a zone of low pressure 116. After mixing the fuel with the gas, a pseudo-boiling layer is formed in the fuel mix. This pseudo-boiling layer stabilizes to form a foamed fuel (as indicated by arrow 207) which is output to a combustion chamber for combustion (as indicated by arrow 208).

More particularly, the fuel activation device 100 provides a method for preparing a fuel gas mixture for submission into the combustion chamber. During use, fuel from a tank, such as an organic fuel, is input into the fuel pipeline 101 under pressure. The fuel is dispersed into the fuel stream moving in the fuel pipeline 101, and forms a local zone of increased turbulence and low pressure 110. A second liquid component, for example water, is driven into the local low pressure zone 110 under a pressure which exceeds the pressure in the local low pressure zone 110. The two liquid components are hydro-dynamically mixed within vortices of the fuel activation device 100 and a turbulent movement is developed in the fuel pipeline 101. A gaseous component such as compressed air is driven into the pipeline 101 under pressure and opposite the direction of movement of the stream of the two-component fuel mixture. The compressed air forms a second zone of local low pressure 116 in the fuel activation device 100. The zone of low pressure 116 has a pressure lower than the pressure of the two-component fuel mixture stream prior to its interaction with the gaseous component. A local pseudo-boiling condition is formed in the fuel mixture in the second zone of low pressure 116 as the fuel mixture moves in the direction of the combustion chamber. The gradual increase in local pressure in the fuel stream changes the fuel stream from a fuel mixture in a pseudo-boiling condition into a substantially homogeneous fuel mixture stream of micro-bubbles.

As described above, the fuel activation device 100 includes a hydrodynamic portion 210 and an aerodynamic portion 212. The hydrodynamic portion 210 of the fuel activation device 100 includes a housing 102 that forms a cavity 104. During use, the cavity 104 receives fuel from the fuel line 101.

The cavity 104 is conical in shape with a decreasing cross-sectional area in the direction of the fuel flow. More particularly, the cavity 104 has a greater diameter near an end where fuel enters the fuel activation device 100 than at locations along the path of the fuel flow subsequent to entry of the fuel. The decreasing diameter of the cavity 104 increases the turbulence in the flow of liquid in cavity 104 and increases the pressure of the fuel as the fuel flows in the fuel activation device 100.

A cone 103 is located inside the cavity 104 such that fuel passing through the cavity 104 passes over the cone 103. The cone 103 has a conical shape with the tip 119 of the cone 103 pointing toward the end of the cavity 104 where fuel enters the fuel activation device 100. The inclusion of the cone 103 in the cavity 104 further decreases the area in which the fuel can flow and increases the pressure in the fuel as the fuel passes through the fuel activation device 100. The conical shape of the cavity 104 and cone 103 also increases turbulence in the fuel as the fuel flows through the pipeline due to the increased contact of the liquid with the surface of cone 103. In general, in a fuel pipeline the turbulence is greatest near the surfaces of the pipeline and the flow is less turbulent in the middle of the pipeline. A conical surface (such as the conical surface of cavity 104 and of cone 103) increases the turbulence in the fuel by increasing the surface area which the fuel contacts. As shown in FIG. 1, the cone 103 also transforms the flow of the fuel stream from having cylindrical flow to having conical flow. In the fuel pipeline prior to the region that includes the cone, the fuel has a laminar flow. In the laminar flow, a portion of the fuel nearest to the pipeline has increased turbulence. When the fuel passes over the cone 103, the cone 103 transforms the flow from the cylindrical flow to a conical flow. The cone 103 also increases the turbulence in the fuel because the fuel contacts the edge of the cone causing the direction of the flow of the fuel to change. As such, turbulence is increased in the flow of fuel due to the presence of cone 103.

The hydrodynamic portion 210 of the fuel activation device 100 includes multiple channels 106 located at an end of the cavity 104 opposite of the end at which the fuel enters the fuel activation device 100. After the fuel flows through the cavity 104, the fuel enters the channels 106. The channels 106 are distributed at regular intervals on a circle and have a length at least 10 times greater than their diameter. In general, the spacing of the channels is determined based on the size of the fuel activation device. The channels are fluidly connected at one end to the conical cavity 104 at a base of the conical reflector 103 and at the other end to a conical capillary ring channel 109. The conical ring channel 109 is a conical channel in which the fuel can flow. The conical ring channel 109 is formed in a region between two differently sized conical shaped surfaces. During use, fuel from the cavity 104 is directed through the channels 106 and through the conical ring channel 109. As the fuel moves from the cavity 104 through the channels 106 and 109, the speed of the stream of fuel increases and simultaneously the turbulence of the stream increases.

The hydrodynamic component 210 of the fuel activation device 100 also includes a ring cavity 105 that receives a second liquid such as water, the same fuel, or a different fuel. The ring cavity 105 is fluidly connected to a channel ring 107. The ring cavity 105 and the ring channel 107 are located between the internal surface of the pipeline 101 and an external surface of the housing 102 of the hydrodynamic component 210. During use, the liquid flows through the ring cavity 105 and into the ring channel 107 (as shown by arrow 201). The width of the ring cavity 105 is greater than the width of the channel ring 107. As such, when the liquid flows from the ring cavity 105 through the channel ring 107 the pressure and turbulence of the liquid increase.

The fuel activation device 100 includes a low pressure zone 110 at the intersection of the hydrodynamic component 210 and the aerodynamic component 212. The liquid from the channel ring 107 and the fuel from conical ring channel 109 are output into the low pressure zone 110. The fuel from the conical ring channel 109 is directed into the low pressure zone 110 at an angle with respect to the direction of flow of the liquid entering the low pressure zone 110 from the channel ring 107, thereby promoting mixing of the two liquids.

The shape of the low pressure zone 110 promotes hydrodynamic mixing of the liquid components from the channel ring 107 and ring channel 109 to form a fuel mix and promotes turbulence in the fuel mix. The local low pressure zone 110 increases turbulence in the liquid components of the fuel mix resulting from the hydrodynamic effect created by utilizing the physical principles of Bernoulli's Theorem. The turbulent fuel mix in the low pressure zone 110 is directed into the aerodynamic portion 212 of the fuel activation device 100 where the fuel mix is further mixed with a gaseous component such as air.

The aerodynamic portion 212 of the fuel activation device 100 includes a housing 114 that receives a stream of compressed gas and transforms a direction of the flow of the compressed gas. A pipeline 118 provides an input for the compressed gas into the aerodynamic portion 212 (as indicated by arrows 202). The pipeline 118 for inputting the compressed gas has a smaller diameter than a diameter of the fuel pipeline 101. The housing 114 of the aerodynamic portion 212 forms a cavity 123 that receives the compressed gas from the pipeline 118. The cavity 123 includes a first portion 122 having a similar shape and diameter to the shape and diameter of pipeline 118 and a second portion 120 having a conical shape with a decreasing cross-sectional area. More particularly, portion 120 of cavity 123 has a greater diameter at an end where compressed gas enters portion 120 from portion 122 than at locations along the path of the gas flow subsequent to entry of the compressed gas. The decreasing diameter of the cavity 123 in portion 120 increases the air pressure of the gas as the gas flows through the fuel activation device 100. The conical shape also increases the turbulence in the gas flow.

A cone 113 is located inside the cavity 123 such that gas passing through the cavity 123 passes over the cone 113. The cone 113 has a conical shape with the tip 125 pointing toward the end of the cavity 123 where the compressed gas enters the fuel activation device 100 from the pipeline 118. As such, the inclusion of the cone 113 in the cavity 123 further decreases the area in which the gas can flow and increases the pressure of the gas. The cone 113 also modifies the direction of the air flow in the fuel activation device 100 and directs the compressed air into a set of openings 111. The openings 111 divide the stream of the compressed gas into capillary micro-streams of compressed gas. The openings 111 are distributed at regular intervals about the base of cone 113. In general, the spacing of the openings 111 and the number of openings 111 can be based on the size of the fuel activation device 100. The openings 111 are connected at one end to the cavity 123 near the base of the cone 113 and at the other end to an opening 126. Opening 126 is connected to a conical channel ring 112. As the gas flows from the cavity 123, through the openings 111, and into the conical channel ring 112, the stream of the compressed gas changes direction.

More particularly, the gas enters the aerodynamic portion 212 of the fuel activation device 100 in a direction substantially opposite to the direction of the fuel flow and exits the aerodynamic portion 212 of the fuel activation device 100 in a direction that is substantially the same as the direction of the fuel flow. A stabilizer 115 included in the conical reflector supports the high speed of movement of gas. The stabilizer provides maintenance of thickness of a stream of the activated fuel mix in limits that define maintenance of speed of a stream in proportional limits and maintenance of a level of kinetic energy of a stream and its fragments in certain limits.

The stabilizer 115 forms a channel 127 disposed at an angle to the ring channel 112. Due to the high speed of movement of the stream of compressed gas through the conical channel ring 112 and stabilizer channel 127, when the compressed gas exits the conical channel ring 112 and stabilizer channel 127, a local zone of low pressure 116 is formed at the point where the compressed gas exits the conical channel ring 112 and stabilizer channel 127. The fuel mix from low pressure zone 110 is delivered into the local zone of low pressure 116 through a channel 128 such that the compressed gas from the stabilizer channel 127 mixes with the fuel mix. The mixture of the gas and fuel generates a pseudo-boiling volume in the low pressure zone 116 of the fuel activation device 100 (as indicated by arrow 206). The fuel and gas mixture flows away from the low pressure zone 116 and into a ring area 117. Ring area 117 has a larger diameter than that of the low pressure zone 116. The pressure in the liquid and air mixture increases as the pseudo-boiling volume flows away from the low pressure zone 116 and into ring area 117. In ring area 117, the pseudo-boiling volume of fuel and gas at least partially stabilizes to form a foam of micro-bubbles of fuel (as indicated by arrows 207 and 208).

In general, the micro-bubbles of fuel are formed of a core of compressed gas surrounded by a shell of fuel or fuel mixed with another liquid. In the foam of micro-bubbles, the ratio of the volume of gas to the volume of fuel can be from about 10% to about 30% (e.g., from about 10% to about 15%, from about 15% to about 25%, from about 25% to about 30%). The size of the micro-bubble can also vary. For example, the diameter of the core of compressed gas can be from about 0.15 mm to about 0.3 mm (e.g., from about 0.15 mm to about 0.2 mm, from about 0.2 mm to about 0.25 mm, from about 0.25 mm to about 0.3 mm).

In order for the micro-bubble to remain stable for a length of time prior to entry of the micro-bubble into a combustion chamber, the shell of the liquid surrounding the compressed gas is thick enough to prevent the micro-bubble from bursting. For example, the micro-bubble can have a shell thickness of from about 0.1 mm to about 0.3 mm (e.g., from about 0.1 mm to about 0.2 mm, from about 0.2 mm to about 0.25 mm, from about 0.25 mm to about 0.3 mm). The diameter of the core of compressed gas and the thickness of the shell of liquid can vary in a volume of foamed fuel. For example, not all of the fuel must be in a foamed micro-bubble condition. In some embodiments, the physical-chemical properties of the fuel after processing by the fuel activation device 100 are maintained until combustion. In order to maintain the properties of the processed fuel, it can be beneficial to place the fuel activation device 100 near the combustion device.

While in at least some examples described above, the fuel activation device is described generally as mixing fuel and water, the fuel activation device can mix various types of liquid components. For example, the fuel activation device can mix two dissimilar liquid components such as gasoline and water. In some additional examples, the fuel activation device can mix two homogeneous components, such as gasoline and ethanol. In yet additional examples, the fuel activation device can mix at least three diverse components, such as gasoline, ethanol and water. In such embodiments, two of the components are provided to one of the liquid inputs to the hydrodynamic portion of the fuel activation device 100. In yet other examples, the same liquid can be provided to both inputs to the fuel activation device 100, for example, a fuel such as gasoline can be provided to both liquid inputs of the fuel activation device 100.

FIG. 6 shows a block diagram of a system that includes a fuel activation device for generating and activating a multi-component fuel gas mixture for burning in a combustion chamber. The system 600 includes a tank 601 that stores organic fuel and a tank 602 that stores a second liquid component such as an inorganic liquid to be mixed with the organic fuel from tank 601. A pipe 603 is connected between the tank 602 and a hydrodynamic system 605 of a fuel activation device and provides an input of the inorganic fuel component to the activation device for hydrodynamic mixing with the organic fuel. A fuel pump 604 pumps the fuel from the tank 601 through a pipeline to the hydrodynamic system 605 of a fuel activation device. During use, the hydrodynamic system 605 of the fuel activation device hydro-dynamically mixes the organic and inorganic fuel components. The hydrodynamic system 605 of a fuel activation device is connected to an aerodynamic system 607 that produces complex aerodynamic effects on the fuel mix. More particularly, the aerodynamic system 607 mixes the liquid from the hydrodynamic system with a gaseous component. The air used in the aerodynamic system 607 can be provided from a compressor 608 with a drive of rotation from a shaft of the device with the internal combustion chamber. After the fuel has been activated (e.g., the air and liquid mixed to form micro-bubbles), the fuel mix can be submitted to a cylinder within an internal combustion chamber 610 through a system of fuel atomizers 609.

Dimensional Dependencies of Elements of the Fuel Activation Device:

In some embodiments, various dimensional relationships within the fuel activation device can be set to increase the turbulence within the fuel and to generate a foam. Geometrical forms of the fuel activation device can be limited by the size of the fuel pipeline as well as parameters of a stream of a fuel mix moving in this pipeline such as pressure in a stream of a fuel mix, the quantity of a fuel mix which is passing through system of the fuel pipeline in unit of time, viscosity of a fuel mix, density of a fuel mix, the temperature of a fuel mix and the Reynolds's number of a stream of a fuel mix. Exemplary dimensional relationships are presented in FIGS. 7 at L-1, 8A, and 8B, however, other dimensional dependencies are possible.

The introduction of the fuel activation device in a fuel pipeline has the potential to change the pressure, velocity and turbulent conditions in the pipeline and can lead to deformation of the fuel flow if the fuel does not remain adequately compressed. As such, a ratio between the diameter of the fuel pipeline and an area of the fuel activation device component dimensions is selected to promote the transport of the fuel through the fuel activation device and the formation of foamed fuel, based upon conditions in a particular embodiment.

FIGS. 7, 8A, and 8B show the relationship between different dimensions of the fuel activation device. In FIGS. 7, 8A, and 8B the following dimensions are shown:

d1=outer diameter of the hydrodynamic housing of the fuel activation device forming the diameter d2 as the difference between the inside diameter of the pipeline housing the activation device D and d1;

d=internal diameter of the input fuel pipeline;

D=internal diameter of the pipeline in which the fuel activation device is located;

S=the areas of system;

L=length forming a conical reflector;

L1=length of the open active working surface of a target cone of hydraulic system of the housing of the activating device;

d2=diameter of capillary apertures in the housing; and

d3=diameter of the smaller basis of the truncated cone on an input in the device of activation.

In some embodiments, the following empirical formulas can be used to determine the size of various components in the fuel activation device:

S(D−d1)=S(d)

S(D−d1)=0.9S(d);

L=min 15(d2); and

L1=min 8(d2).

In some embodiments, the cross section area of the hydraulic system of the fuel activation device should not be more than 10% greater than the cross-system area of the input fuel line.

In some embodiments, the length of a conical surface of the hydraulic reflector in the fuel activation device, 109 in FIG. 1, should be at least in 15 times greater than a diameter of capillary apertures in the housing of the hydraulic system of the device, 106 in FIG. 1.

In some embodiments, the Length of the conical surface, L in FIG. 8B, of a cone of the hydraulic system housing of the fuel activating device is at least in 8 times greater than a diameter of capillary apertures in the housing of the hydraulic system of the device, 106 in FIG. 1 system

Structure of the Pre-Activated and Activated Fuel Mix:

Without being bound by theory, FIGS. 15A-D show exemplary structures of the fuel mix at different stages of the fuel activation within the fuel activation device.

In FIG. 15A, the volumetric structure of the fuel mix after the first stage of activation (e.g., after the fuel is mixed with the second liquid component in the first low pressure zone) is shown. As shown, during this stage of activation, the bubbles are closely pressed to each other. In the volume of fuel, multiple fuel spheres 1501 contact each other as indicated by line 1502. At this stage, the fuel has not yet been mixed with the gaseous component.

In FIG. 15B, the volumetric structure during the moment of the fuel mix from low pressure zone 110 to low pressure zone 116 is shown. During this stage of activation, the volume of bubbles have started to separate from each other due to the turbulence in the fuel. The volumetric structure of the fuel includes multiple fuel spheres in their homogeneous mode. The multiple fuel spheres contact each other as indicated by lines 1504 and 1505.

FIGS. 15C and 15D show the activated volume of a fuel mix as the fuel mix moves in the fuel pipeline subsequent to mixing of the gas with the fuel mix in low pressure zone 116. As shown in FIG. 15C, when the fuel mix is first mixed with the compressed gas in the low pressure zone 116, spheres of fuel are formed with a random arrangement. Upon initial mixing, some of the fuel forms micro-spheres of fuel while other portions of the fuel remain as spheres of fuel 1517 without an interior core of compressed gas. In addition, kernels of compressed gas 1506 exist in the fuel mix and have not yet been coated with fuel to form a microsphere. The mixture also includes microspheres 1507 where the microsphere includes a kernel of compressed gas surrounded by a shell 1508 of the liquid. The shell 1508 on the fuel spheres is made from a combustible liquid, for example gasoline or a mix from gasoline and water. The thickness of the coating 1508 can vary between different fuel spheres in the mixture. For example, fuel sphere 1509 is a fuel sphere with the maximum diameter of a kernel of compressed gas and a minimum thickness of a coating 1510 of combustible composite while fuel sphere 1518 shows a smaller kernel 1519 of gas and a thicker coating 1520 of the fuel.

As shown in FIG. 15D, as the fuel-air mix stabilizes, the bubbles of fuel align to form a foam. In the stabilized fuel air mix, the average diameter of the fuel spheres (e.g., the diameter of the compressed gas core if present and the shell of fuel) becomes similar. While the average diameter of the fuel spheres is constant, the diameter of the kernel of compressed gas can vary between fuel spheres. For example, some fuel spheres, such as fuel sphere 1511, have a core of a small or minimal diameter while other fuel spheres, such as fuel sphere 1512, have a kernel that is so large that the coating on the fuel sphere has an insufficient thickness to provide stability due to forces of superficial tension. Over time, fuel spheres such as fuel sphere 1512 are likely to burst. In order to reduce the number of fuel spheres that burst prior to combustion, the time between formation of the foamed fuel and combustion of the fuel can be short.

Other fuel spheres such as fuel sphere 1513 have an incomplete coating. Other fuel spheres have a kernel of compressed gas and a shell of liquid that have sizes providing a generally stable micro-bubble. In general, it can be desirable to form micro-bubbles having a ratio of the radius of the kernel of compressed to the thickness of the shell of liquid of between about 0.8 and 2.5 (e.g., between about 1 and about 2, between about 1.5 and about 2, about 2). Such a ratio can provide a stable micro-bubble that is less likely to burst while still providing an increased surface area of the fuel. For example, microsphere 1517 has a kernel 1514 of compressed gas that has a diameter about equal to the thickness of the shell of liquid 1515 coating the kernel 1514, and microsphere 1519 has a kernel 1516 of compressed gas that has a radius about equal to the thickness of the shell of liquid 1518 coating the kernel 1516.

The foamed fuel (e.g., such as the fuel shown in FIG. 15D) is inserted into a combustion chamber. When injected into the combustion chamber during a running cycle, the kinetic parameters of the activated volume of the fuel mix, in combination with the large active surface area of an activated unit dose of fuel, makes the burning process highly efficient. For example, a ratio of the surface area of the fuel after activation to a surface area of the fuel prior to activation can be from about 100 to about 1000 (e.g., from about 100 to about 250, from about 250 to about 500, from about 500 to about 1000).

Fuel activation device for generating a fuel mix that includes a single liquid component and a gaseous component:

Referring to FIGS. 3A, 3B, 4, and 5, in some embodiments a fuel activation device can include a single liquid input. FIG. 5 shows a block diagram of a fuel activation system 500. The fuel activation system 500 includes a fuel activation device 510 that has a single liquid input. The fuel activation device 510 receives fuel and generates a foamed fuel mixture for submission to the combustion chamber 507. The fuel activation device 510 includes a hydrodynamic system 503 and an aerodynamic system 504.

During use, a fuel pump 502 moves a liquid fuel component from a tank 501 into the hydrodynamic system 503 of the fuel activation device 510. The hydrodynamic system 503 of the fuel activation device 510 increases the Reynolds's number of the stream and increases the turbulence level in the liquid fuel component. Upon exiting the hydrodynamic system 503 the fuel has a high speed of flow and a high level of turbulence. In the aerodynamic system 504 of the fuel activation device 510, a stream of the compressed air is received from the compressor 505. The compressor is connected to the rotation of a shaft 508 of the device with the internal combustion chamber 507. The aerodynamic system 504 of the fuel activation device 510 directs the compressed air through capillary openings and changes direction of the air flow approximately 180 degrees. Upon exiting the aerodynamic system 504 of the fuel activation device 510 a low pressure zone is created in which the liquid fuel stream mixes with the compressed air and forms a pseudo-boiling volume. In the pseudo-boiling volume a process of simulated boiling occurs where explosions of large bubbles of air accelerate the stream of fuel and form smaller and smaller air bubbles generating a foamed fuel that is output from the fuel activation device 510. The foamed fuel mix stream flows to atomizer 506 or any other fuel input device which injects the foamed fuel mix into the combustion chamber 507.

FIGS. 3A, 3B and 4 show a cross-sectional view of a fuel activation device 510 with a single liquid input and the flow of liquids and air within the fuel activation device 510. The fuel activation device 510 is located in a fuel pipeline 301 and includes a hydrodynamic portion 503 and an aerodynamic portion 504. The hydrodynamic portion 503 and aerodynamic portion 504 overlap in an interface region. In general, the hydrodynamic portion 503 generates turbulence in a liquid and the aerodynamic portion 504 mixes the turbulent liquid with a compressed gas to form micro-bubbles 410.

As described in more detail below, during use, a liquid fuel component is input into an input 304 of the hydrodynamic portion 503 of the fuel activation device 510. The liquid fuel component can be submitted into the fuel pipeline 301 in which the fuel activation device 510 is located. The stream of the liquid is transformed into a number of micro-streams and is dispersed into the fuel stream moving in the fuel pipeline forming a first local zone of increased turbulence and low pressure 314. A gaseous component such as compressed air is driven into a pipeline 320 under pressure and in a direction opposite of the fuel flow in pipeline 301. The gaseous component forms a second zone of local low pressure 330 that has pressure lower than the pressure in the stream of the liquid. The movement of the liquid and gas in the fuel activation device 510 forms a local pseudo-boiling condition in the second zone of low pressure 330 as the fuel moves from the fuel tank in the direction of the combustion chamber (as indicated by 410). As the fuel and air mixture flows away from the low pressure zone 330, a gradual increase of local pressure in the stream changes the mix from a pseudo-boiling condition into a homogeneous fuel stream of micro-bubbles (as indicated by arrow 411).

In general, the single liquid fuel activation device 510 is used for preparation of a fuel gas mixture for subsequent burning in a combustion chamber. The fuel activation device includes functionally connected integrated mechanical-hydrodynamic and mechanical-aerodynamic interfaces. The fuel activation device 510 can be fluidly connected to a fuel tank by a pipeline in which the fuel activation device is located. The fuel component is provided to the hydrodynamic system of the fuel activation device 510 by the pipeline 301. A second pipeline 320 provides an input for the gaseous component to the aerodynamic system 504 of the fuel activation device 510, for example, from the compressor to the aerodynamic system.

As described above, the fuel activation device 510 includes a hydrodynamic portion 503 and an aerodynamic portion 504. The hydrodynamic portion 503 and aerodynamic portion 504 are located in separate housings that are coaxial. The housings are located on cylindrical pins within each system housing, and together, both provide an integrated mechanical-hydrodynamic and mechanical-aerodynamic interface. The housing 302 of the hydrodynamic portion 503 of the fuel activation device 510 forms a cavity 304 which receives fuel from the fuel line 301. The cavity 304 is conical in shape with a decreasing diameter. More particularly, the cavity 304 has a greater diameter at an end where fuel enters the fuel activation device 510 than at locations along the path of the fuel flow subsequent to entry of the fuel.

The decreasing diameter of the cavity 304 increases the turbulence of the fuel as the fuel flows in the fuel activation device 510. The hydrodynamic portion 503 includes a cone 305 that is located inside the cavity 304. The cone 305 has a conical shape with the tip of the cone pointing toward the end of the cavity 304 where fuel enters the fuel activation device 510. In use, fuel passing through the cavity 304 passes over the cone 305. As such, the inclusion of the cone 305 in the cavity 304 further decreases the area in which the fuel can flow and increases the pressure and turbulence in the fuel as the fuel passes through the fuel activation device 510. The cone also transforms the flow of the fuel stream from having cylindrical flow to having conical flow, increasing the turbulence in the fuel.

The hydrodynamic portion 503 of the fuel activation device 510 also includes multiple channels 307 located at an end of the cavity 304 opposite of the end at which the fuel enters the fuel activation device 510. After the fuel flows through the cavity 304, the fuel enters the channels 307 (as indicated by arrow 403). The channels 307 are distributed about the base of the cone 305 (e.g., at regular intervals on a circle) and have a length at least 10 times greater than their diameter. In general, the spacing of the channels 307 is determined based on the size of the fuel activation device 510. The channels are fluidly connected at one end to the conical cavity 304 at a base of the conical reflector 305 and at the other end to a conical ring channel 308. During use, fuel from the cavity 304 is directed through the channels 307 (as indicated by arrow 403) and through the conical ring channel 308 (as indicated by arrow 404). As the fuel moves from the cavity 304 through the channels 307 and 308, the speed of the stream of fuel increases and simultaneously the turbulence of the stream increases.

The fuel activation device 510 includes a low pressure zone 314 at the intersection of the hydrodynamic component 503 and the aerodynamic component 504. The liquid from the channel ring 308 is output into the low pressure zone 314 to form a turbulent stream of liquid. The local low pressure zone 314 increases turbulence in the liquid resulting from the hydrodynamic effect created by utilizing the physical principles of Bernoulli's Theorem. The turbulent fuel in the low pressure zone 314 is directed into the aerodynamic portion 504 of the fuel activation device 510 where the fuel is mixed with a gaseous component such as air.

The aerodynamic portion 504 of the fuel activation device 510 includes a housing 303 that receives a stream of compressed gas from a pipeline 320 (as indicated by arrows 402). The pipeline 320 for inputting the compressed gas has a smaller diameter than a diameter of the fuel pipeline 301. The housing 303 of the aerodynamic portion 504 forms a cavity 321 that receives the compressed gas from the pipeline 320. The cavity 321 includes a first portion having a similar shape and diameter to the shape and diameter of pipeline 320 and a second portion having a conical shape with a decreasing cross-sectional area. The decreasing diameter of the cavity 321 increases the air pressure of the gas as the gas flows in the fuel activation device 510. A cone 319 is located inside the cavity 321 such that gas passing through the cavity 321 passes over the cone 319. The cone 319 has a conical shape with the tip of the cone 319 pointing toward the end of the cavity 321 where the gas enters from the pipeline 320. As such, the cone 319 in combination with the decreasing cross-sectional area of cavity 321 decrease the area in which the gas can flow and modify the direction of the air flow. The aerodynamic portion 504 also includes multiple openings 313 that divide the stream of the compressed gas into capillary micro-streams of compressed gas. In general, the spacing of the openings 313 and the number of openings 313 can be based on the size of the fuel activation device 510. The openings 313 are connected at one end to the cavity 321 and at the other end to an opening 312. Opening 312 is connected to a conical channel ring 317. As the gas flows from the cavity 321, through the openings 313, and into the conical channel ring 317, the stream of the compressed gas changes direction. More particularly, the gas enters the aerodynamic portion 504 in a direction opposite to the direction of the fuel flow and exits in a direction that is substantially the same as the direction of the fuel flow.

Due to the high speed of movement of the stream of compressed gas through the conical channel ring 317, when the compressed gas exits the channel ring, a local zone of low pressure 330 is formed at the point where the compressed gas exits the conical channel ring 317. The fuel mix from low pressure zone 314 is delivered into the local zone of low pressure 330 through a channel 323 such that the compressed gas mixes with the fuel. The mixture of the gas and fuel generates a pseudo-boiling volume in the low pressure zone 330 (as indicated by arrows 410). The fuel and gas mixture flows away from the low pressure zone 330 and into a ring area 316. Ring area 316 has a larger diameter than that of the low pressure zone 330. Due to the increased area, the pressure in the liquid and air mixture decreases as the pseudo-boiling volume flows away from the low pressure zone 330. In ring area 322, the pseudo-boiling volume of fuel and gas at least partially stabilizes to form a foam of micro-bubbles of fuel (as indicated by arrows 411). In general, the micro-bubbles of fuel are formed of a core of compressed gas surrounded by a shell of fuel or fuel mixed with another liquid (e.g., as described herein).

Fuel Activation Device Located Near A Combustion Chamber:

While in some of the embodiments described above, the fuel activation device has been described as being located in the fuel pipeline, the fuel activation device can be located elsewhere. For example, the fuel activation device can be separate from the fuel pipeline. In some embodiments, the fuel activation device can be located near the combustion chamber.

FIGS. 7 and 8A show an axial cross section of a fuel activation device and the flow of liquids and air in the device, respectively. The fuel activation device is housed within an enclosure 701 connected at one end to a fuel pipeline 703 and at another end to multiple channels (e.g., channels 712 and 714) for output of the activated fuel mix to a combustion chamber.

As described above, the fuel activation device includes a hydrodynamic portion 702 and an aerodynamic portion 709. A fuel pipeline 703 is connected to an input into the hydrodynamic portion 702 and provides fuel from a fuel tank to the hydrodynamic portion 702 (as indicated by arrows 801). In general, the liquid component provided by fuel pipeline 703 can be a fuel mix having an organic origin, for example gasoline. The fuel from pipeline 703 flows through the housing 707 of the device producing hydrodynamic effects. Condensation 704 may form at a location where the pipeline joins the enclosure 701. In a stream of the compressed gas, on an output from a zone of the lowered pressure there is a downturn of temperature that corresponds to known laws of physics.

At a meeting of a stream of a liquid with the raised level of turbulence and the specified stream of gas, a process of local condensation which does not render a negative influence on the process of activation takes place.

Another pipeline 705 provides an input of a second liquid component such as an inorganic fuel component, for example, water (as indicated by arrow 802). The second liquid is input by the forces of gravitation, without superfluous pressure into cavity 706 (as indicated by arrows 803). The liquid from pipeline 705 accumulates in cavity 706 and is drawn through a ring capillary channel 708 into a low pressure zone 710. In low pressure zone 710, the inorganic fuel component is hydro-dynamically mixed and made turbulent with the fuel from pipeline 703 (as indicated by arrows 804). The low pressure zone 710 is formed in a cavity in which the mixing of organic and inorganic fuel components occurs. During the mixing, the organic fuel component is dispersed, made turbulent, and creates the local zone of low pressure that is coaxial and symmetric to zone 706. In the zone of low pressure, the inorganic fuel component, due to the geometry and the form of connection of all the specified cavities, is distributed to and mixed in regular intervals with the turbulent volume of the organic fuel component. Therefore, the resulting mix maintains a level of turbulence and a level of intra-volumetric pressure. A pipeline 713 is attached to the aerodynamic portion 709 and inputs compressed air from a compressor into the aerodynamic portion 709. The air from the pipeline 713 flows through a conical reflector 709 that produces aerodynamic effects. The compressed air is output from the aerodynamic portion 709 into a ring zone 711 in which the air mixes with the liquid from zone 710 and a pseudo boiling condition is formed in the liquid-gas mix. The ring cavity 711 is symmetrical and coaxial to the previous cavities. In the cavity 711, the compressed air creates the zone of local low pressure having a pressure that is lower than the pressure in the hydrodynamic cavity 710 causing the fuel in this cavity 711 to mix with the compressed air. The mixture of air and fuel forms a pseudo-boiling volume in which the stream of fuel has the structure of a moving foam of micro-bubbles. Multiple channels 712 and 714 are connected to the cavity 711. The channels 712 and 714 are located on a circle, coaxial to the previous cavities and disposed about the pipeline 713. The channels 712 and 714 output the activated fuel mix from cross section 711 to a combustion chamber.

Hermetically Sealed System for Fuel Activation:

While in some of the embodiments described above the fuel activation device was located directly within the fuel pipeline, in some embodiments, as shown in FIG. 8C, a fuel activation device can be located in a hermetically sealed system between two portions of the fuel pipeline 730 and 748. For example, in some combustion systems a diameter of the fuel pipeline can be about 10 millimeters or less. Due to the small size of the fuel pipeline, the fuel activation device can be located in a portion 744 that has a greater diameter than the diameter of the fuel pipeline. A pair of conical transition portions 740 and 732 connects the portions of the fuel pipeline 730 and 748 having the smaller diameter with the portion 744 having a greater diameter in which the fuel activation device is located. The conical transition portions 740 and 732 can be hermetically sealed to provide a liquid and air tight seal between the portions of the fuel pipeline 730 and 748 and the portion 744 in which the fuel activation device is located. The portion 744 in which the fuel activation device is located can also include an inlet for a liquid fuel component 736, an inlet for another liquid component 734, and an inlet for a compressed air 742.

System for Direct Entry of Activated Fuel into Combustion Cylinder:

In some embodiments, a fuel activation device for generating foamed fuel can be located to allow direct entry of the activated fuel into a combustion chamber. FIG. 10 shows an exemplary cross section of a cylinder head of an internal combustion chamber with a fuel activation device built into the system allowing for direct entry of activated fuel into the cylinder. The cylinder includes a cylinder head housing 1006, a housing 1007 of the cylinder block in an internal combustion chamber, and a piston 1008. In use, the piston is actuated to cause the fuel to combust. A fuel activation device 1001 is located with an outlet from the fuel activation device being located inside the cylinder. The fuel activation device 1001 generates foamed fuel (e.g., as described herein) for combustion in the cylinder. The fuel activation device 1001 includes multiple channels 1002 that output of the activated fuel mix from the activation module to the atomizers 1003. The atomizers 1003 distribute the foamed fuel into the cylinder.

It is believed that locating the fuel activation device to allow direct entry of the foamed fuel into the cylinder can provide various advantages. For example, the location of the fuel activation device with an output into the cylinder reduces the amount of time that the activated fuel is in a micro-bubbled state prior to combustion. This lessens the likelihood of the micro-bubbles of fuel bursting prior to entry into the combustion chamber.

FIG. 11A shows an exemplary fuel activation device 1100 for direct entry of activated fuel which has been built in the head of a cylinder in an internal combustion chamber and FIG. 12A shows the flow of liquid and gas through the fuel activation device 1100 of FIG. 11A and output of the activated fuel from the fuel activation device 1101 to the combustion chamber (e.g., as shown in FIG. 10).

The fuel activation device 1100 is fluidly connected to a pipeline 1118 that provides the liquid component (e.g., an organic fuel component) to the fuel activation device 1100. As indicated by arrows 1201, the fuel is inputted from the pipeline 1118 into a chamber 1120. The chamber 1120 is formed from the shaft of the housing of the hydraulic system of the device 1102. In general, the chamber 1120 includes two portions. A first portion is generally cylindrical and has a diameter slightly smaller than the diameter of the pipeline 1118. Since the diameter is smaller than the diameter of the pipeline 1118, the speed of the fuel flow and the pressure in the fuel increases as the fuel passes from the pipeline 1118 into the chamber 1120. The second portion of the chamber is generally conical in shape and has in increasing cross-sectional area in the direction of fuel flow. More particularly, the cavity 1120 has a smaller diameter at an end where fuel enters the fuel activation device 1100 than at locations along the path of the fuel flow subsequent to entry of the fuel. In general the increasing cross-sectional area allows the fuel to allow the foam to flow without deformation.

To prevent unwanted hydraulic resistance in the fuel activation device, proportional dimensional dependence between all system geometric fluid passageways within systems of the specified device is required; after activation, the cross section area within the device is increased to prevent deformation of the fuel mix foam as it flows out of the device to the fuel pipeline.

The fuel activation device 1100 also includes a cylindrical pin 1103 which is system of an integrated interface connecting the hydrodynamic and the aerodynamic systems of the device 1100. A conical axial pin 1104 is connected to the cylindrical pin 1103 with a point of the conical axial pin 1104 pointing toward the end of the cavity 1120 where fuel enters the fuel activation device 1100 from the pipeline 1118. As indicated by arrows 1201 the stream of the organic fuel component is input into the cavity 1120 and transformed from a cylindrical flow to a conical flow increasing the turbulence in the liquid. In use, fuel passing through the cavity 1120 passes over the cone 1104. The fuel activation device 1100 also includes multiple channels 1112 located at an end of the cavity 1120 opposite to the end at which the fuel enters the fuel activation device 1100. The channels 1112 are distributed at regular intervals about the cylindrical pin 1103 for dispersal of the organic fuel component. The channels 1112 are fluidly connected at one end to the conical cavity 1120 at a base of the conical reflector 1104 and at the other end to a conical ring channel 1121 formed from an external conical surface 1111 of a reflector of the interface and an internal conical surface 1114 of the housing of the hydraulic system of the device. During use, fuel from the cavity 1120 is directed through the channels 1112 and through the conical ring channel 1121 (as indicated by arrow 1202). As the fuel moves from the cavity 1120 through the channels 1112 and 1121, the speed of the stream of fuel increases and simultaneously the turbulence of the stream increases. The fuel mixes with air in a cavity 1122. Prior to mixing with the fuel, the compressed air is input into the aerodynamic system of the fuel activation device 1100 from a pipeline 1116. The aerodynamic system of the fuel activation device 1100 is formed from a housing 1107 and a conical axial pin 1105 of the aerodynamic system of the interface. The housing forms an internal cavity 1108 connected to the pipeline 1116. The cavity has a first region in which the cross-sectional area of the chamber increases and a second region in which the cross-sectional area of the chamber decreases. The region of increasing cross section provides various advantages. The design target is to eliminate hydraulic resistance between the fuel inputs into the fuel activation device and the fuel outputs from the fuel activation device; system; therefore, the cross section area within the hydraulic system of the fuel activation device should not be more than 10% larger than the cross section area of the input fuel line; system after the zone of activation, the cross section area for the accumulation of the foamed fuel mix is more than 50-70% greater, but only within a transition area as the fuel mix flows out of the fuel activation device to the fuel pipeline. This increase in cross section area after activation prevents deformation and destruction of the structure of the activated fuel before and during injection into the combustion chamber.

In general, the shape of the cavity 1108 and the conical axial pin 1105 form a zone for dispersal of the stream of compressed air (as indicated by arrows 1206). Multiple regularly located openings 1107 are disposed in a forward end face of the housing 1106. The openings 1107 are connected at one end to the cavity 1108 and at another end to an opening 1123 in which the direction of the air's movement is altered (as indicated by arrows 1205).

After the direction of the airflow has been altered, the air flows through a conical ring channel 1124 formed from an internal conical surface of the reflector of the interface of the aerodynamic device and an outer surface of the housing of the aerodynamic system of the device 1100. Upon exiting the channel 1124, the air is mixed with the fuel. Due to low pressure, the zone 1122 in which the turbulent stream of the organic liquid component of the fuel is mixed with compressed air and thereby forms a pseudo-boiling volume which flows to an atomizer, for example, in a foamy stream of micro-bubbles (as indicated by arrow 1204). A set of channels 1115 are connected to zone 1122 for output of the fuel mix to, for example, an atomizer 1117 (as indicated by arrow 1207). The atomizer 1117 delivers the foamed fuel to the combustion chamber (as indicated by arrows 1208). The device includes two zones of the lowered pressure or under pressure which are divided only by thickness of a conical reflector. These zones have the common output. It is believed that the two zones closely located reduces length of communications and increases efficiency of the device.

Systems Having Multiple Fuel Activation Devices:

In some embodiments, a system can include multiple fuel activation devices for generating foamed fuel (e.g., micro-bubbles of fuel) for combustion in a combustion chamber.

FIG. 13 shows a block diagram of a system that includes two fuel activation devices 1312 and 1314. The fuel activation devices 1312 and 1314 mix an organic liquid fuel with air to form the fuel mix that is input to the combustion chamber 1310 as a homogeneous, highly efficient high-caloric fuel. During the flow of the fuel mix from the fuel tank 1301 to the combustion chamber, the process of activation occurs in consecutive stages of the activation. The first stage of activation is after the output of the liquid fuel component from the fuel tank in the fuel pipeline, and the second stage of activation is before input (or injection) of the fuel mix into the chamber of combustion. During the first stage of activation, a fuel pump 1302 supplies fuel from the fuel tank 1301 to a hydrodynamic system 1304 of the first activation module 1312 via a fuel pipeline 1303. A source of compressed gas 1306 such as a compressor supplies a compressed gas to the aerodynamic system 1305 of the first activation module 1312. In the first activation module 1312, the air and gas are mixed to form a foamy stream of micro-bubbles. An output from the first activation module 1312 is connected to an input of the second activation module 1314. This stream of micro-bubbles generated in the first activation module 1312 is provided as an input to the hydrodynamic system 1307 of the second activation module 1314 and compressed gas from the source of compressed gas 1306 is provided to the aerodynamic system 1308 of the device of the second activation module 1314. The compressed gas is mixed with the foamed fuel from the first activation module to generate further turbulence in the fuel and to form additional micro-bubbles. The second activation module 1314 is located before the fuel is injected into the combustion chamber 1310. The foamed fuel from the second activation module 1314 is provided to an input 1309 into the combustion chamber 1310, for example in the form of an atomizer.

FIG. 14 shows a block diagram of a system for consecutive activation of a multi-component fuel mix. The multi-component fuel mix includes diverse liquid components, one of which can be inorganic. The system includes a first fuel activation device 1420 that includes a hydrodynamic system 1407 and an aerodynamic system 1408 and a second fuel activation device 1422 that includes a hydrodynamic system 1410 and an aerodynamic system 1411. The two fuel activation devices 1420 and 1422 generate an activated fuel mix that enters the combustion chamber as a homogeneous fuel, thereby providing a highly efficient process of combustion.

The first fuel activation device 1420 receives two liquid components. The first liquid component is an organic fuel component that is received from a fuel talk 1401 through a pipeline 1405. The pipeline 1405 connects the hydrodynamic portion 1407 of the first fuel activation device to a fuel pump 1403 that supplies the fuel from the fuel tank 1401. The second liquid component is received via a pipeline 1405 from a fuel tank 1402 and can be either an organic fuel component or an inorganic component. A pipeline 1409 connects the aerodynamic portion of the fuel activation device 1420 to a source of compressed gas, for example, a compressor 1412. During use, the first fuel activation device 1420 mixes the first liquid component from fuel tank 1401 with the second liquid component from tank 1402. The liquid mixture is further mixed with air from the compressor 1412 to form a volume of micro-bubbles.

The second fuel activation device 1422 has a single input to the hydrodynamic system 1410. The input is connected to the output of the first fuel activation device 1420. During use, the second fuel activation device 1422 receives the foamed fuel from the first fuel activation device. The aerodynamic system 1411 of the second activation module 1422 is connected to the compressor 1412. The compressed gas is mixed with the foamed fuel from the first activation module to generate further turbulence in the fuel and to form additional micro-bubbles. An output of the second fuel activation device 1422 is connected to a combustion chamber 1416 by an input device 1415 configured to input the fuel mix into the combustion chamber 1416. The input device is also connected to the compressor 1412 by a pipeline 1413. The input device 1415 receives compressed gas from the compressor 1412 and inputs a stream of the compressed gas in the site of the pipeline isolated from an atmosphere for preservation of parameters of a stream of the compressed gas.

Atomizers for Use with Foamed Fuel:

As described above, various types of devices can be used to generate a foamed fuel that includes bubbles of fuel with a core of compressed gas surrounded by a shell of liquid. In general, an atomizer receives the foamed fuel and converts the foam into a fine spray of micro-bubbles. The atomizers include a nozzle that causes the foamed fuel to disperse in a fine spray into the combustion chamber.

Use of Foamed Fuel with an Internal Combustion Engine:

FIG. 17 shows a block diagram of an internal combustion engine block, for example an internal combustion engine in an automobile. In use, a fuel pump 2307 pumps fuel from a fuel tank 2306 through a fuel pipeline to a fuel activation device 2305. In the fuel activation device the fuel can optionally be mixed with another liquid from tank 2311.

The fuel is also mixed with compressed air from a compressor 2308 that is powered by a power take off shaft 2309. The fuel activation device 2305 outputs micro-bubbles of fuel having a core of compressed gas and a liquid shell. The activated fuel is provided to a distribution (hydraulic switching) mechanism 2304 that regulates the amount of fuel submitted to the engine block 2301. The activated fuel is directed through atomizers 2303 and into combustion chamber. Excess exhaust from the combustion block 2301 is released through an exhaust pipe 2310. It is believed that the inclusion of the fuel activation device 2305 and generation of foamed fuel for combustion reduces the level of exhaust expelled through the exhaust pipe 2310 because the fuel combustion percentage is higher due to the increased surface area of the micro-bubbles.

Exemplary Components for Manufacture of the Fuel Activation Device:

Various methods can be used to manufacture the fuel activation devices described herein. In some embodiments, as shown in FIG. 16, the fuel activation device can be made from three separate components including a hydrodynamic housing 1600, an interface 1602 with two cone-shaped reflectors, and an aerodynamic housing 1604. The hydrodynamic housing 1600 and the aerodynamic housing 1604 are made to fit over the interface 1602 with two cone-shaped reflectors to form the fuel activation device.

More particularly, the hydrodynamic housing 1600 includes a central orientation hole 1608 between an inside conical chamber 1606 and a conical opening 1610. Conical opening 1610 is configured to fit over a cone-shaped reflector 1616 of the hydraulic system of the interface 1602. The central orientation hole 1608 is configured to fit over a cylindrical axial pin 1614 of the interface 1602 such that, when the hydrodynamic housing 1600 and the interface 1602 are connected, a conical axial pin 1612 of the hydraulic system of the interface is located inside the conical chamber 1606 of the hydrodynamic housing.

Similarly, the aerodynamic housing 1604 includes a central orientation hole 1622 connected to a conical chamber 1624. The central orientation hole 1622 is configured to fit over a conical axial pin 1619 of a aerodynamic system of the interface 1602 such that, when the aerodynamic housing 1604 and the interface 1602 are connected, the conical axial pin 1619 of a aerodynamic system of the interface 1602 is located inside the conical chamber 1624 of the aerodynamic housing 1604.

In addition to the conical pins 1612 and 1619, the interface 1602 also includes a cone-shaped reflector 1616 of the hydraulic system of the interface and a combined cone-shaped reflector 1617 of an aerodynamic system of the interface.

In general, the hydrodynamic housing 1600, interface 1602 with two cone-shaped reflectors, and aerodynamic housing 1604 can be made of a material capable of withstanding substantial degradation in the presence of fuel and air. Exemplary materials include stainless steel, plastic, ceramics, and titanium.

Forming the fuel activation device from three separate components configured to be connected to one another can provide various advantages. For example, the individual components may be less complicated to produce. In some embodiments, the pieces can be die cast eliminating the need for expensive tooling processes.

System Management:

In some embodiments, a combustion device can be controlled by an electronic control system. The control system that controls the combustion device can also be used to control one or more aspects of a fuel activation device. Using the pre-existing electronic control system can provide various advantages such as allowing the use and control of the fuel activation device without requiring an additional control system to be added to the combustion system. As such, an engine or other combustion system can be retrofitted to include a fuel activation device without requiring an additional control system and/or an engine can be built such that a single control system controls both the combustion chamber and the fuel activation device.

For example, the electronic control system can control one or more of the following: a pressure of a fuel or other liquid delivered to the fuel activation device, a pressure of air or another gas delivered to the fuel activation device, a volume of fuel or other liquid delivered to the fuel activation device, and/or a volume of air or another gas delivered to the fuel activation device. In fuel activation devices that include the input of two liquid components, the electronic control system can additionally control the pressure of the second liquid, the volume of the second liquid, and/or a ratio of the amount of the first liquid to the second liquid.

In some embodiments, the electronic control system can adjust one or more of the input parameters of the liquid or gas components based on feedback related to characteristics of the output foamed fuel. For example, sensors can be included in the combustion device to measure one or more of the following: fuel flow, temperature in the cylinder, amount of fuel burned (e.g., based on the emissions) and/or efficiency of the combustion chamber. Based on the measured characteristics, the electronic control system can adjust one or more input parameters of the liquid (s) or gas components to the fuel activation device. For example, if the electronic control system determines that efficiency of the combustion chamber is low, the electronic control system can adjust the pressure of the air input to generate more bubbles in the fuel and/or change a ratio of the first and second liquids to achieve a more optimal balance of the liquids.

The electronic controls that manage the operation of an engine to maximize the performance of the engine can also be used to provide the electronic controls for the fuel activation device. Using the same electronic control system can provide various advantages such as allowing control of the inputs to the fuel activation device without requiring an additional control system to be added to the combustion system.

While in some embodiments, the control system that controls that combustion device can be used to control the fuel activation device, in other embodiments a separate control system can be used to control the fuel activation device.

In some embodiments, a resonant sensor can provide feedback about the foamed fuel and the inputs to the fuel activation device can be adjusted based on measurements provided by the resonant sensor.

It is believed that for a particular fuel system, there is an optimal ratio of air to fuel. The dielectric permeability of the fuel mix having the optimal value (or another reference value) of air to fuel can be measured and used as a standard for subsequent measurements. When the dielectric permeability measured by the resonant sensor differs from the dielectric permeability measured for the optimal mix, one or more of the inputs into the fuel activation device can be adjusted.

Air Filter for Use with Fuel Activation Device:

In some embodiments, an air filter can be included to filter air prior to submitting the air to a fuel activation device. As described herein, the fuel activation device mixes fuel with air to form bubbles of fuel having a core of compressed air surrounded by a liquid shell. Due to the bubbled form of the fuel that is submitted to the combustion chamber, the amount of air that is present inside the combustion chamber is greatly increased. Since the total volume of air that enters the combustion chamber is increased, in order to prevent or lessen the impact of the particles included in the air on the functionality of the combustion chamber, it may be beneficial to filter the air prior to forming the micro-bubbles. By filtering the air, the total number of particles that enter the combustion chamber can be reduced (e.g., limited to an amount similar to the amount that would be present if the fuel was not foamed).

In some embodiments, a filter can include two consecutive filtering steps for removal of dust and other particles from the air. A first filtering step can involve passing the air through a liquid such as ethanol and a second filtering step can involve passing the air through a porous mineral impregnated by mineral oil.

Example of a Fuel System of a Car:

Fuel system such as a fuel system of a car or other automobile has communication paths within the fuel system with a fuel activation device. The fuel system includes a fuel activating device that generates foamed fuel such as the fuel activating devices described herein. The fuel system includes the fuel activation device, a system to control the fuel activation device, a system for regulating and controlling the engine functionality, a communication system for communication with other mechanisms of the car and a system to react to the signals of feedback from sensor controls in the fuel system of the car.

The fuel system includes a motor of the car. The motor includes a compression chamber in which liquid fuel is burned to produce energy to power the automobile. Fuel from a fuel tank is provided to the motor for combustion. Prior to entry of the fuel into the motor, a fuel pump directs the fuel through a fuel activation device. The fuel activation device mixes the fuel with a second liquid component (e.g., an inorganic component) from an additional tank and optionally with another auxiliary organic fuel component from a second additional tank. The fuel activation device also mixes the liquid fuel components with air from a compressor that has been filtered by an air filter located prior to an input to the compressor.

The fuel system includes a control system that is configured to control various parameters for functions of the motor. The control system includes a central processor of the car. The central processor is connected to a local processor and a master processor that is synchronized with the dependent local processor. The local processor manages, controls, and adjusts an activating system of the fuel system. The master processor operates various processes of updating of operating modes of activating devices by a method of comparison with statistical models of situations. A signal amplifier aggregates signals from various sensors in the fuel system and amplifies and provides the monitoring signals to the processors via an interface. The interface includes software for identification and decoding of signals from the various sensors in the fuel system. The processors communicate with components of the fuel system to modify parameters of the system in response to the signals received from the sensors.

The control system is configured to monitor and control the level of fuel and input of fuel from the tanks. The first fuel tank is connected to multiple sensors that monitor various parameters associated with the second fuel tank. A sensor is configured to gauge a level of fuel in the first tank. This sensor is connected to a signal amplifier by a communication line. Another sensor associated with the second fuel tank is configured to gauge a density of the liquid in the tank. Another sensor associated with the fuel tank is configured to gauge a viscosity of the liquid in the tank. Sensors are connected to the signal amplifier by communication lines. Another sensor is configured to gauge a temperature of the liquid in the tank and is connected to the signal amplifier by a communication line. Another sensor monitors a pressure in a fuel pipeline after the fuel pump and is connected to the signal amplifier by a communication line.

Similar to the first fuel tank, additional fuel tanks are also connected to multiple sensors that monitor various parameters associated with the fuel tank. Sensors also gauge the density of the liquid in tanks and are connected to the signal amplifier by a communication lines. Sensors also gauge the density of the liquid in tanks and are connected to the signal amplifier by communication lines. Sensors also gauge the viscosity of the liquid in tanks and are connected to the signal amplifier by communication lines.

The fuel system with fuel activation device also includes sensors associated with the air compressor. A gauge monitors the charge of compressed air and a gauge monitors the pressure of compressed air. These gauges can be used to determine the amount and pressure of the air submitted to the fuel activation device. The gauges are connected to the signal amplifier by communication lines.

The fuel system with fuel activation device also includes sensors for monitoring the emissions from an exhaust pipe. More particularly, a gas analyzer analyzes the concentration of gases in an exhaust emitted from the motor. The concentration of gases in the exhaust can indicate how efficiently the fuel is being burned in the motor. The gas analyzer is connected to the signal amplifier by a communication line.

As described above, the fuel activation device generates a foamed fuel that includes micro-bubbles of fuel with a core of compressed gas. It can be beneficial to monitor the extent to which the fuel is being foamed. In order to monitor the effectiveness of the fuel activation device, the fuel system with fuel activation device includes a resonant sensor that monitors a dielectric permeability of the activated fuel mix. The resonant sensor is connected to the signal amplifier by a communication line.

The parameters monitored by the various sensors and gauges in the fuel system can be used to modify one or more control parameters of the fuel system with fuel activation device. The presence of a synchronous system of two processors in which the processor compares signals from gauges with a statistical model of the process allows the engine to effectively adjust its operation.

As described above, systems and methods can be used to form a shell of turbulent organic fuel surrounding the core of compressed gas. In some embodiments, the compressed gas can be air. In some additional embodiments, the compressed gas can be a gas other than air, for example, hydrogen.

In some embodiments, hydrogen under pressure can be used for combustion in the combustion chamber of an aircraft turbine or ramjet. Use of hydrogen can provide various advantages. For example, high density hydrogen slush can be used to cool wings of an aircraft and then brought up to temperature to combust, most likely as a gas. In some embodiments, hydrogen can be put at a lower temperature and used as a liquid, which is can be foamed. Either air or gaseous hydrogen that was brought to a higher temperature can be injected in the aerodynamic system into the hydrogen liquid to form the micro-bubbles. As such, a hydrogen bubble coated with hydrogen liquid can be formed.

In some embodiments, it is believed that the cleanliness of processing of internal surfaces of elements of the device on which the stream of a fuel mix moves can affect the formation of foamed fuel using the fuel activation device due to the losses of kinetic energy from the hydraulic resistance arising in case of badly processed surfaces. In some embodiments, the fuel activation device is formed using materials in which the height of micro-roughness does not exceed about 0.2 micrometers. The conical form of all transitive zones in the fuel activation device allows processing and polishing of the surface to achieve a low value of micro-roughness and accordingly low losses due to hydraulic resistance.

Exemplary Geometrical Ratios and Component Dimensions for the Fuel Mix Activation Device:

The construction materials for housings, such as for the hydraulic activation system and the aerodynamic activation system, can vary depending on the method of manufacturing. For example, for mass production an economical means for manufacturing housings is by molding metal-ceramics, using micro powder from aluminum or copper or copper alloys, for example a brass or bronze. The construction material for the interface can vary depending on the type of the engine in which the activating device is to be installed.

The interface can be made of a material with high mechanical characteristics that require manufacturing from stainless steel with special heat treatment. An economical, method of manufacturing includes metal-ceramic molding, with subsequent heat treatment. Manufacturing can be conducted from a micro powder of stainless steel with components of chromium, nickel and vanadium, or as an alternative, with titanium powder.

Geometrical Relationships and Design Features of the Housing of the Hydraulic System:

In some embodiments, the cross-section area of the entrance channel is about 25-30% greater than the total cross section area of the capillary channels. As shown in FIG. 20, the length of capillary channels 2602 can be at least about 10 times greater than the diameter of the capillary channel 2601. As shown in FIG. 18, the edge of the top of the conical surface of the mechanical interface reflector at 2403 and 2404 has a diameter of an external conical surface 2403 greater than the diameter of an internal conical surface 2404. The diameter of the focusing and fixing pin 2406 can be at least about 1.5 times less than height of cone 2405, which is the conical reflector on the input side of the hydraulic system housing. The outside diameter of the conical reflector can be about 0.7 millimeters smaller than the internal diameter of the fuel pipeline or the external sleeve of the activation device. The slots 2401 on the outer diameter of the conical reflector are used for creating additional turbulence of the fuel mix stream, and are formed radial to the axis of cylindrical pin 2402, spirally distributed at regular intervals on its diameter. In FIG. 20, conical surfaces 2603 and 2604 have a common axis and the axes of apertures 2601 are parallel to this axis and the centers of these apertures are located on a circle, concentric to this axis.

Geometrical Relationships and Design Features of the Interface Which is Integrated to and Incorporated in Both the Hydraulic and Aerodynamic Systems of the Activation Device:

In FIG. 19, the integrated interface has two conical reflectors in which the diameter of the conical cross section of the hydraulic system 2501 is larger than the diameter of the conical reflector of the aerodynamic system 2502. The diameter of the focusing pin 2503 of the aerodynamic system of the integrated interface is at least 1.5 times smaller than the length 2504 on the conical surface of the conical reflector of the aerodynamic system of the device.

Geometrical and Constructive Relationships Between the Fuel Pipeline and the Housing of Aerodynamic System:

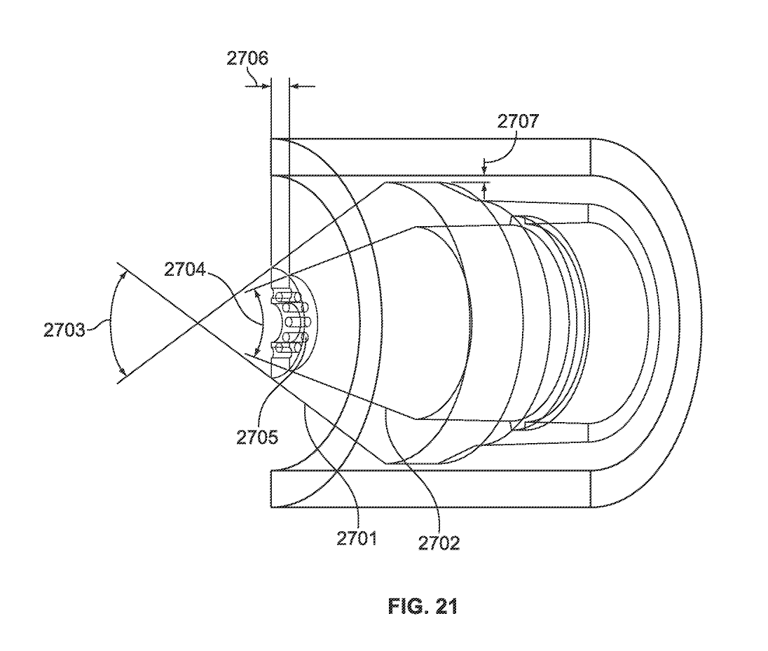

FIGS. 21, 22, and 23 show volumetric models of the housing and cross section of the fuel pipeline. The diameter of the external conical surface of the housing 2703 is greater than the diameter of the internal conical surface 2704. The distance between the external cylindrical surface of the housing 2703 and the internal diameter of the fuel pipeline 2707 is equal to half of diameter of aperture 2705. The internal and external conical surfaces 2701 and 2702 can each have a micro-roughness of no more than 0.2 micrometers.

The length of apertures 2705 and 2706 can be at least ten times the diameter these apertures. The transition between the plane and the conical surface of the end face of housing 2803 can be polished up to form a surface with an average value of micro-roughness of 0.2 micrometers. The concentric ring distance 2804 between the cylindrical surface of the housing and the internal diameter of the fuel pipeline can be at least 10 times the diameter and at least 5 times the length of distance 2805. When making groove 2802 in the housing, when the housing is machined and not molded, flute 2801 is for output of the tool. Transitions between the conical and cylindrical surfaces of the housing, at 2903, 2904, 2907, 2906, 2905, can be polished with a height of micro-roughness of no more than 0.2 micrometers. Apertures 2902 from the bottom 2901 are manufactured with 45 degree polished facets, and have a diameter with a micro-roughness of no more than 0.2 micrometers.

Geometrical and Constructive Relationships Between Conical Surfaces of Reflectors and Housings:

The distance between the internal conical surfaces of reflectors and external conical surfaces of housings in the aerodynamic system is determined as follows: the distance equals (0.1 millimeters) plus (the diameter of a capillary aperture in the housing divided by the number of apertures). The distance between the external conical surfaces of reflectors and internal conical surfaces of housings in the hydraulic system is determined as follows: the distance equals the resultant of (0.1 millimeters) plus (the diameter of a capillary aperture in the housing divided by the number of apertures), or 0.02 millimeters, whichever is the lesser.

Component Dimensions for Exemplary Fuel Activation Device:

Referring to FIG. 24, a device for activation of the fuel mix consisting of one liquid component, such as gasoline, ethanol or diesel fuel is shown. For this example, the diameter of the fuel pipeline is selected to equal 10 millimeters. However, the general ratios, principles, and sizes can be applied to fuel pipelines having other diameters.

The fuel pipeline 3601 in the form of a pipe has an internal diameter of 9.6 millimeters and a thickness of a wall of a pipe of 0.65 millimeters. A nipple 3602 with a special flange tightly fastens to a pipe of the fuel pipeline, for example by means of soldering. A pipe 3603 of the fuel pipeline is located after the activating device and leads to the chamber of combustion. A nipple 3604 is tightly fixed on the pipe 3603. A housing 3605 of hydraulic system of the device of activation of a fuel mix and a housing 3606 of aerodynamic system of the device of activation of a fuel mix are sized to house the hydraulic and aerodynamic systems respectively. A conical reflector 3607 enters into the hydraulic system of the device of activation of a fuel mix, structurally connecting hydraulic and aerodynamic systems of the device for activation of a fuel mix. A nut 3608 holds and seals the device for activation of a fuel mix with the fuel pipeline after process of activation. A nut 3609 holds and seals the device for activation of a fuel mix with the fuel pipeline before process of activation.

The assembly housing 3610 of the device for activation of a fuel mix is affixed to the internal components of the device. A collector 3611 is configured for bringing compressed air and removing an activated fuel mix which has the function of a remote element which clamps in an axial direction and is sealed to a target system of the device for activation of a fuel mix. A conical surface 3612 hermetically seals an internal volume of the device for activation of a fuel mix from an input in the device. A ring channel 3613 in the housing of the hydraulic system of the device for activation of a fuel mix is used to input additional fuel mix components when they are available. Channels 3614 connecting the ring channel 3613 are located at regular intervals on a circle of external diameter of the housing of hydraulic system of the device for activation of a fuel mix and create the local zone in which the area of the lowered pressure is created. A conical ring 3615 forms a distance between a conical aperture in the housing of hydraulic system of the device for activation of a fuel mix and an external conical surface of a reflector of the mechanical interface. The size of this distance is from about 0.2 up to about 0.5 millimeters and varies depending on the viscosity and density of liquid components of a fuel mix. A conical reflector 3616 forms an entry into the aerodynamic system of the device for activation of a fuel mix. A conical cavity 3617 accumulates compressed air in the housing of aerodynamic system of the device for activation of a fuel mix. An open system 3618 of a conical surface of the target channel of the housing of the hydraulic system of the device for activation of a fuel mix increases turbulence of the stream and creates an area of the lowered pressure where a stream mixes with a stream of compressed air to form foam from a fuel mix. A set of channels 3619 mixes the activated fuel mix in the fuel pipeline. A set of radial apertures 3620 connects channels 3619 with a target heat-sink cone of the device for activation of a fuel mix. A cone 3621 is located just after fuel enters the input of the fuel activation device from the fuel pipeline. [To prevent hydraulic shock, in a distance of 10 millimeters from the fuel input into the fuel activation device, the diameter of the cone 3621 increases to 20 mm. Conical system 3622 has a surface with grooves or channels 3623 allocated at regular intervals on its diameter. The channels increase of a level of turbulence of streams of a fuel mix. A length of the channels can be about 15 millimeters, a width of the channel can be about 2 millimeters, a depth of the channel can be about 2.5 millimeters, and the cross section area of one channel can be about 5 square millimeters. In total there are the 12 cross sectional channels for hydraulic flow for a total of about 60 square millimeters. A ring cavity 3624 forms the basis of a reflector in which the compressed air is accumulated before dispersal. Grooves 3625 are distributed at regular intervals and form channels for submission and dispersal of compressed air. The cross section of the channels can be about one millimeter and a length of channels can be about 18 millimeters. A conical bell 3626 of an integrated reflector which on an external conical surface connects to the hydraulic system of the activating device and on an internal conical surface connects to the aerodynamic system. A ring channel 3627 is located in the aerodynamic system of the device for activation. The distance between the conical surfaces forming the channel can be from about 0.15 up to about 0.2 millimeters. An open conical surface 3628 of the housing of aerodynamic system of the device of activation of a fuel mix provides a surface on which the stream of compressed air is dispersed and incorporated with a stream of a turbulent fuel component or a mix to form a pseudo boiling layer in a stream of a fuel mix and in a course of movement of a stream passing in foam. A radial channel 3629 provides a path for submission of compressed air in aerodynamic system of the activating device and connecting input 3630 connects the channel with a pipeline 3631.

A pipeline 3631 of an aerodynamic passageway connects an aerodynamic system of the device of activation with the compressor. A conical surface 3632 forms a hermetic seal between an internal cavity of the device of activation and an output of the activated fuel mix. A transitive conical cavity 3633 connects the device of activation of a fuel mix with the fuel pipeline.

The housing 3610 can be made of aluminum with the subsequent hard anodizing internal surfaces and with a chemical covering of nickel at external surfaces. The mechanical interface can be made of stainless steel with the concentration of chromium of not less than 13%, and a last heat treatment up to a level −45 units on a Rockwell scale. The nipples 3602 and 3604 can be made of construction steel with decorative black oxidation. The nuts 3609 and 3608 can be made of a brass with finishing on all surfaces. Other components are made of an aluminum alloy with anodizing.

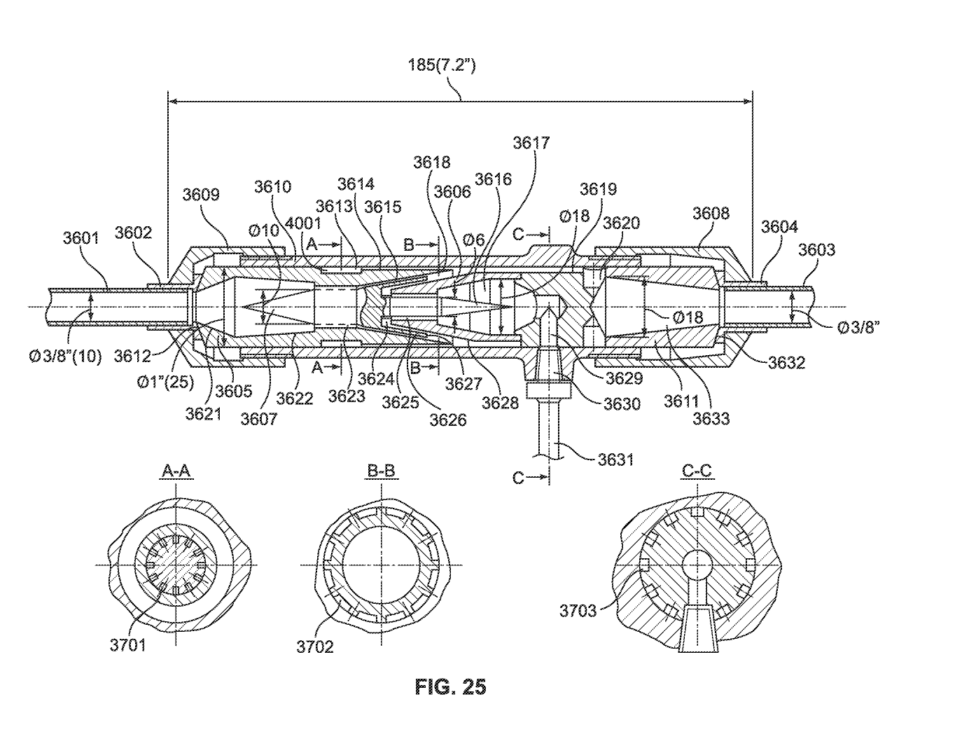

Referring to FIG. 25, a device for activation of a fuel mix in which there is only one liquid organic component is shown. FIG. 25 shows exemplary basic dimensional characteristics of the device where the size of various components is shown in millimeters and/or in inches. The device is represented generally in scale of one to one. FIG. 25 shows three different systems to which the transitive channels connect to various destinations and a principle of action of the system of the device for activation of a fuel mix.

As shown in FIG. 25, channels 3701 are openings that connect the conical system in the entrance of the hydraulic system with the first stage of activation for increasing a level of turbulence in streams of a fuel mix are shown. In this embodiment, the device includes 12 channels each having a cross-sectional area of 4.9 square millimeters and a length of 15 millimeters. As such, the total area of all channels is 58.8 square millimeters. In contrast, the cross sectional area of the fuel pipeline which has a diameter of 9.6 millimeters is 72.3 square millimeters. The ratio between the areas is 81%. While the ratio is shown in this example as being 81%, the width of the channels can be increased such that the ratio is up to 90%.

As shown in FIG. 25, channels 3702 connecting a zone of local pressure decline with entrance pipelines for submitting additional fuel components (e.g., inorganic fuel components) to the fuel activation device, including of inorganic origin, are shown. In this embodiment, the device includes 12 channels each having a cross-sectional area of 0.5 square millimeters and a total area of 6 square millimeters. In some embodiments, it may be desirable to reduce the cross sectional area of channels. In such embodiments, the channel may be coated with materials.

As shown in FIG. 25, channels 3703 connect the mix with the cross section in which the fuel mix foam is formed.] The area of each of channels can be 11 square millimeters and the total area of all channels is 132 square millimeters. The total area of the channels 3703 is about 1.8 times more than the area of the entrance channel. A gradual transition of the mix through a conical shaped cavity allows transition of the mix without having significant hydraulic resistance and thereby lessens the potential destructive impact on the structure of the fuel mix foam.

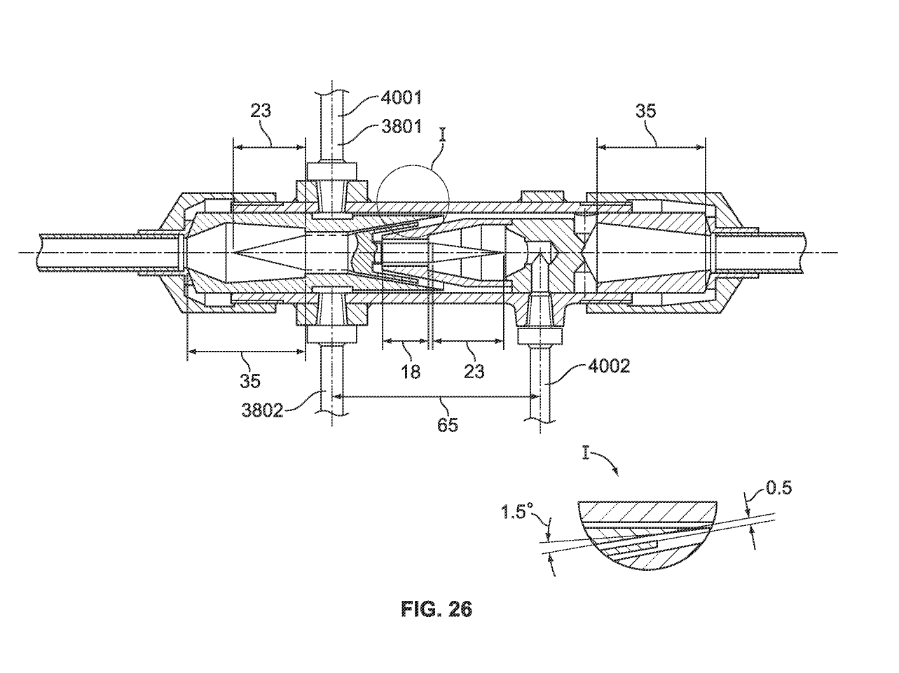

As shown in FIG. 26, the axial system of the device for activation of a fuel mix provides inputs for three fuel components of which one or more of the components can be inorganic. For example, a pipeline 3801 can be used for submission of a secondary fuel component and a fuel pipeline 3802 can be used for submission of an inorganic fuel component. Providing three inputs allows the input of additional fuel components without changes to the device. If two components are mixed in each pipeline, then up to 6 components can be used. The updating or modification of the inputs does not require change of a design of the device allowing experimental works and in the further modernization of the device. The exemplary lengths and sizes shown in FIG. 26 are in millimeters.

FIG. 26 shows a zone in which a local pressure decline is formed. This zone connects to the hydraulic system of the device for activation of a fuel mix. In the specified place on a conical surface there is a convex site. The size of the chamber in relation to the basic conical surface makes 1.5 degrees. Thus, a thickness of the ring conical channel within the limits of hydraulic system of the device of activation is 0.5 millimeters. This constructive difference compensates loss of kinetic energy of a stream at removal from a zone of the maximum local under pressure.

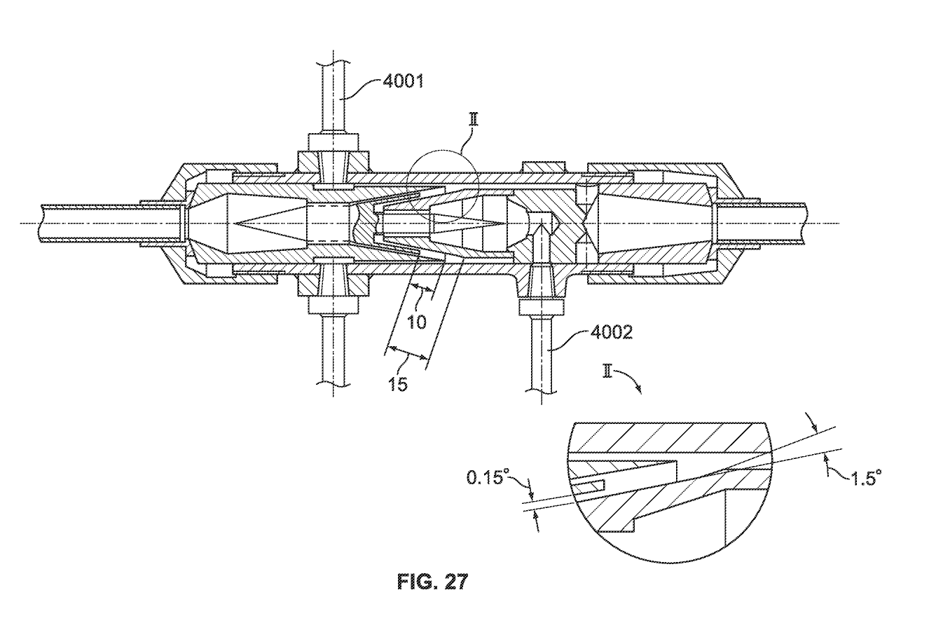

FIG. 27 shows a zone in which a local pressure decline is formed. This zone concerns the aerodynamic system of the device for activation. In the specified place on a conical surface of the housing of the aerodynamic system there is the convex site located at the basic conical surface under a corner of 1.5 degrees. The size of a distance between conical surfaces of the housing and a reflector in the aerodynamic system of the device of activation is 0.15 millimeters. The sizes specified in FIG. 27 are in millimeters.

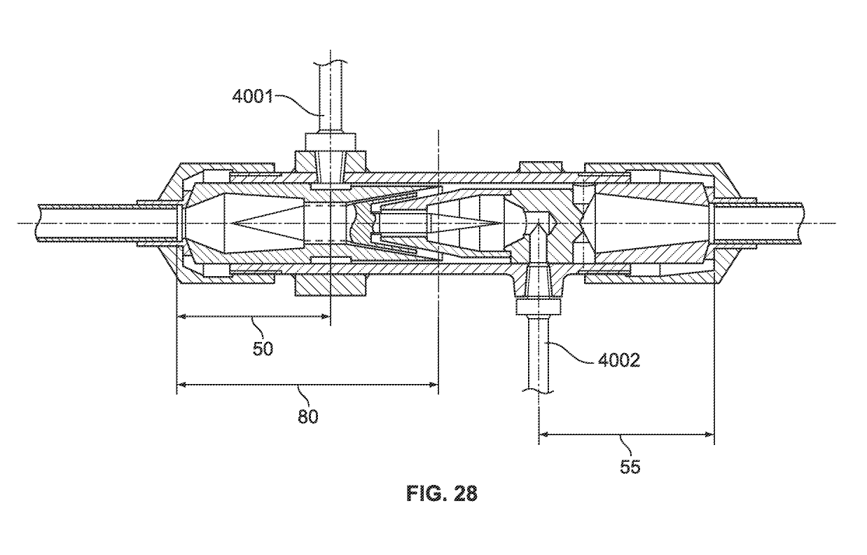

FIG. 28 shows an axial system of the device for activation of a fuel mix for a mix including one organic component with no additional liquid component (e.g., an inorganic or an organic component) and compressed air. An input 4001 allows input of an additional liquid fuel component and an input 4002 allows input of compressed air. The exemplary lengths and sizes shown in FIG. 28 are in millimeters.

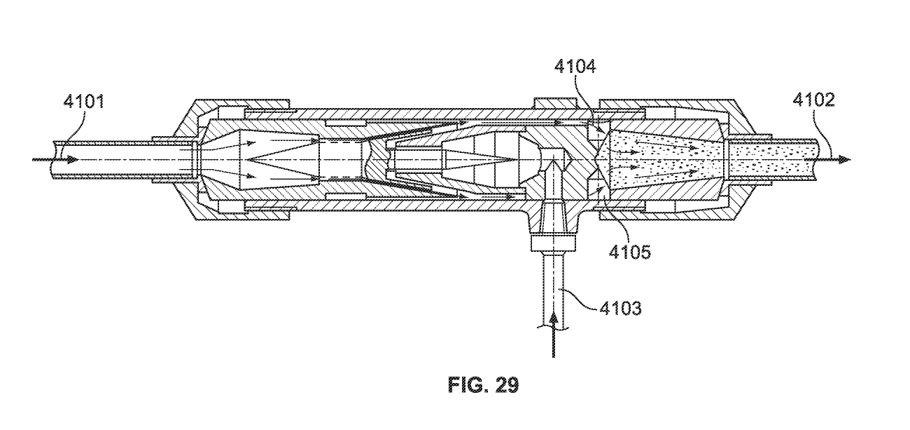

FIG. 29 shows a scheme of movement of fuel components in the device for activation of a fuel mix. Fuel is inserted from the fuel pipeline 4101, activated by a fuel activation device, and output into the fuel pipeline 4002. An input pipeline 4103 allows submission of compressed air in the device of activation. Radial channels 4104 and 4105 carry the fuel from the activation device to the fuel pipeline 4102.

FIGS. 30A, 30B, and 31 depict:

4201, —the housing of this embodiment of the device for activation and mixing of a gaseous fuel component with a gaseous oxidant component; the minimum pressure of the compressed oxidant component in this embodiment is 1.2 atmospheres greater than the pressure of the gaseous fuel component which is at a pressure of more than 4 bar;

4202, —a nut which also has a nut with a nozzle opening at 4220;

4203, —the positioning nut for the vortex chamber

4204, —a spherical reflector;

4205, —the aerodynamic distributor of the gaseous fuel component a stream which increases the level of turbulence of a stream;

4206, —the conical aerodynamic reflector intended for compression of incoming flow of the gaseous fuel component stream into a ring and the reduction in cross section also increasing turbulence;

4207, —the housing of the vortex chamber;

4208, —the internal ring cavity of the of the vortex chamber housing, connected to the ring chamber in which is a whirlwind is formed by means of some apertures whose axes are parallel to the axis of the conical aerodynamic reflector 4206;

4209, —a flange in which channels are executed to direct the flow of compressed gaseous oxidant to the vortex chamber;

4210, —the pipeline for submission of compressed gaseous oxidant;

4211, —apertures located in regular intervals for submission and dispersal of streams of gaseous oxidant acting from the vortex chamber to the spherical reflector;

4212, —an atomizer;

4213, —a threaded pin of the housing 4201;

4214, —connecting coupling;

4215, —channels for formation of a compressed gaseous oxidant whirlwind;

4216, —the apertures connecting the ring cavity 4208 with the vortex cavity;

4217, —an external wall of the channel for formation of a compressed gaseous oxidant whirlwind;

4218, —an internal wall of the channel for formation of a compressed gaseous oxidant whirlwind

4219, —a cylindrical surface of the vortex chamber; and

4220, —a threaded pin for fastening an atomizer 4212.

FIG. 32 depicts:

4301, —a cylindrical wall of the vortex chamber;

4302, —the vortex chamber;

4303, —a transfer aperture that moves the compressed gaseous oxidant flow to the tangential channels 4215;

4304, —an internal wall of the channel for formation of a compressed gaseous oxidant whirlwind;

4305, —an external wall of the channel for formation of a compressed gaseous oxidant whirlwind;

4306, —an angle between points of crossing between an internal wall of the channel for formation of a compressed gaseous oxidant whirlwind and a cylindrical wall of the vortex chamber, and an external wall of the channel for formation of the compressed gaseous oxidant whirlwind and a cylindrical wall of the vortex chamber; and

4307, —an angle between internal and external walls of the channel for formation of a compressed whirlwind.

In some aspects, a control system can control one or more of the following aspects of the formation and use of foamed fuel: fuel pressure in a fuel pipe before an activation device, fuel flow in the fuel pipe before activating device, air pressure before the activation device, air flow in the pipe before the activation device, and/or parameters of the bubbles controllable with a sensor. Precision measurements of the dielectric permeability of the activated fuel mix stream in the pipeline after output from the activating device allows the determination of one or more of the following parameters: the concentration of air in a given volume of fuel mix; estimated pressure inside the air bubbles; whether in a given volume of fuel mix there is a homogeneous air bubbles structure; a fuel mix flow rate; the linear velocity of the fuel mix; and the turbulence of the fuel mix flow; In some aspects, the distribution of the bubble can be estimated by assuming (in the first approximation) that it is Gaussian (normal). Thus it will be characterized by the average size of the bubble d and RMS deviation σ. The relations between those two parameters and characteristic scale of the engine (size of the chamber) will define “bubble-ness” of the foam. It is believed that for the particular fuel an optimal size of the bubble will exist. The reason is believed to be: in the limit of very small bubbles there is asymptotically a pure liquid, while a very large bubble is just air without a liquid. The size of the bubble depends on surface tension (measured in kg/seĉ2), viscosity (measured in m̂2/sec), density (measured in kg/m̂3) and a square of velocity (measured in m̂2/seĉ2). The reason for the last dependency is that the Bernoulli Effect links a pressure with square of velocity and not with velocity itself. A dimensional analysis) shows that the simplest dependence is:

L=constant*(surface tension/density*velocitŷ2). For example, in a simplest case the size of a bubble does not depend on viscosity. The formula is physically correct since it shows that high surface tension will lead to the large bubbles and high velocity will lead to the small bubble. The constant can be defined experimentally. Based on the formula, it is believed that for small bubbles it may be crucial to have very high velocity.

Advantages of Technology of Complex Activation of the Fuel Mix:

The technology of complex activation of a fuel mix provides additional benefits: by increasing the pressure of compressed air from an output of the compressor, the compressed air in the active chambers of the device for complex activation of a fuel mix is further compressed. This provides an opportunity for active, effective mixing on all volumes of various components of a fuel mix before its injection in the chamber of combustion. For example, proportional mixing of gasoline and ethanol can be controlled in the device in a time sufficient for mixing the subsequent saturation of this mix by oxygen, prior to injection in the chamber of combustion.

The solubility of air in gasoline in a closed volume is a function of the pressure of the compressed air. For example, under some external conditions, the pressure in a stream of air within the limits from one atmosphere up to 3 atmospheres, with the temperature of the air and gasoline up to 20 degrees Celsius, the volumetric dissolution of oxygen in gasoline can not exceed 0.22%. As the pressure increases up to 10 atmospheres, under the same external conditions, the volumetric dissolution of oxygen in gasoline increases to 1.89%.

Mixing gasoline with ethanol allows the fuel mix to have a lower overall cost and new operational characteristics that improve the basic parameters of the process of burning and transformation of energy in an internal combustion engine. The described fuel activation device permits these mixtures to be made dynamically on board a vehicle, in the proportions desired by the engine management system, variable as conditions change, rather than as mix delivered from a storage tank at a re-fueling station, where the mixture is fixed in its component proportionality and may “de-mix” or age over time.

Use of Bursting Micro-Bubbles of Fuel in HCCI Engines:

In some embodiments, micro-bubbles of fuel that are pressurized to burst in a combustion chamber can be used in conjunction with a Homogeneous Charge Compression Ignition (HCCI) engine. An HCCI engine is type of internal combustion engine in which fuel mixed with an oxidizer such as air is compressed to a point of auto-ignition. The auto-ignition of the fuel produces an exothermic reaction that releases chemical energy in a form that can be translated by an engine into mechanical energy.

Advantages of HCCI engines are that they produce low discharges of nitrogen oxides and soot particles while at the same time is highly efficient. However, in order to work effectively HCCI engines may need careful control of the fuel mixture.

In many HCCI engines, the engine includes a combustion chamber bounded downwards in a cylinder by a movable piston. The movements of the piston in the cylinder are converted to rotary movement of a crankshaft that is connected to the piston by a connecting rod. In non-foamed fuel HCCI engines, when the piston moves downward in the cylinder, an inlet valve is open to draw air into the combustion chamber. At the same time, a fuel pump injects fuel into the combustion chamber. The subsequent upward movement of the piston causes compression of the fuel mixture in the combustion chamber such that the fuel mixture undergoes a temperature increase which is related to the degree of compression and the fuel mixture reaches a temperature at which self-ignition of the fuel mixture takes place. During the combustion process, expansion occurs in the combustion chamber and the piston is pushed downward.

While in many existing HCCI engines, air and fuel are separately inserted into the HCCI combustion chamber (e.g., via separate input lines), the use of a fuel activation device that generates foamed fuel (e.g., as described above) allows a single input to provide both the fuel and air in the appropriate ratios. It is believed that using a fuel activation device to allow direct entry of the foamed fuel that includes both the fuel and air into the cylinder can provide various advantages. For example, it is believed that for a particular fuel system (e.g., for a particular HCCI engine), there is an optimal ratio of air to fuel. Using a fuel activation device to foam fuel prior to submitting the fuel to the combustion chamber allows greater control of the ratio of air to fuel inside the combustion chamber. As such, by controlling parameters of the fuel activation device 1001, a fuel and air mixture having the desired properties can be submitted to the combustion chamber. Since the fuel and air are mixed prior to submission to the combustion chamber properties of the fuel mix can be measured and used to adjust the generation of bubbles of fuel. For example, the dielectric permeability of the fuel mix of air and fuel can be measured by a resonant sensor and used to adjust one or more of the inputs into the fuel activation device (e.g., as described in U.S. Provisional Application Nos. 60/970,655, 60/974,909, and 60/978,932, the contents of which are hereby incorporated by reference).

In order to generate the appropriate ratio of fuel and air, an electronic control system can control one or more of the following: a pressure of a fuel or other liquid delivered to the fuel activation device, a pressure of air or another gas delivered to the fuel activation device, a volume of fuel or other liquid delivered to the fuel activation device, and/or a volume of air or another gas delivered to the fuel activation device. In fuel activation devices that include the input of two liquid components, the electronic control system can additionally control the pressure of the second liquid, the volume of the second liquid, and/or a ratio of the amount of the first liquid to the second liquid. The electronic control system can adjust one or more of the input parameters of the liquid or gas components based on feedback related to characteristics of the output foamed fuel. For example, sensors can be included in the combustion device to measure one or more of the fuel flow, temperature in the cylinder, amount of fuel burned (e.g., based on the emissions) and/or efficiency of the combustion chamber. Based on the measured characteristics, the electronic control system can adjust one or more of the input parameters of the liquid(s) or gas components to the fuel activation device.

For example, if the electronic control system determines that efficiency of the combustion chamber is low, the electronic control system can adjust the pressure of the air input to generate more bubbles in the fuel and/or change a ratio of the first and second liquids to achieve a more optimal balance of the liquids.

Gaseous Components Of Fuel Mixing

In FIG. 33, the cross-section of another embodiment of a linear vortex activation and mixing device of the gaseous fuel component with compressed gaseous oxidant is presented. As shown a number of consecutive vortex generators are connected to the compressor; all vortex generators and the pipeline of submission of the gaseous fuel component are coaxial to the vortex channels of each of the vortex generators. The channel for submission of the gaseous fuel component is continuous through all of the vortex generators. The minimum pressure of the compressed gaseous oxidant in this embodiment is 1.2 atmospheres greater than the pressure of the gaseous fuel component.

FIG. 33 includes the following features:

4401, —a housing of the device for vortex activation and mixing of a gaseous fuel component and compressed gaseous oxidant component;

4402, —a pipeline for submission of a gaseous fuel component, which is coaxial to a vortex channel of each vortex generator

4403, —a nozzle which acts as an atomizer for submission of a mix of gases to the combustion chamber;

4404, —a nut for fixing all vortex generators in the housing 4401;

4405, —a first vortex generator as the gaseous fuel component moves; this generator is intended for formation of a primary vortex channel in a stream of the gaseous fuel component and creation of forward motion for a stream of gas whose vector coincides with a direction of movement of the gas to the combustion chamber;

4406, —a second vortex generator, completely identical to the first;

4407, —a third vortex generator;

4408, —a fourth vortex generator;

4409, —the remote washer forming vortex channels of the fourth vortex generator;

4410, —hermetic compression washers

4411, —an atomizer;

4412, —a vortex channel of the first vortex generator;

4413, —a pipeline for submission of compressed gaseous oxidant in the first vortex generator;

4414, —a pipeline for submission of compressed gaseous oxidant in the third vortex generator;

4415, —a pipeline for submission of compressed gaseous oxidant in the second vortex generator; and

4416, —a pipeline for submission of compressed gaseous oxidant in the fourth vortex generator.

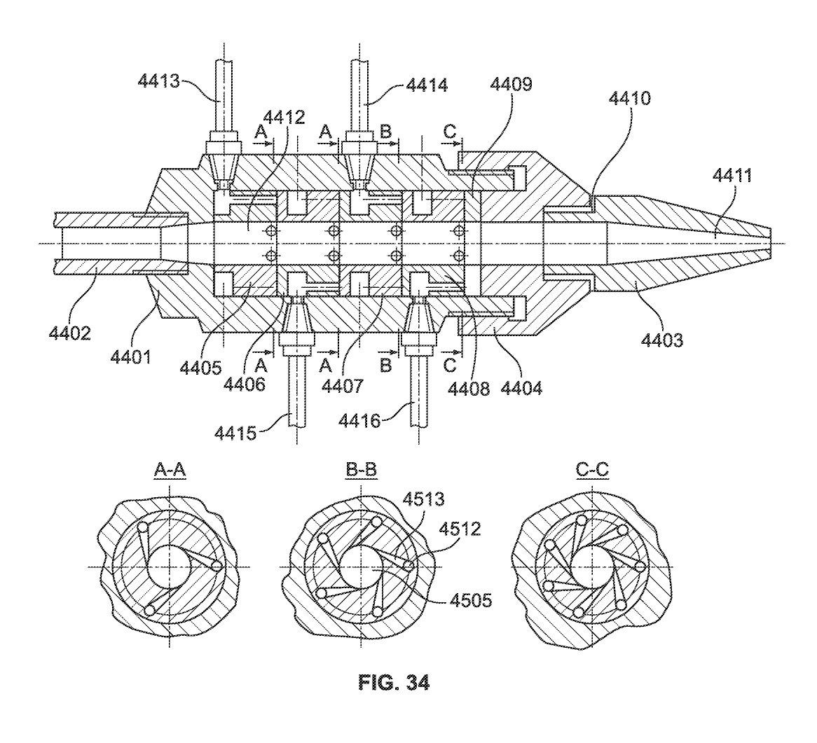

In FIG. 34 systems of vortex tangential channels in each of the vortex generators are shown. FIG. 34 includes the following features:

4501, —a channel for submission of the gaseous fuel component;

4502, —a connection between the channel for submission of the gaseous fuel component and the vortex channel of the first vortex generator;

4503, —a vortex channel of the first vortex generator;

4504, —a vortex channel of the second vortex generator;

4505, —a vortex channel of the third vortex generator;

4506, —a vortex channel of the fourth vortex generator;

4507, —a channel for submission of a gas mix in the combustion chamber;

4508, —a channel connecting a target channel of an atomizer with a system of the vortex channels of the vortex generators;

4509, —a channel of an atomizer forming a conically shaped pipeline to deliver fuel flow to the combustion chamber;

4510, —a ring collector for submission of compressed gaseous oxidant in the second vortex generator;

4511, —a ring collector for submission of compressed gaseous oxidant in the first vortex generator;

4512, —apertures for submission of compressed gaseous oxidant in tangential channels of vortex generators;

4513, —tangential channels of the vortex generators;

4514, —a ring collector for submission of compressed gaseous oxidant in the fourth vortex generator; and

4515, —a ring collector for submission of compressed gaseous oxidant in the third vortex generator.

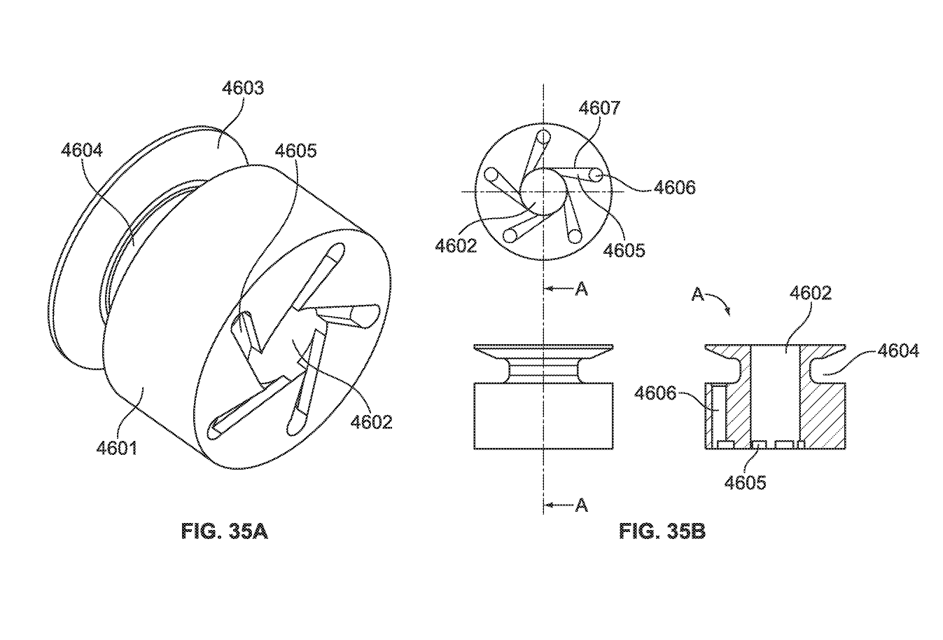

FIGS. 35A and 35 B depict isometric views of systems of the vortex generator. FIGS. 35A and 35B include the following features:

4601, —a cylindrical housing of the vortex generator;

4602, —a vortex channel;

4603, —a flange of a housing of the vortex generator;

4604, —a ring collector of the housing of the vortex generator;

4605, —tangential channels of the vortex generator;

4606, —apertures for submission of compressed gaseous oxidant in tangential channels of the vortex generator; and

4607, —walls of the tangential channels, tangent to the cylindrical surface of the vortex channel of the vortex generator.

Cooling the Gaseous Components of the Mix and Producing Potable Water

The ring vortex generator which is used in vortex devices for mixing and activation of gases; The vortex generator possesses properties for causing a cooling effect as there is adiabatic expansions of the compressed air leaving tangential channels of the specified generator.

Air under pressure from the compressor moves in the collecting ring channel of the housing of the vortex generator and then through transit channels, and then acts in the tangential channels to form the vortex channel or a vortex pipe.

In the case of output from the tangential channels, adiabatic expansion of air occurs and according to the Joule-Thompson Effect, as the temperature of the air decreases proportionally to a difference in the expansion pressure.

During the output of air from the tangential channels there also is a process of formation of the vortex channel in the form of a vortex pipe that creates conditions for occurrence of what is known as the Ranque Effect, which produces decreases in temperature in addition to the adiabatic effects.

The cumulative decrease in temperature also cools the housing of the vortex generator:

Upon compression in the compressor, the temperature of air increases and, at its input into the collection ring channel of the vortex generator housing, whose temperature is essentially below the temperature of air, primary condensation of water occurs and the temperature of air thus decreases.

On output from tangential channels at adiabatic expansion there is a second stage of downturn of temperature which is defined by a difference in pressure before and after adiabatic expansions. The change in pressure causes a change in temperature, providing it at a level of a dew-point or below a dew-point. Thus, if the temperature in the air stream is below zero, water in air freezes and turns to crystals of ice.

Cooling Combustion Exhaust Gas Streams to Produce Water and Using the Resultant Mix for Further Mixing as an Additional Fuel Component

The method of extraction of water from exhaust gases of the engine with the purpose of its use in the device for activation of a fuel mix as an additional component for mixing with an organic making fuel can be realized by means of the vortex generators applied to mixing and activation of gases.

The ring vortex generator which is applied in the vortex devices for mixing and activation of gases possesses the additional properties allowing to double a cooling effect from throttling of pressure or adiabatic expansions of the compressed air leaving the tangential channels of the specified generator.

Air under pressure from the compressor moves in the collecting ring channel of the housing of the vortex generator and then through transit channels, and then acts in the tangential channels to form the vortex channel or a vortex pipe.

In the case of output from the tangential channels, adiabatic expansion of air occurs and according to the Joule-Thompson Effect, the temperature of air decreases proportionally to a difference in the expansion pressure.

During the output of air from the tangential channels there also is a process of formation of the vortex channel in the form of a vortex pipe that creates conditions for occurrence of what is known as the Ranque Effect, which produces decreases in temperature in addition to the adiabatic effects.

The cumulative decrease in temperature also cools the housing of the vortex generator.

Upon compression in the compressor, the temperature of air increases and, at its input into the collection ring channel of the vortex generator housing, whose temperature is essentially below the temperature of air, primary condensation of water occurs and the temperature of air thus decreases.

On output from the tangential channels at adiabatic expansion there is a second stage of downturn of temperature which is defined by a difference in pressure before and after adiabatic expansions. The change in pressure causes a change in temperature, providing it at a level of a dew-point or below a dew-point. Thus, if the temperature in the air stream is below zero, water in air freezes and turns to crystals of ice.

Exhaust gases act in the central channel of the vortex generator housing in which the developed contact surface is created. Hot exhaust gas is in contact with the cold surface of the vortex generator housing and water which is a system of exhaust gas is condensed on the cooled contact surface. The water and soot mixture is then available to be collected and used as an additional liquid mix component in the fuel activation device.

Other embodiments are within the scope of the following claims.

1. A fluid mixture, comprising:
a plurality of fluid-based spheres in contact with each other, each sphere having:
a core of compressed gas; and
a shell made of liquid surrounding the core of compressed gas comprising a liquid with a thickness forming a volumetric structure made of foam bubbles.

2. The fluid mixture of claim 1, wherein the fluid is a composite made of a fuel as the liquid and air as gas.

3. The fluid mixture of claim 1, wherein at least about 50% of the fuel spheres have a volume ratio calculated to be a radius of the core over the thickness of the shell of between at least about 0.8 and about 2.5.

4. The fluid mixture of claim 3, wherein the shell comprises a first organic fuel.

5. The fluid mixture of claim 4, wherein the shell further comprises a second fuel.

6. The fluid mixture of claim 5, wherein the at least one of the first or second organic fuels is selected from the group consisting of gasoline, ethanol, diesel fuel, and glycerin.

7. The fluid mixture of claim 4, wherein the shell further comprises an inorganic fuel.

8. The fluid mixture of claim 7, wherein the organic fuel is gasoline and the inorganic fuel is water.

9. A fuel mixture for use with an internal combustion chamber, comprising a plurality of fuel spheres in contact with each other, each fuel sphere having a core of compressed gas; and a shell surrounding the core comprising a fuel with a thickness forming a volumetric structure made of foam bubbles.

10. The fuel mixture of claim 9, wherein at least about 50% of the fuel spheres have a volume ratio calculated to be a radius of the core over the thickness of the shell of between at least about 0.8 and about 2.5.

11.-91. (canceled)

92. A device for mixing streams of gas, comprising:
a channel for axial submission of a stream of a gaseous fuel component into a variable cross-sectional area that changes as fuel flows, then flowing into a cylindrical channel of the variable cross section, then to a spherical channel;
a two-level vortex chamber connected by system of channels whose axes are parallel to an axis of the gaseous fuel component channel and which are distributed at regular intervals concentric to the axis of the gaseous fuel component channel, then passing on a course of movement into the top of the spherical system where the gaseous oxidant component is directed to be co-terminous with the direction of movement of the stream of the gaseous fuel component;
an integrated reflector component, whose axis coincides with an axis of the channel for axial submission of the stream of the gaseous fuel component, that combines the conical reflector for the compression of the input gaseous fuel with the cylindrical connection between the conical reflector compressing the input gaseous fuel component and the spherical reflector for mixing the gaseous fuel component and the gaseous oxidant, with the integrated reflector component having conical reflectors on its outside edges around its entire circumference;

93. The device according to claim 92, wherein a vortex system contains the vortex generator including the vortex cylinder in which on the cylindrical surface there are round aperture outputs from the vortex stream channels and on which the vortex forming channel cylinder walls are located.

94. The device according to claim 92, wherein a vortex generator contains at least three channels for forming the vortex stream, located in the same plane of the cross-section of the vortex cylinder.

95. The device according to claim 92, wherein the channels forming the vortex stream are located at least in the same cross-section of a vortex cylinder.

96. The device according to claim 92, wherein a vortex generator contains apertures for forming vortex stream channels, and the length of the channels comprising these apertures is identical.

97.-105. (canceled)

106. The fuel mix of claim 9, wherein the shell comprises a first organic fuel.

107. The fuel mix of claim 9, wherein the shell further comprises a second organic fuel.

108. The fuel mix of claim 107, wherein at least one of the first or second organic fuel is selected from the group consisting of gasoline, ethanol, diesel fuel, and glycerin.

109. The fuel mix of claim 108, wherein the shell further comprises an inorganic fuel.

110. The fuel mix of claim 108, wherein the organic fuel is gasoline and the inorganic fuel is water.

111. A fluid activation device to generate a foamed fluid, comprising:
a hydrodynamic portion for activating at least a compressed liquid by subsequently pressurizing the liquid and depressurizing the liquid into a low pressure zone for mixing of the liquid with a compressed gas; and
an aerodynamic portion overlapping with the hydrodynamic portion at an interface region for mixing a compressed gas into the at least an input compressed liquid at the low pressure zone of mixing by subsequently pressurizing the gas, and changing a flow direction of the gas, and wherein.

112. The fluid activation device of claim 111, wherein the low pressure zone for mixing the at least a liquid and the gas creates a pseudo-boiling of the liquid and the gas to form a fluid mixture comprising a plurality of fluid based spheres in contact with each other, each sphere having a core of compressed gas, and a shell made of liquid surrounding the core comprising a liquid with a thickness forming a volumetric structure made of foam bubbles.

113. The fluid activation device of claim 111, wherein the hydrodynamic portion includes a housing with a cavity having a center cone for pressuring the liquid and directing the liquid to a plurality of channels and ultimately to capillary ring channel between two conical shaped surfaces for depressurization into the low pressure zone.

114. The fluid activation device of claim 111, wherein the aerodynamic portion is overlapping with the hydrodynamic portion at an interface region forming the low pressure zone, and wherein the aerodynamic portion includes a housing to receive the compressed gas with a cavity having a center cone for pressurizing the gas, and a set of openings at the base of the cone for changing a flow direction of the gas in a conical channel ring for depressurization into the low pressure zone.

115. The fluid activation device of claim 111, wherein the hydrodynamic portion activates two compressed liquids by depressurizing each liquid into a low pressure zone for mixing of the liquid with a compressed gas.

116. The fluid activation device of claim 111, wherein the compressed gas is compressed air and the at least a compressed liquid is selected from a group consisting of gasoline, ethanol, diesel fuel, and glycerin.

117. The fluid activation device of claim 115, wherein the two liquids are an organic fuel and an inorganic fuel.

118. The fluid activation device of claim 117, wherein the inorganic fuel is water.

119. A device comprising:
a hydrodynamic system comprising a first input configured to receive a first liquid component comprising a fuel, a plurality of fuel channels fluidly connected to the first input configured to generate a turbulent stream of fuel, an output fluidly connected to the plurality of fuel channels and configured to output the turbulent stream of fuel system into a first zone of low pressure, a second input configured to receive a liquid component, and a second output fluidly connected to the second input and configured to output the second liquid component into the first zone of low pressure; and
an aerodynamic system comprising a plurality of air channels configured to generate a stream of compressed air, an output configured to output the stream of compressed air to a second low pressure zone connected to the first low pressure zone, and a channel between the first low pressure zone and the second low pressure zone configured to deliver a mixture of the first and second liquid components from the first low pressure zone to the second low pressure zone such that the first and second liquid components are mixed with a stream of compressed air to form a plurality of micro-bubbles of fuel.

120. The device of claim 119, wherein the hydrodynamic system comprises a conical fuel intake cavity in the shape of a truncated cone having a greater diameter at an input of the first liquid component and becoming smaller in the direction of movement of the first liquid component, and the aerodynamic system comprises a conical gaseous intake cavity in the shape of a truncated cone having a greater diameter at the input of the gaseous component and becoming smaller in the direction of movement of the gaseous component.

121. The device of claim 119, wherein the hydrodynamic system further comprises capillary openings disposed at the smaller diameter end of the truncated cone in the hydrodynamic system, the capillary openings having an axis parallel to an axis of the fuel pipeline and concentric to the circles of the truncated cone, and the aerodynamic system further comprises capillary openings disposed at the smaller diameter end of the truncated cone in the aerodynamic system, the capillary openings having an axis parallel to an axis of the fuel pipeline and concentric to the circles of the truncated cone.

122. A method of preparing a mixture of fuel and gas, the method comprising:
receiving a first liquid component comprising a fuel;
forming a first zone of increased turbulence and local low pressure by moving the first liquid component in an activation device;
receiving a second liquid component into the first local zone of low pressure;
mixing the first and second liquid components in the first local zone of low pressure to form a fuel mixture;
receiving pressurized gas;
receiving the fuel mixture in a second zone of local low pressure; and
mixing the fuel mixture and the pressurized gas in the second zone of local low pressure to form a stream of micro-bubbles.

123. The method of claim 122, wherein the first liquid component comprises an organic fuel, the second liquid component comprises water, and the pressurized gas comprises compressed air.

124. The method of claim 122, wherein forming the second zone of low pressure comprises inputting the pressurized gas in a pipeline under pressure, opposite the direction of movement of the liquid fuel gas mixture, and transforming a direction of movement of the gas prior to entry of the gas into the second zone of low pressure.

125. The method of claim 122, wherein the formation of the first zone of low pressure comprises the formation of the first zone of low pressure using a hydrodynamic effect created by utilizing the physical principles of Bernoulli's Theorem, and the formation of the second zone of low pressure comprises forming the second zone of low pressure using an aerodynamic effect created by utilizing the physical principles of Bernoulli's Theorem.

126. A device for preparing a fuel gas mixture, comprising:
an activation module disposed in a fuel pipeline comprising a hydraulic system and an aerodynamic system connected to the hydraulic system;
at least one tank with one or more components of a fuel mix being connected by a fuel pump and a pipeline to the hydraulic system of the activation module;
a compressor driven from a shaft of a device with the combustion chamber, an output of the compressor connected to the activation module; and
at least one device for output of an activated fuel mix from the activation module to an atomizer for entry into the combustion chamber.

127. The device of claim 126, wherein the activation module comprises a first housing structure, a second housing structure, and a component that unites the first and second housing structures and provides a site for connection to the fuel pipeline, the component, first housing, and second housing being configured to generate conditions for creating effects by applying the Bernoulli Theorem and generate two consecutive local zones of activation.

128. The device of claim 127, wherein the hydrodynamic system comprises a conical fuel intake cavity in the shape of a truncated cone having a greater diameter at the input of the fuel component and becoming smaller in the direction of movement of the fuel component; and the aerodynamic system comprises a conical gaseous intake cavity in the shape of a truncated cone having a greater diameter at the input of the gaseous component and becoming smaller in the direction of movement of the gaseous component.
